(19) United States
(12) Patent Application Publication
(10) Pub. No.: US 2025/0304386 A1
(43) Pub. Date: Oct. 2, 2025

(54) ROBOTIC PACKAGE HANDLING SYSTEMS AND METHODS

(71) Applicant: Ambi Robotics, Inc., Berkeley, CA (US)

(72) Inventor: Jeffrey B. Mahler, Berkeley, CA (US)

(73) Assignee: Ambi Robotics, Inc., Berkeley, CA (US)

(21) Appl. No.: 18/974,775

(22) Filed: Dec. 9, 2024

Related U.S. Application Data
(60) Provisional application No. 63/608,134, filed on Dec. 8, 2023.
(60) Provisional application No. 63/608,430, filed on Dec. 11, 2023.

(51) Int. Cl. B65G 61/00; B25J 9/16; B25J 15/06; B25J 19/02

(52) U.S. Cl. CPC B65G 61/00; B25J 9/1697; B25J 15/0616; B25J 19/023

(57) ABSTRACT

One embodiment is directed to a robotic package handling system, comprising: an end effector assembly configured to transfer one or more packages from an input assembly to an output assembly; a first imaging device positioned and oriented to capture image information pertaining to the one or more packages; and a first computing system operatively coupled to the end effector assembly and the first imaging device, and configured to receive the image information from the first imaging device and command movements of the end effector assembly based at least in part upon the image information; wherein the first computing system is configured to operate the end effector assembly to move a targeted package of the one or more packages from the input assembly based at least in part upon the image information, and release the targeted package to be at least transiently coupled with the output assembly with position and orientation.

### RELATED APPLICATION DATA

This application claims priority to U.S. Provisional Patent Application No. 63/608,134 filed on Dec. 8, 2023, and also to U.S. Provisional Application No. 63/608,430 filed on Dec. 11, 2023. The entire disclosures of the above applications are expressly incorporated by reference herein.

### FIELD OF THE INVENTION

This invention relates generally to the field of robotics, and more specifically to a new and useful system and method for planning and adapting to object manipulation by a robotic system. More specifically the present invention relates to robotic systems and methods for managing and processing packages.

### BACKGROUND

Many industries are adopting forms of automation. Robotic systems, and robotic arms specifically, are increasingly being used to help with the automation of manual tasks. The cost and complexity involved in integrating robotic automation, however, are limiting this adoption.

Because of the diversity of possible uses, many robotic systems are either highly customized and uniquely designed for a specific implementation or are very general robotic systems. The highly specialized solutions can only be used in limited applications. The general systems will often require a large amount of integration work to program and setup for a specific implementation. This can be costly and time consuming.

Further complicating the matter, many potential uses of robotic systems have changing conditions. Traditionally, robots have been designed and configured for various uses in industrial and manufacturing settings. These robotic systems generally perform very repetitive and well-defined tasks. The increase in e-commerce, however, is resulting in more demand for forms of automation that must deal with a high degree of changing or unknown conditions. Many robotic systems are unable to handle a wide variety of objects and/or a constantly changing variety of objects, which can make such robotic systems poor solutions for the product handling tasks resulting from e-commerce. Thus, there is a need in the robotics field to create a new and useful system and method for planning and adapting to object manipulation by a robotic system. This invention provides such new and useful systems and methods.

### SUMMARY

One embodiment is directed to a robotic package handling system, comprising: an end effector assembly configured to transfer one or more packages from an input assembly to an output assembly; a first imaging device positioned and oriented to capture image information pertaining to the one or more packages; and a first computing system operatively coupled to the end effector assembly and the first imaging device, and configured to receive the image information from the first imaging device and command movements of the end effector assembly based at least in part upon the image information; wherein the input assembly is operatively coupled to the first computing system and configured to be operated by the first computing system based at least in part upon the image information to mechanically process a plurality of incoming packages from a substantially disordered mechanical organization to provide a supply of packages to be transferred to the input assembly that is substantially singulated, and to prune away certain packages which do not become substantially singulated as a result of the mechanical process; and wherein the first computing system is configured to operate the end effector assembly to move a targeted package of the one or more packages from the input assembly based at least in part upon the image information, and release the targeted package to be at least transiently coupled with the output assembly with a position and orientation based at least in part upon the image information. The end effector assembly may comprise a first suction cup assembly coupled to a controllably activated vacuum load operatively coupled to the first computing system, the first suction cup assembly configured such that operating the end effector assembly to move a targeted package comprises engaging the targeted package and controllably activating the vacuum load. The end effector assembly further may comprise a tray member configured to be at least partially positioned below the targeted package when operating the end effector assembly to move a targeted package. The first imaging device may comprise a camera. The first imaging device may comprise a stereoscopic camera assembly. The first imaging device may comprise a depth camera. The input assembly may be configured to be operated by the first computing system to control the supply of packages based at least in part upon a number of the one or more packages transiently coupled to output assembly. The input assembly may be configured to be operated by the first computing system to control the supply of packages based at least in part upon the image information pertaining to the one or more packages at the input assembly. The input assembly may comprise one or more mechanical singulation elements configured to mechanically process and direct the substantially singulated supply of packages toward the output assembly. The one or more mechanical singulation elements may be selected from the group consisting of: a ramp sequence; a vibratory actuator; a belt; a coordinated plurality of belts; a ball sorter conveyor; a step sequence; a chute with one or more 90-degree turns; a mechanical diverter; a vertical mechanical filter; and a horizontal mechanical filter. The input assembly may be configured to be operated by the first computing system to prune away certain packages which do not become substantially singulated as a result of the mechanical process using a diversion element configured to selectably divert one or more targeted packages. The system further may comprise a second image capture device operatively coupled to the first computing system and configured to capture information pertaining to the one or more packages on the input assembly. The system further may comprise a second image capture device operatively coupled to the first computing system and configured to capture information pertaining to the one or more packages on the output assembly. The first image capture device may be positioned and oriented to capture information pertaining to packages being moved from the input assembly to the output assembly. The input assembly may comprise an electromechanical conveyance. At least a portion of the conveyance may comprise a multi-axis electromechanical conveyance. The output assembly may be configured to controllably release the targeted package to an output container. The output container may be selected from the group consisting of: a bin, a sack, a tote, a gaylord container, a chute, a conveyance. The first computing system may be operatively coupled to the output assembly. The output assembly may be configured to controllably release the targeted package to a distribution module, the distribution module being operatively coupled to the first computing system and configured to controllably release the targeted package to an output container. The output container may be selected from the group consisting of: a bin, a sack, a tote, a gaylord container, a chute, a conveyance. The distribution module may comprise a tray or bin movably coupled to a transport assembly coupled between the distribution module and the output assembly. The distribution module may be movably coupled to the transport assembly using a pan-tilt actuation assembly operatively coupled to the first computing system. The transport assembly may comprise an elevated gantry assembly configured to have physical access to an array of available output containers. The transport assembly may comprise a rail assembly configured to have physical access to an array of available output containers. A plurality of output containers comprising the array of available output containers may be coupled together as an assembly to be transferred away from the output assembly together. A plurality of output containers comprising the array of available output containers may be removably coupled together as an assembly to be transferred away from the output assembly together. The distribution module may be configured to be able to controllably release the targeted package to a targeted output container selected from an array of available output containers. The first computing system may be configured to operate the distribution module to sequence packages into one a plurality of targeted output containers selected from the array of available output containers based upon a multi-pass sorting algorithm. The multi-pass sorting algorithm may comprise a hash-sort configuration selected to facilitate efficient sequenced unloading of the plurality of targeted output containers. The first computing system may be configured to automatically controllably release the targeted package to a targeted output container selected from an array of available output containers based at least in part upon image information from the first image capture device. The first computing system may be configured to automatically controllably release the targeted package to a targeted output container selected from an array of available output containers based at least in part upon image information from the first image capture device which may be utilized by the first computing system to estimate a factor selected from the group consisting of: package geometry; package compliance; estimated package bounding box geometry; package relative mass; relative rigidity of package material; package mechanical stability; and package moment of inertia. The system further may comprise a second image capture device fixedly coupled to the distribution module and configured to provide image information pertaining to movement of packages between the distribution module and the array of available output containers. The second image capture device may be further configured to provide image information pertaining to interior portions defined within output containers comprising the array of available output containers. The second image capture device may be configured to provide image information pertaining to interior portion factors selected from the group consisting of: shape of interiors of output containers, geometry of items within output containers, and fill level within output containers. The first computing system may be configured to operate the distribution module to place the targeted package into the targeted output container with a position and orientation automatically selected to optimize geometric fit of the targeted package within the targeted output container. The first computing system may be configured to operate the distribution module to sequence packages into one a plurality of targeted output containers selected from the array of available output containers based upon a known pattern regarding a planned unloading of the plurality of targeted output containers. The first computing system may be configured to operate the distribution module to sequence packages into one a plurality of targeted output containers selected from the array of available output containers based upon a known pattern regarding a planned relative positioning of the plurality of targeted output containers within a delivery vehicle. The first computing system may be configured to operate the distribution module to sequence packages into one a plurality of targeted output containers selected from the array of available output containers based upon a known delivery route pertaining to a planned unloading of the plurality of targeted output containers. The input assembly may comprise a herringbone conveyance operatively coupled to the first computing system and configured to automatically position the one or more packages in a central position within reach of the end effector assembly. The first computing system may be configured to operate the herringbone conveyance based at least in part upon the image information from the first image capture device. The input assembly may comprise an input conveyance and a plurality of movable members configured to extend above the input conveyance, the plurality of movable members and input conveyance being operatively coupled to the first computing system and configured to automatically reposition the one or more packages when on the input conveyance. The first computing system may be configured to operate the plurality of movable members and input conveyance based at least in part upon the image information from the first image capture device. The first image capture device may be configured to capture image information pertaining to the one or more packages as they are positioned upon the input assembly. The first computing system may be configured to establish an identity for each of the one or more packages based at least in part upon the image information captured from the input assembly. The first computing system may be configured to utilize the established identity in releasing the targeted package to the output assembly. The first computing system may be configured to utilize the established identity in releasing the targeted package to the output assembly based at least in part upon characteristics of the targeted package which may be associated with the established identity. The first computing system may be configured to associated other predetermined information pertaining to the one or more packages from another operatively coupled computing system based at least in part upon the image information captured from the input assembly. The input assembly may comprise a primary item processing/input system.

Another embodiment is directed to a robotic package handling method, comprising: providing an end effector assembly configured to transfer one or more packages from an input assembly to an output assembly; providing a first imaging device positioned and oriented to capture image information pertaining to the one or more packages; and providing a first computing system operatively coupled to the end effector assembly and the first imaging device, and configured to receive the image information from the first imaging device and command movements of the end effector assembly based at least in part upon the image information; wherein the input assembly is operatively coupled to the first computing system and configured to be operated by the first computing system based at least in part upon the image information to mechanically process a plurality of incoming packages from a substantially disordered mechanical organization to provide a supply of packages to be transferred to the input assembly that is substantially singulated, and to prune away certain packages which do not become substantially singulated as a result of the mechanical process; and wherein the first computing system is configured to operate the end effector assembly to move a targeted package of the one or more packages from the input assembly based at least in part upon the image information, and release the targeted package to be at least transiently coupled with the output assembly with a position and orientation based at least in part upon the image information. The end effector assembly may comprise a first suction cup assembly coupled to a controllably activated vacuum load operatively coupled to the first computing system, the first suction cup assembly configured such that operating the end effector assembly to move a targeted package comprises engaging the targeted package and controllably activating the vacuum load. The end effector assembly further may comprise a tray member configured to be at least partially positioned below the targeted package when operating the end effector assembly to move a targeted package. The first imaging device may comprise a camera. The first imaging device may comprise a stereoscopic camera assembly. The first imaging device may comprise a depth camera. The input assembly may be configured to be operated by the first computing system to control the supply of packages based at least in part upon a number of the one or more packages transiently coupled to output assembly. The input assembly may be configured to be operated by the first computing system to control the supply of packages based at least in part upon the image information pertaining to the one or more packages at the input assembly. The input assembly may comprise one or more mechanical singulation elements configured to mechanically process and direct the substantially singulated supply of packages toward the output assembly. The one or more mechanical singulation elements may be selected from the group consisting of: a ramp sequence; a vibratory actuator; a belt; a coordinated plurality of belts; a ball sorter conveyor; a step sequence; a chute with one or more 90-degree turns; a mechanical diverter; a vertical mechanical filter; and a horizontal mechanical filter. The input assembly may be configured to be operated by the first computing system to prune away certain packages which do not become substantially singulated as a result of the mechanical process using a diversion element configured to selectably divert one or more targeted packages. The method further may comprise providing a second image capture device operatively coupled to the first computing system and configured to capture information pertaining to the one or more packages on the input assembly. The method further may comprise providing a second image capture device operatively coupled to the first computing system and configured to capture information pertaining to the one or more packages on the output assembly. The first image capture device may be positioned and oriented to capture information pertaining to packages being moved from the input assembly to the output assembly. The input assembly may comprise an electromechanical conveyance. At least a portion of the conveyance may comprise a multi-axis electromechanical conveyance. The output assembly may be configured to controllably release the targeted package to an output container. The output container may be selected from the group consisting of: a bin, a sack, a tote, a gaylord container, a chute, a conveyance. The first computing system may be operatively coupled to the output assembly. The output assembly may be configured to controllably release the targeted package to a distribution module, the distribution module being operatively coupled to the first computing system and configured to controllably release the targeted package to an output container. The output container may be selected from the group consisting of: a bin, a sack, a tote, a gaylord container, a chute, a conveyance. The distribution module may comprise a tray or bin movably coupled to a transport assembly coupled between the distribution module and the output assembly. The distribution module may be movably coupled to the transport assembly using a pan-tilt actuation assembly operatively coupled to the first computing system. The transport assembly may comprise an elevated gantry assembly configured to have physical access to an array of available output containers. The transport assembly may comprise a rail assembly configured to have physical access to an array of available output containers. A plurality of output containers comprising the array of available output containers may be coupled together as an assembly to be transferred away from the output assembly together. A plurality of output containers comprising the array of available output containers may be removably coupled together as an assembly to be transferred away from the output assembly together. The distribution module may be configured to be able to controllably release the targeted package to a targeted output container selected from an array of available output containers. The first computing system may be configured to operate the distribution module to sequence packages into one a plurality of targeted output containers selected from the array of available output containers based upon a multi-pass sorting algorithm. The multi-pass sorting algorithm may comprise a hash-sort configuration selected to facilitate efficient sequenced unloading of the plurality of targeted output containers. The first computing system may be configured to automatically controllably release the targeted package to a targeted output container selected from an array of available output containers based at least in part upon image information from the first image capture device. The first computing system may be configured to automatically controllably release the targeted package to a targeted output container selected from an array of available output containers based at least in part upon image information from the first image capture device which may be utilized by the first computing system to estimate a factor selected from the group consisting of: package geometry; package compliance; estimated package bounding box geometry; package relative mass; relative rigidity of package material; package mechanical stability; and package moment of inertia. The method further may comprise providing a second image capture device fixedly coupled to the distribution module and configured to provide image information pertaining to movement of packages between the distribution module and the array of available output containers. The second image capture device may be further configured to provide image information pertaining to interior portions defined within output containers comprising the array of available output containers. The second image capture device may be configured to provide image information pertaining to interior portion factors selected from the group consisting of: shape of interiors of output containers, geometry of items within output containers, and fill level within output containers. The first computing system may be configured to operate the distribution module to place the targeted package into the targeted output container with a position and orientation automatically selected to optimize geometric fit of the targeted package within the targeted output container. The first computing system may be configured to operate the distribution module to sequence packages into one a plurality of targeted output containers selected from the array of available output containers based upon a known pattern regarding a planned unloading of the plurality of targeted output containers. The first computing system may be configured to operate the distribution module to sequence packages into one a plurality of targeted output containers selected from the array of available output containers based upon a known pattern regarding a planned relative positioning of the plurality of targeted output containers within a delivery vehicle. The first computing system may be configured to operate the distribution module to sequence packages into one a plurality of targeted output containers selected from the array of available output containers based upon a known delivery route pertaining to a planned unloading of the plurality of targeted output containers. The input assembly may comprise a herringbone conveyance operatively coupled to the first computing system and configured to automatically position the one or more packages in a central position within reach of the end effector assembly. The first computing system may be configured to operate the herringbone conveyance based at least in part upon the image information from the first image capture device. The input assembly may comprise an input conveyance and a plurality of movable members configured to extend above the input conveyance, the plurality of movable members and input conveyance being operatively coupled to the first computing system and configured to automatically reposition the one or more packages when on the input conveyance. The first computing system may be configured to operate the plurality of movable members and input conveyance based at least in part upon the image information from the first image capture device. The first image capture device may be configured to capture image information pertaining to the one or more packages as they are positioned upon the input assembly. The first computing system may be configured to establish an identity for each of the one or more packages based at least in part upon the image information captured from the input assembly. The first computing system may be configured to utilize the established identity in releasing the targeted package to the output assembly. The first computing system may be configured to utilize the established identity in releasing the targeted package to the output assembly based at least in part upon characteristics of the targeted package which may be associated with the established identity. The first computing system may be configured to associated other predetermined information pertaining to the one or more packages from another operatively coupled computing system based at least in part upon the image information captured from the input assembly. The input assembly may comprise a primary item processing/input system.

### BRIEF DESCRIPTION OF THE DRAWINGS

FIGS. 1A and 1B illustrate a high level flow diagrams of sortation processing configuration.

FIG. 2A illustrates various subsystems which may be utilized for package processing and primary induction.

FIG. 2B illustrates a singulation configuration for processing packages or other items, which may incorporate one or more conveyance features.

FIG. 2C illustrates a side view of a physical singulation configuration.

FIGS. 2D-2F illustrate aspects of conveyance-based processing modules.

FIGS. 2G-2L illustrate aspects of robotic sortation embodiments which may incorporate one or more suction cup assemblies to assist in forming a package-grasping end effector module.

FIG. 2M illustrates a chute assembly configuration.

FIG. 3 illustrates a semi-rigid output container.

FIG. 4A illustrates a process flow embodiment pertaining to a sortation configuration to output containers.

FIGS. 4B, 5A, and 5B illustrate various aspects of package sortation and distribution configurations featuring a movable distribution module.

FIGS. 6, 7A-7C, 8A-8B, 9A-9B, and 10A-10M illustrate aspects of configurations which may be utilized for using output containers such as totes or bags with handles.

FIGS. 11A-11G and 12A-12H illustrate various aspects of a configuration which may be removably grasp an output container such as a bag or tote using vacuum and a lower pick up tray.

FIG. 13 illustrates how various output container volumes or packages may be assembled together and or utilized together with geometric efficiency.

FIG. 14 illustrates various aspects of a configuration wherein a package or item comprises various components and features which may be tracked or examined using various sensors or image capture devices.

FIGS. 15A-15B, 16A-16H, and 17A-17F illustrate various aspects of conveyance integrations which may be utilized on computer-coupled sortation systems.

FIGS. 18A-18E illustrate various aspects of specific package configurations and a flow for processing such packages to transfer or shipping outputs.

FIGS. 19A-19D and 20A-20C illustrate aspects of assembly which may be utilized to scale sortation of packages or other items.

FIGS. 21A-21G illustrate aspects of sorting unique package or item geometries or constructs, such as envelopes.

FIGS. 22, 23A-23B, 24A-24B, and 25A-25B illustrate various aspects of computer-controlled sortation configurations from primary item processing to transfer out or other endpoint.

FIGS. 26A-26D illustrate various views of image capture devices, such as cameras, and other devices directed integrated with a mobile distribution module which may be configured to deliver packages to output containers with specific levels of control, such as vectoring, positioning, and orientation into an output container.

FIGS. 27A-27F and 28A-28D illustrate various views of sortation configurations wherein an input assembly, such as one comprising a conveyance, may be configured to deliver packages to a mobile distribution module which may be configured to deliver packages to output containers with specific levels of control, such as vectoring, positioning, and orientation into an output container.

FIG. 29 illustrates a process flow configuration from primary item or package processing, to precision sortation, to pack-out processing.

FIGS. 30 and 31 illustrate aspects of sortation systems comprising a mobile distribution module which may be configured to deliver packages to output containers with specific levels of control, such as vectoring, positioning, and orientation into an output container.

### DETAILED DESCRIPTION

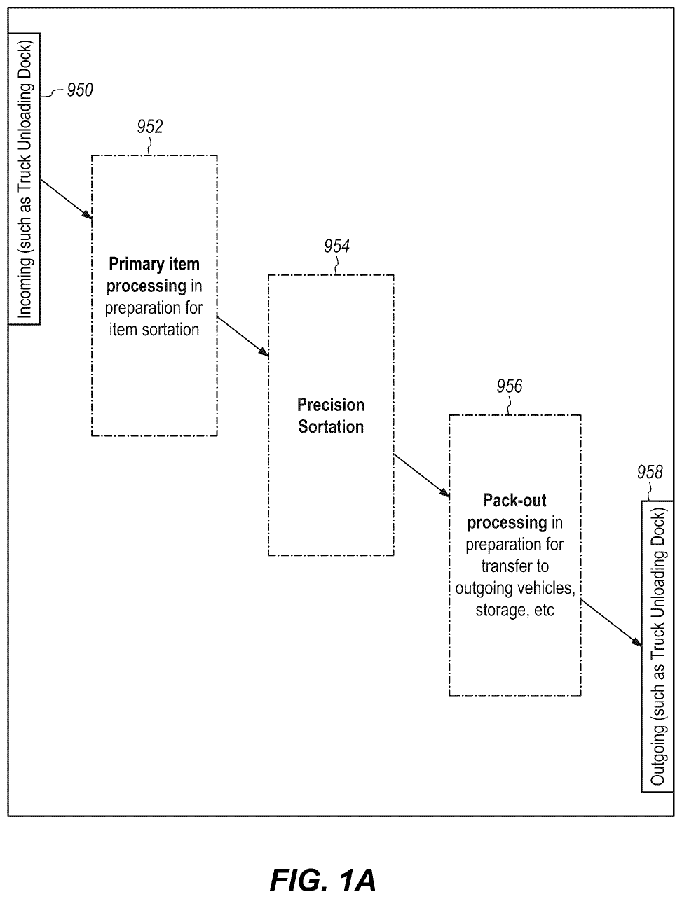

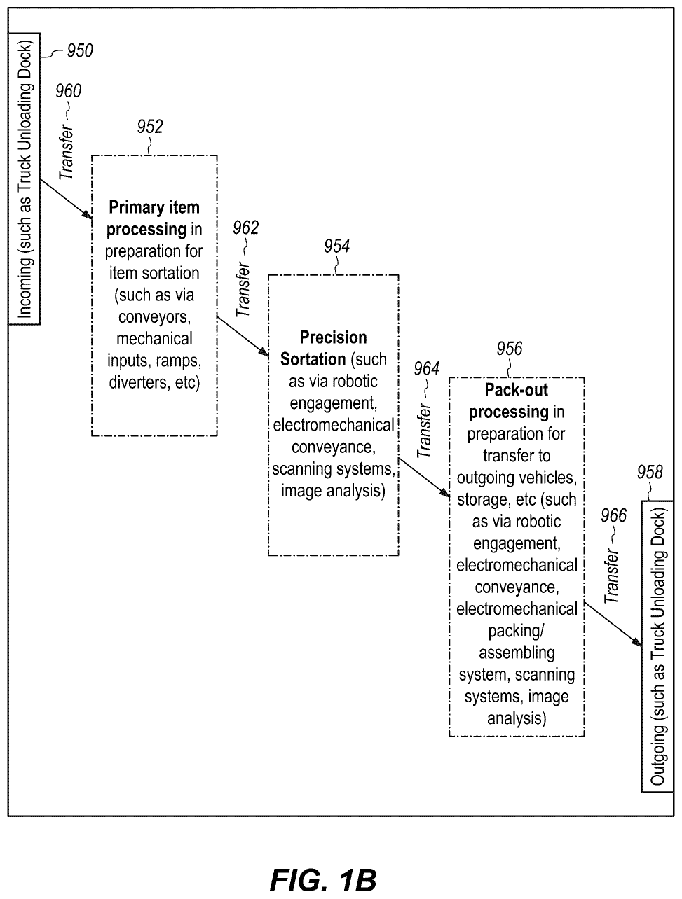

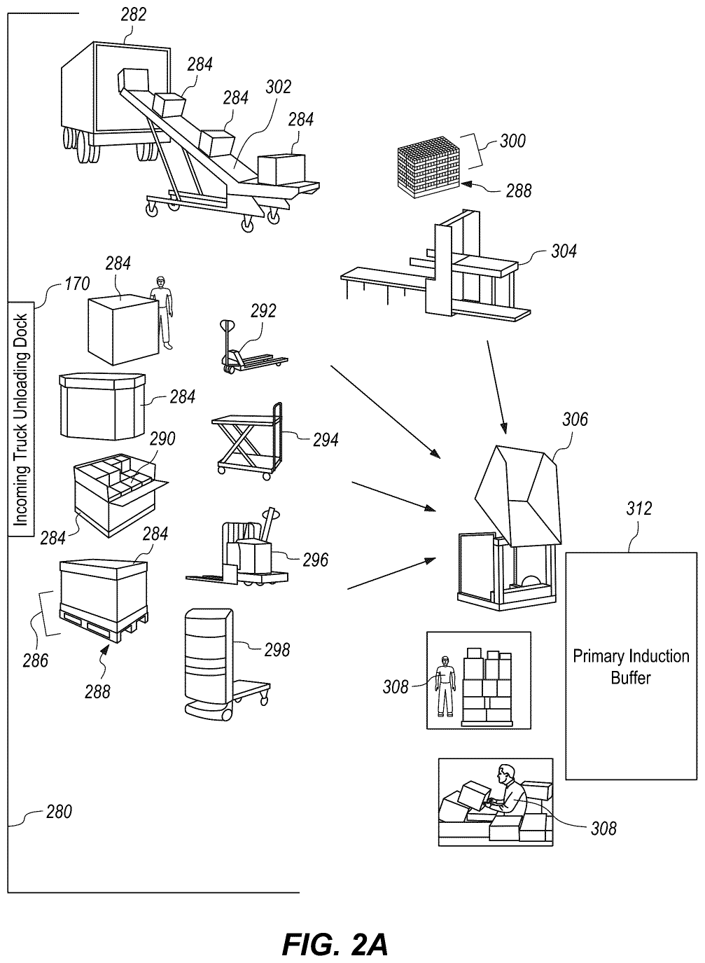

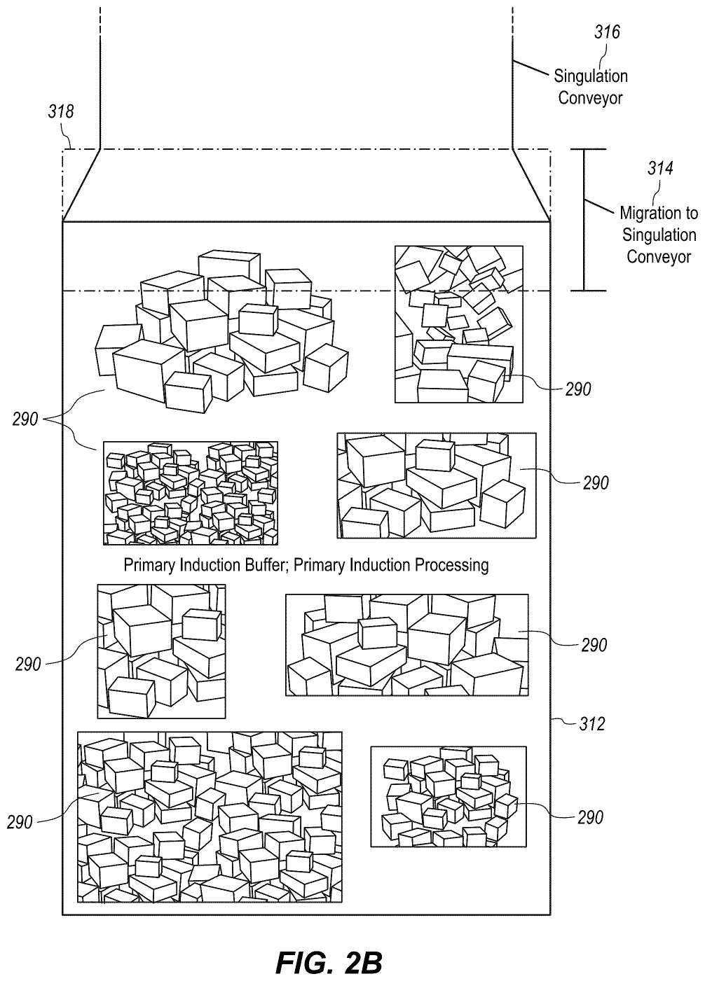

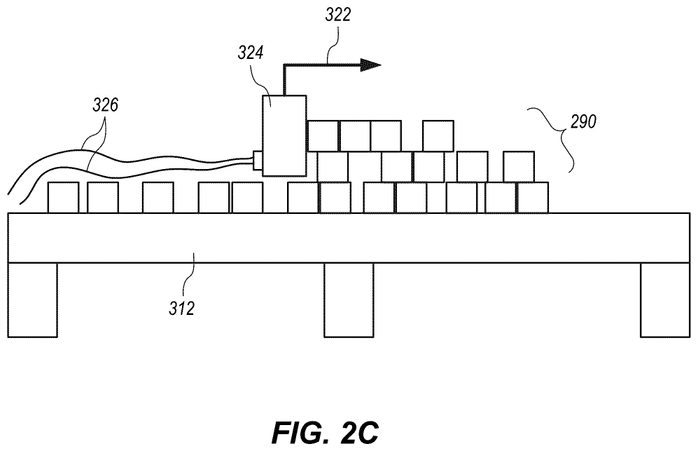

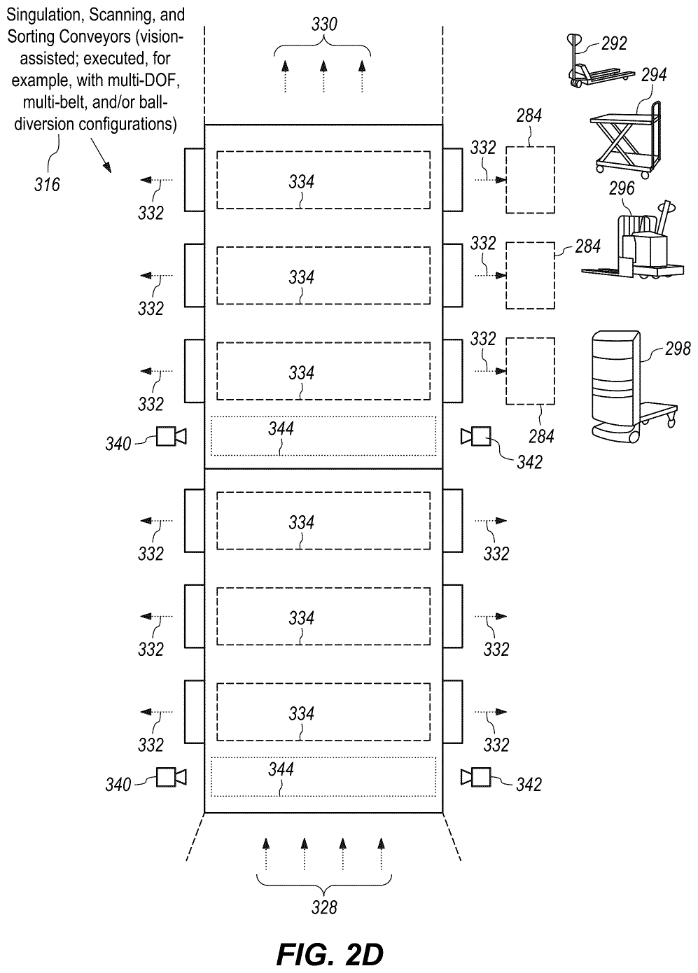

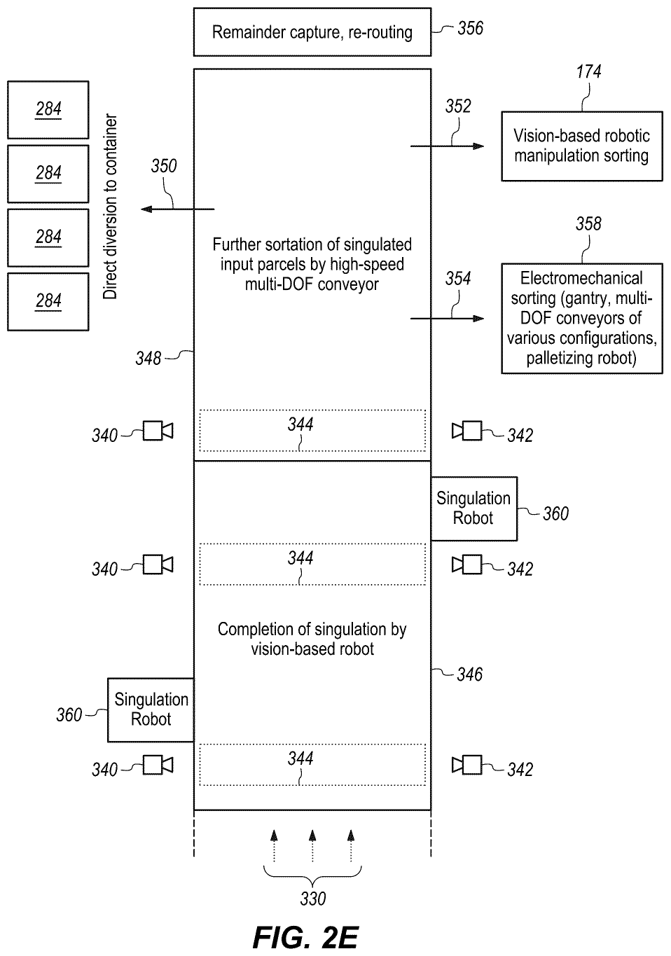

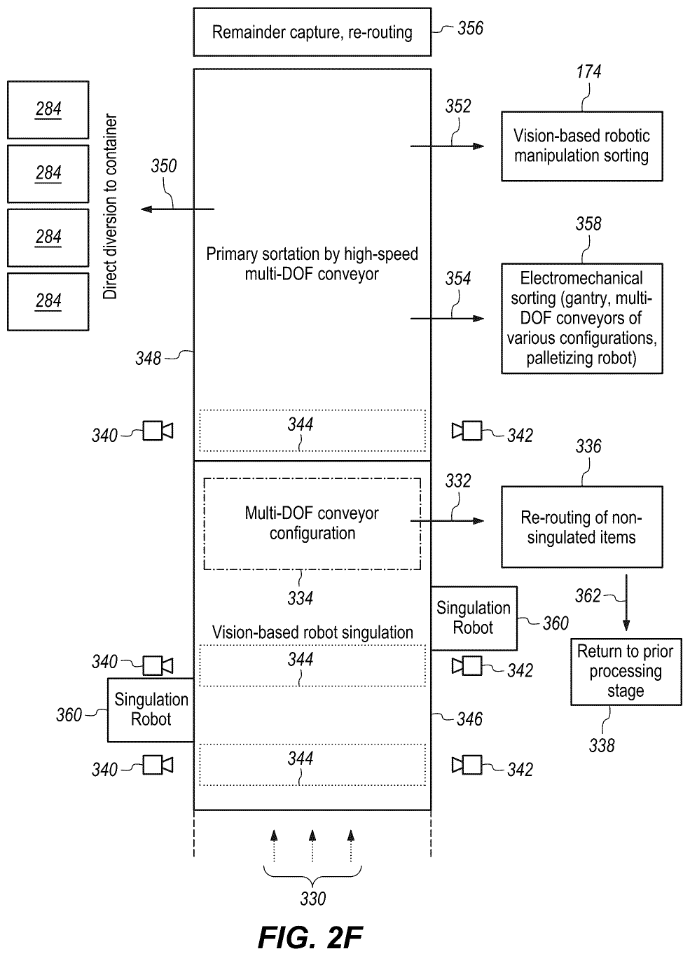

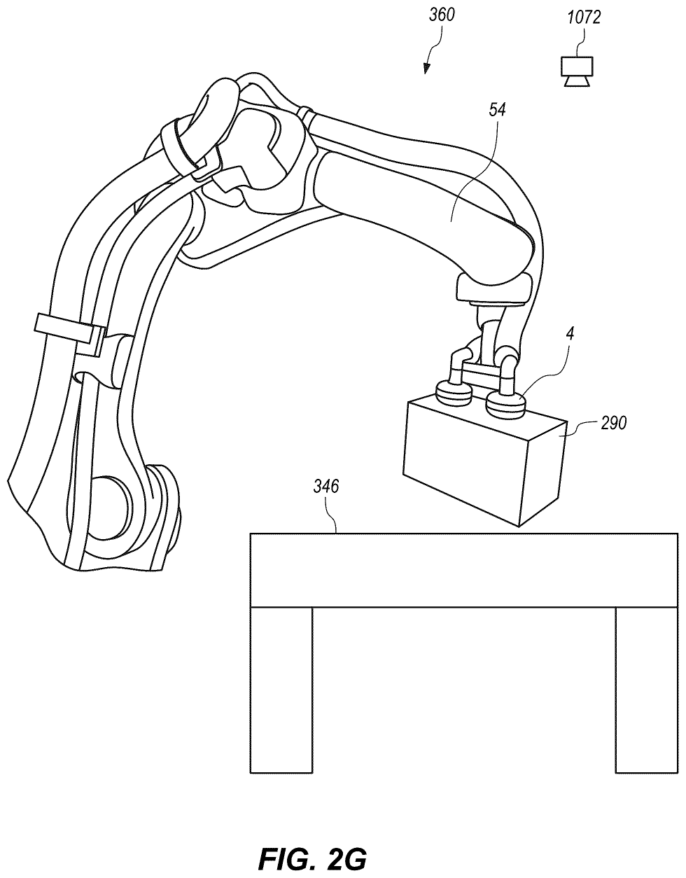

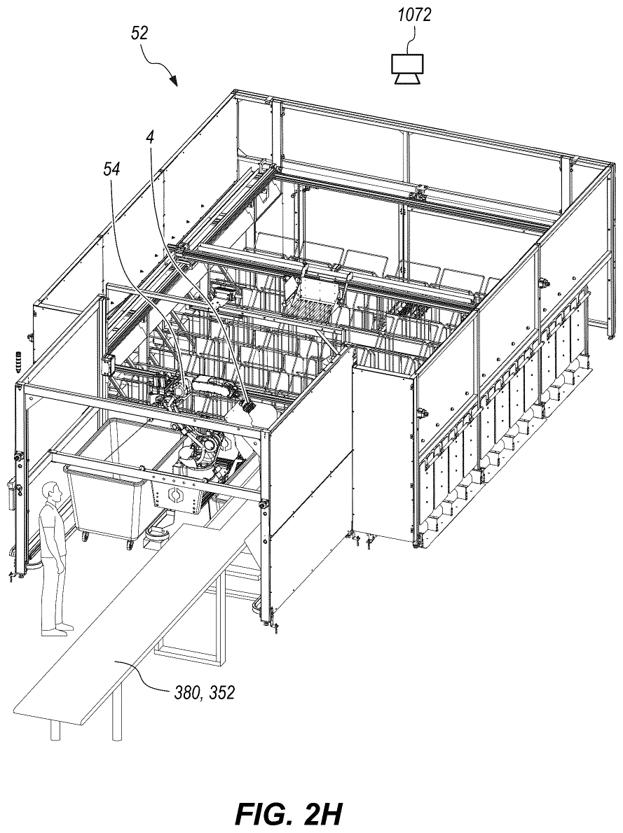

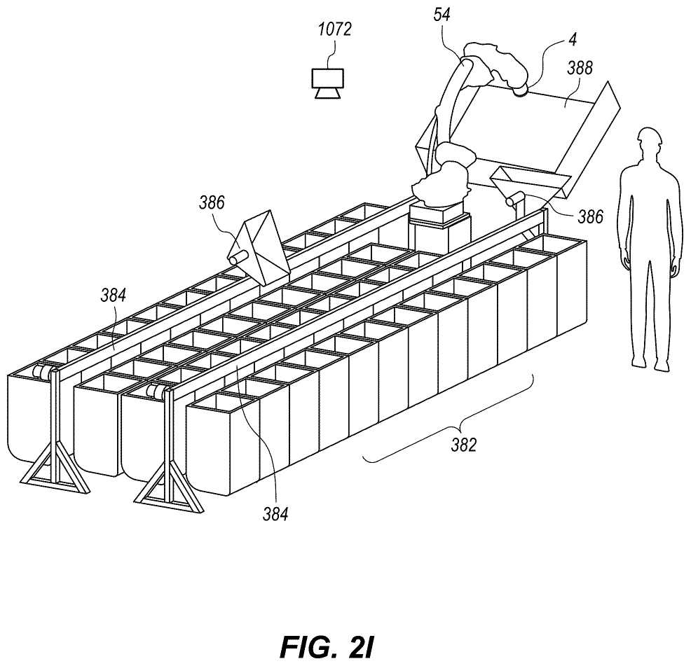

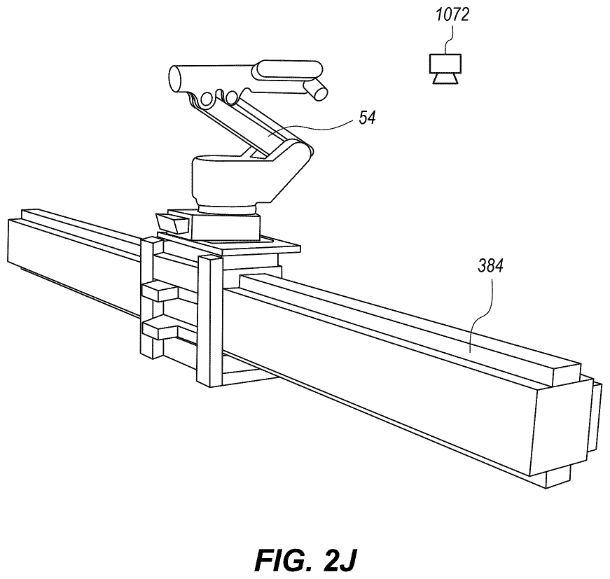

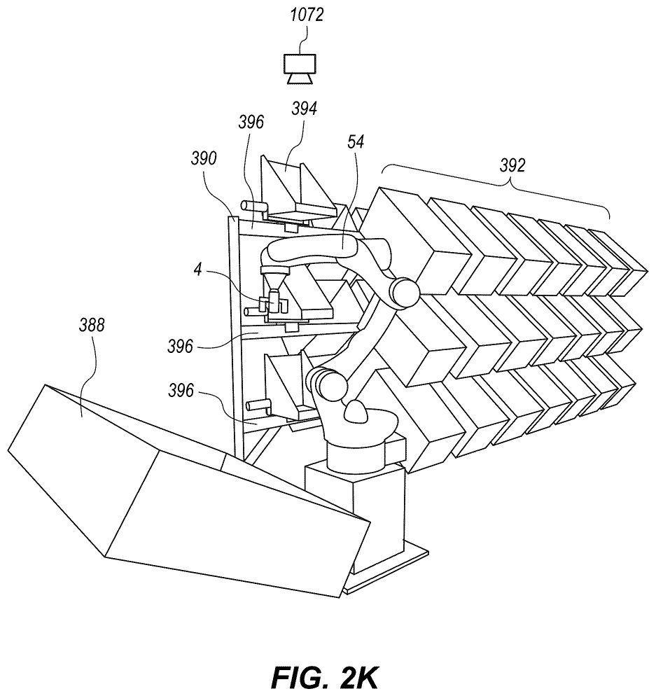

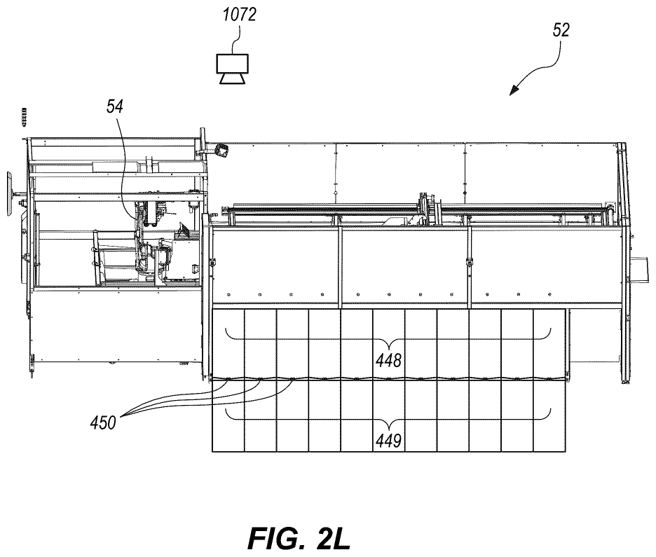

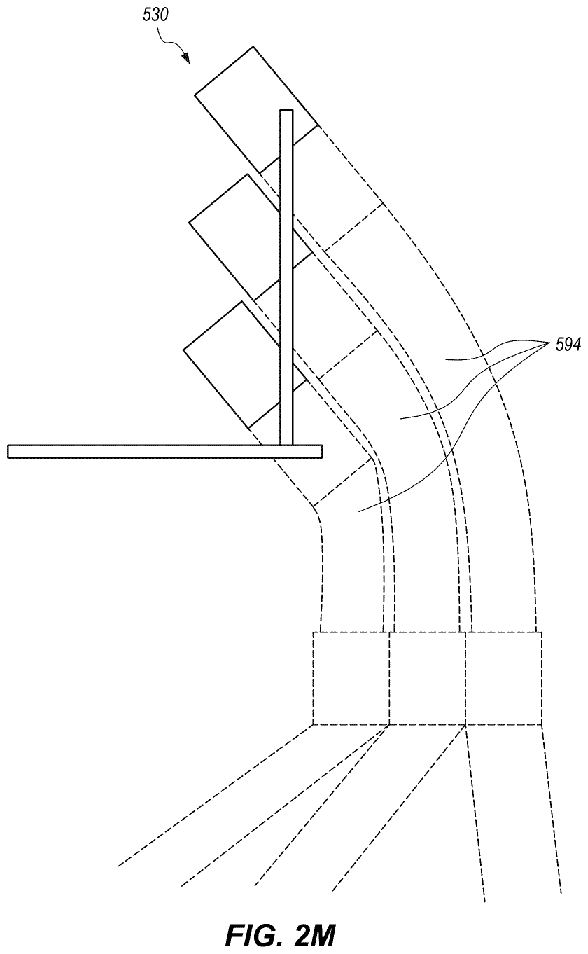

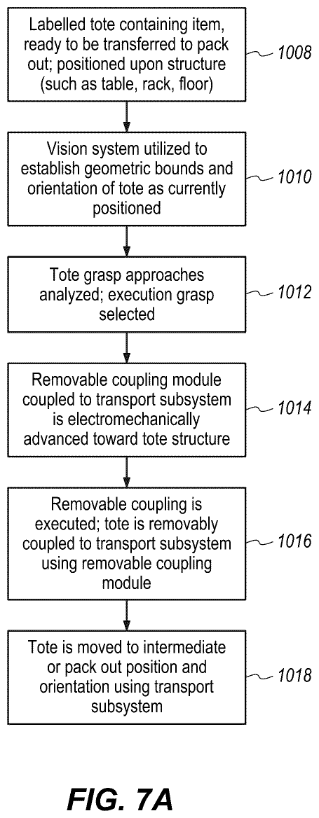

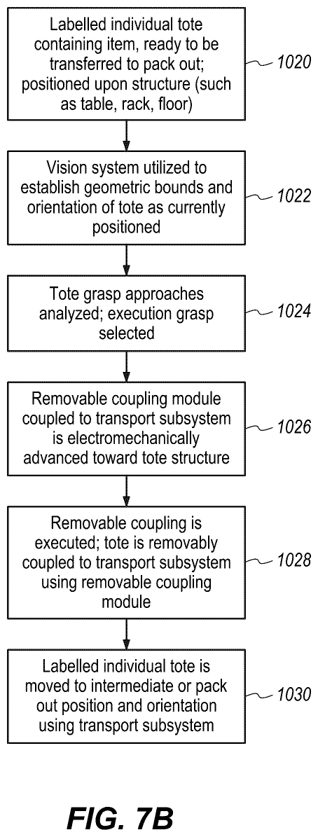

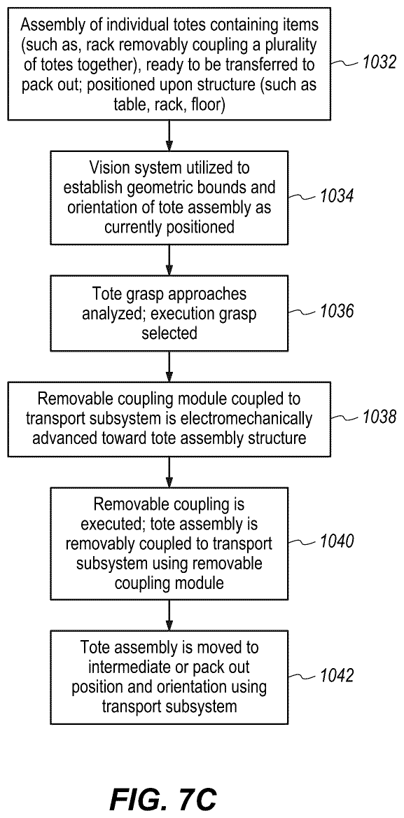

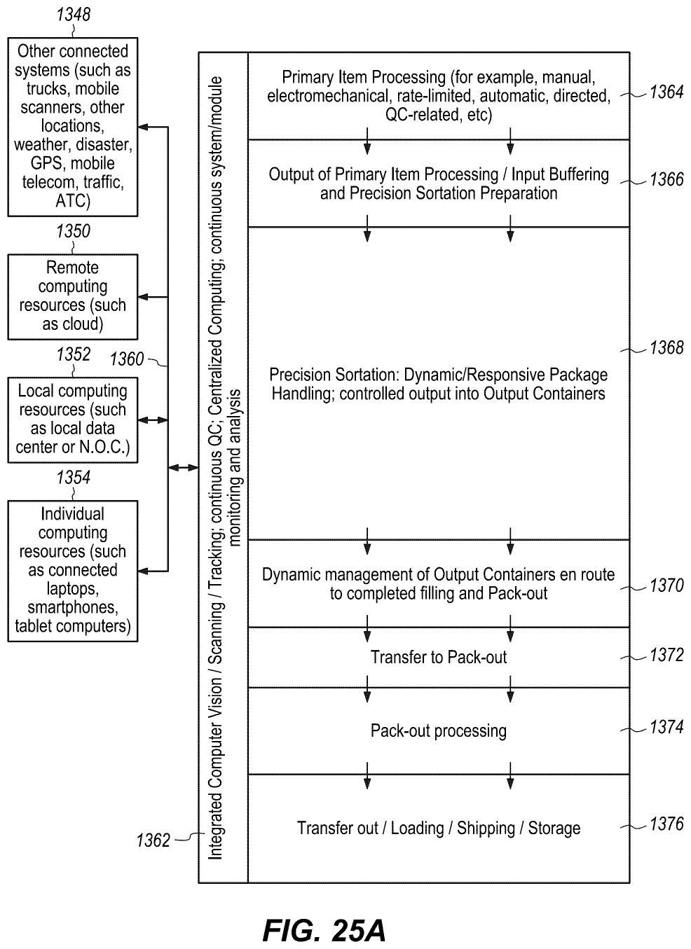

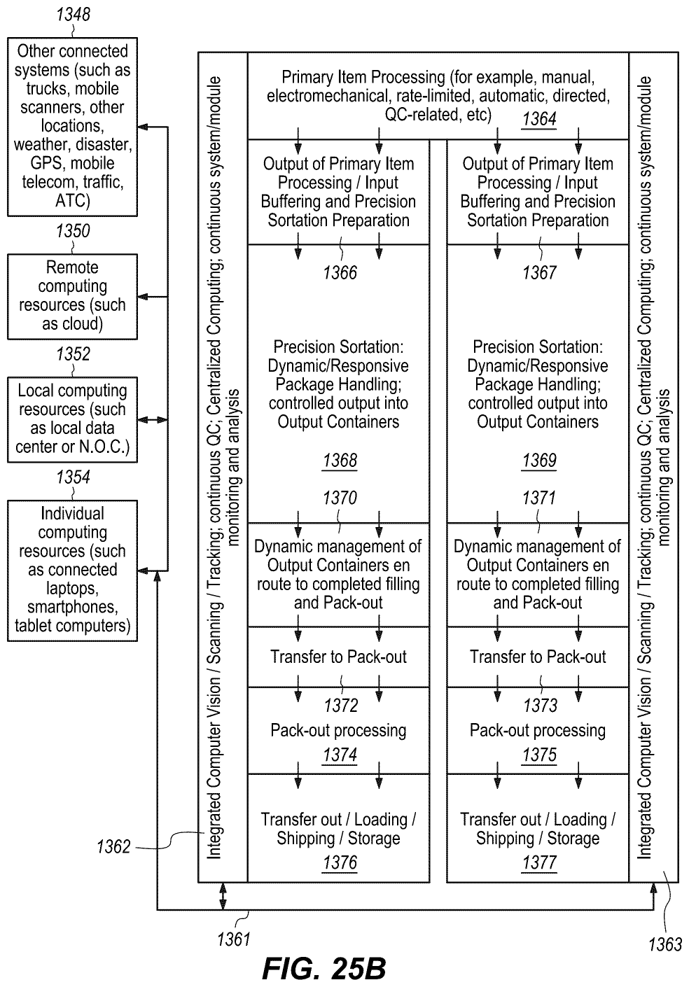

Referring to FIG. 1A, from a high-level flow perspective, various package handling logistical challenges pertain to the processing of packages from various inputs such as incoming truck unloading (950), into a primary item processing configuration wherein the various items may be transported or transferred to a subsystem such as a conveyor, chute, or other structure to generally aggregate various incoming packages and potentially accomplish some processing (952) in preparation for precision sortation (954) to one or more destinations and/or output containers or routing configurations, followed by pack-out processing (956) to process the sorted output for subsequent transfer or shipping (958). Generally such processes are organized to assist with business needs wherein there are various input sources of various types of incoming packages, and there are various outputs for different destinations, output package types, kitting processes, and the like. The system configurations described herein and in the incorporated reference provide significant flexibility and modularity, while also emphasizing speed of throughput as well as due care in the handling of valuable packages and items therein. Referring to FIG. 1B, between each subprocess, there generally is a transfer (960, 962, 964, 966), and these transfers may be accomplished using automated means such as mobile robots, electromechanical conveyance systems, chutes, and the like, they may also be conducted with the assistance of personnel (308), either directly or from a controls perspective. For example, referring to FIG. 2A, at the input side, such as at an incoming truck (282) unloading dock, various large containers, such as those known as “gaylord” containers (284) or pallets (288) comprising various layers or couplings of items (300, 290) may be unloaded using an electromechanical conveyance system (302), and may be locally handled and mobilized using pallet jacks (292), scissor lifts (294), forklifts (296), mobile robots (298), palletizing or pallet-unloading systems (304), and/or electromechanical or hydraulic container dumpers (306) so that they may be directed toward a primary induction buffer (312) such as a large conveyance, as shown in FIG. 2B. Various features (318) such as ramps, chutes, reductions, and steps may be utilized to assist in directing the packages (290) toward a singulation conveyor (316) while also assisting with singulation (unstacking piles, generally moving toward single packages as isolated as possible for sorting and picking processes); for example, referring to FIG. 2C, a controllable (326) overhead structure (324) may be configured to un-stack packages (290) that approach it upon a conveyance table or structure (312). Referring to FIG. 2D, incoming packages (328) from such early processing may then be further processed, such as by image-based analysis and scanning (such as via a barcode scanner or scanning device configured to use captured image information to determine barcode information); various image capture devices (340, 342) are illustrated to assist with identifying, characterizing, and processing the various packages. In scenarios wherein two or more image capture devices are present, they preferably are configured to produce image information that has at least some uncorrelated error (i.e., different devices, from different perspectives, etc) so that so-called “sensor fusion” techniques may be utilized to assist with analysis and determination regarding the various packages by using the aggregation of the information to produce results better than each individual device alone. Incoming parcels (328) pass through the fields of view of one or more scanning and/or image capture devices (340, 342; additional may be positioned underneath a transparent viewing window 344; such devices may comprise computer vision cameras and/or barcode scanners, for example, as described above in reference to the package identification and analysis configurations pertaining to robotic sortation systems; generally they are configured to identify packages as they are moving quickly by, and provide an intercoupled computing system, such as a personal computer, mainframe, mobile computer, or the like (refer ahead to FIGS. 25A and 25B and associated discussion, for example; generally all embodiments herein are discussed in reference to computing resource or computing system connectivity, such as via wired or wireless connection, such as via IEEE 802.11, Bluetooth, nearfield, or other wireless connectivity) with the ability to not only log the presence and instantaneous position of the package, but to also activate a multi-axis conveyor system, such as one featuring a conveyance zone (334) featuring second-axis of conveyance movement which may be utilized to eject or transfer (332) and thereby provide a limited sortation or routing capability during singulation). Various multi-axis conveyor systems, as facilitated by the scanning and identification capability, may be configured to facilitate some early sorting/routing (332), at least some of which may be directly into containers (284) which may be transported (292, 294, 296, 298, etc) directly to pack-out processing. The intercoupled computing system may be configured to operate the various degrees of freedom of the conveyor to divert or exit various packages based upon known positioning of such identified packages on the conveyor, such as via the timing of the scanning (340, 342, 344) and/or the timing or positioning of the conveyor belt or belts, such as from joint monitoring encoders intercoupled into the conveyor drive configuration. Packages or parcels that are not diverted or sorted (330) may be moved ahead along the conveyor system (316) to further processing. Referring to FIG. 2E, in a next sequence of illustrative system configurations wherein processing throughput and velocity is maintained as a maximum as long as possible into the processing, incoming packages (330) may be passed through a scanning configuration (340, 342, 344) as shown, to provide a singulation robot subsystem (360) opportunity to operate a robotic arm (54) and end effector (4) with benefit of the scanning/image capture provided by the scanning configuration (340, 342, 344), to capture, lift, and reposition various parcels or packages (290) for improved singulation on the associated conveyor (346) or other structure, all of which may be operatively coupled to one or more computing systems or resources. In other words, where a package position needs to be adjusted, the robot (54, 4) can move it into better singulation position, subject to computerized automation and/or control, and alternatively given time, provide for a sortation on the spot with delivery straight to a nearby container for transfer to pack-out. A plurality of such singulation robots (360; such as illustrated in FIG. 2G, shown therein with an operatively coupled image capture device 1072 positioned to capture robot operation, such as with a selected package or item 290) is shown in series (but may be in parallel from either side of a conveyor 348, or both series and parallel depending upon throughput objectives). A third scanning configuration is shown after the singulation robots (360) to provide the system with a final viewing of singulation status and a sorting opportunity, such as through multi-degree-of-freedom conveyor: directly (350) to containers (284) for transfer to pack-out, directly (352) to a vision-based robotic sortation system (174) such as is described in reference to FIG. 7A, and/or directly (354) to electromechanical sorting by gantry, further multi-degree-of-freedom conveyor, palletizing robot, or other integrated subsystem (358).

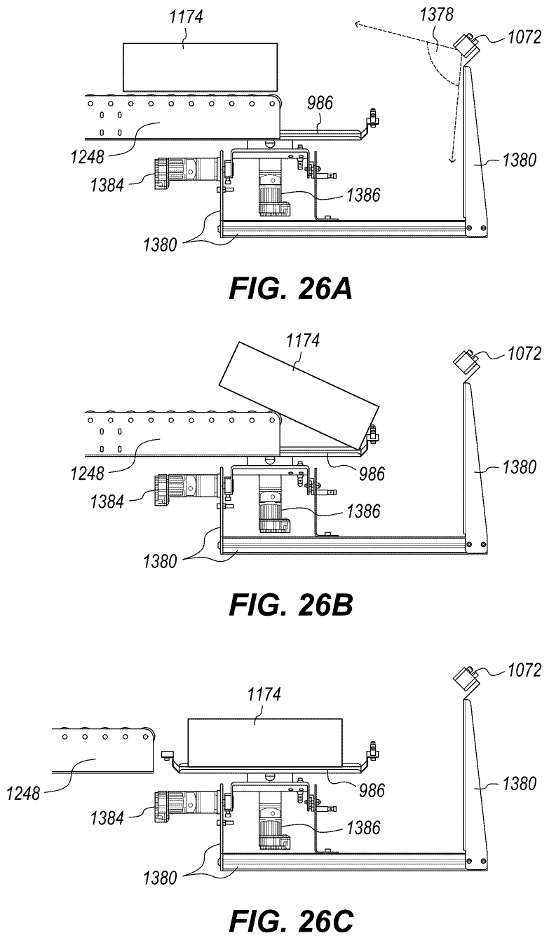

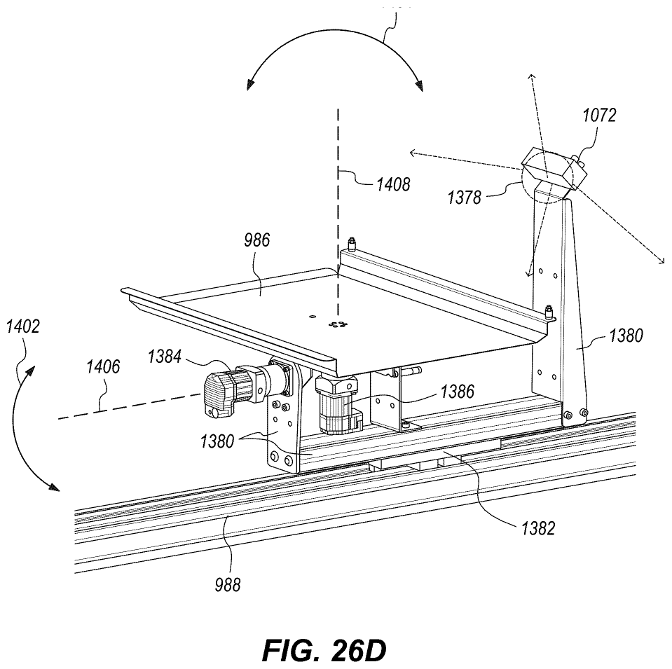

Referring to FIG. 2F, a configuration similar to that of FIG. 26A is illustrated, with an additional multi-degree-of-freedom conveyor (334) for additional diversion (332) alternative, such as for re-routing of non-singulated items (336) or transferring (362) for return (338) to prior processing stage for further singulation. Packages which are not directed to sorting or re-routing (332) may be passed into a remainder capture (356) container, chute, conveyor, or other capture device for re-routing to prior processing stages.

Referring to FIG. 2H, a robotic sortation system (52) such as that described in reference to FIG. 7A is shown with a conveyor (380) input routing feed (352), all of which may be observed by an operatively coupled image capture device (1072) positioned to capture operations such as by the robot (54) and conveyor (380), all of which may be operatively coupled to a computing resource. Referring to FIG. 2I, a group of sortation containers or bins (382) may be served by a sorting robot (54, 4) as described above, which may be fed by a sloped/gravity-feed input container (388) for input packages to be sorted by the robot (54, 4) and placed into one of two electromechanically controllably tiltable distribution containers (386) which may be controllably and electromechanically movable along two linear rail (384) subsystems for delivery into the bins (382). An image capture device (1072) may be operatively coupled and configured to capture operations such as by the robot (54) and rail system (384). Referring to FIG. 2J, a linear rail (384) may also be operatively and controllably coupled to a robot arm (54) for further sorting and distribution alternative configuration, speed, and constraint. As noted above, an image capture device (1072) may be operatively coupled and configured to capture operations such as by the robot (54) and rail system (384). Referring to FIG. 2K, a computerized robotic sorting configuration (54, 4) may be utilized to pick from an sloped input feed container (388) and distribute to one of a stack of three electromechanically controllably tiltable distribution containers (394) which may be controllably and electromechanically movable along three associated linear rail (396) subsystems for delivery into a group of bins (392). An image capture device (1072) may be operatively coupled and configured to capture operations such as by the robot (54), rail system (396), and associated bins (392). Referring to FIG. 2L, in various embodiments, the robotic sortation system may be configured to sort to a top layer of bins or containment features (448), after which a controllably openable door (450) may be switched to an open condition such that parcels or items previously located in the top layer of bins or containment features (448) fall down and are transferred to a lower layer (449) of bins or containment features (448). The doors (450) may be closed again, such that sorting may continue into the upper layer (448), and also such that transfer of the sorted goods out of the lower layer (449) may progress, such as via conveyor or via swapping out the entire lower layer (449) for transfer away from the sorting robot and swapping in of a new/empty lower layer. One or more image capture devices (1072) may be operatively coupled the intercoupled computing resource and configured to capture operations such as by the robot (54) and sortation assembly (52). Referring to FIG. 2M, various exit conduits and configurations may be utilized to guide away sorted packages, such as tilted bin orientations (592), exit conduits or ramps (594), or one or more vertically-oriented layers of controllably releasable doors.

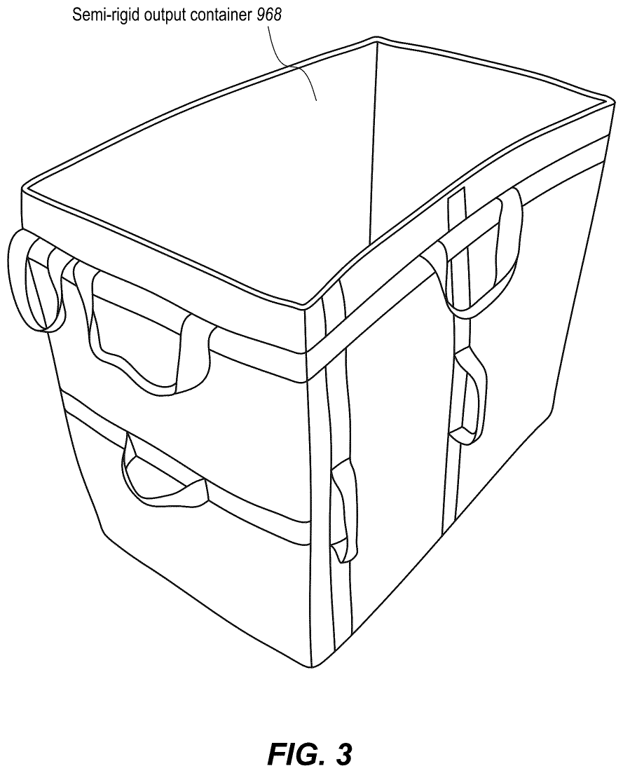

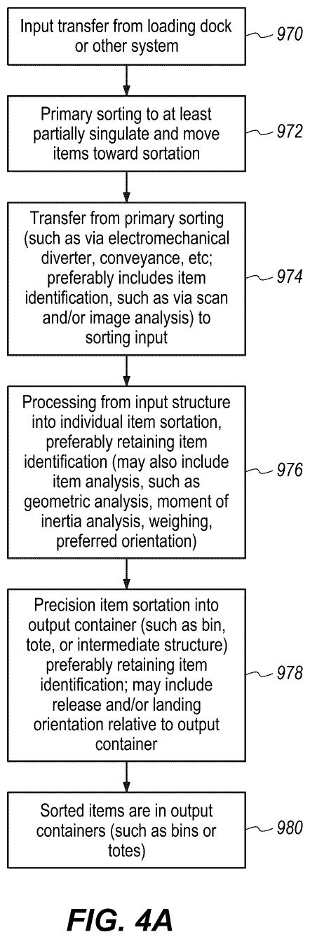

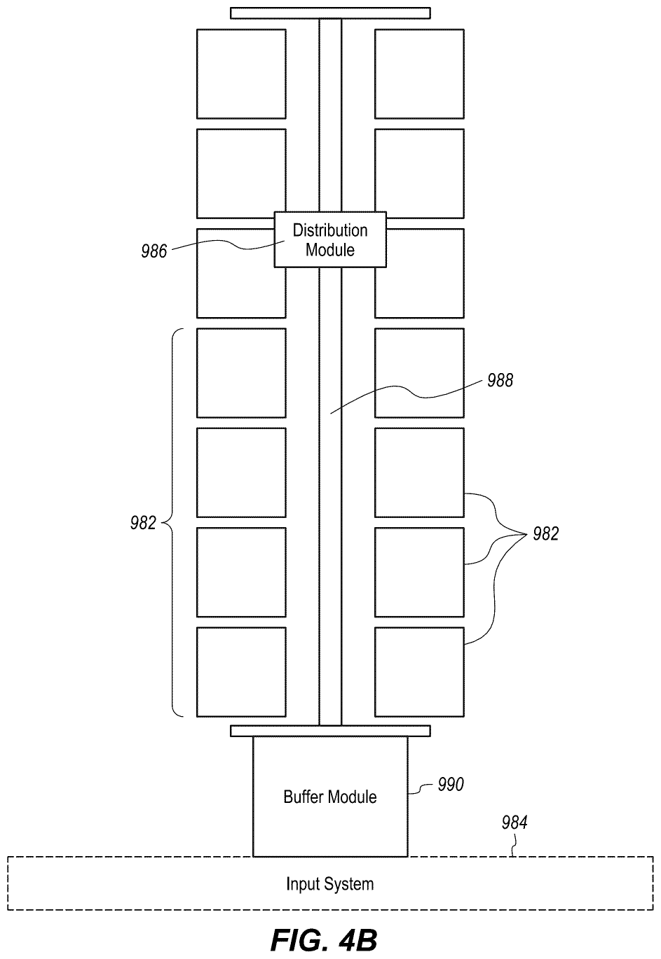

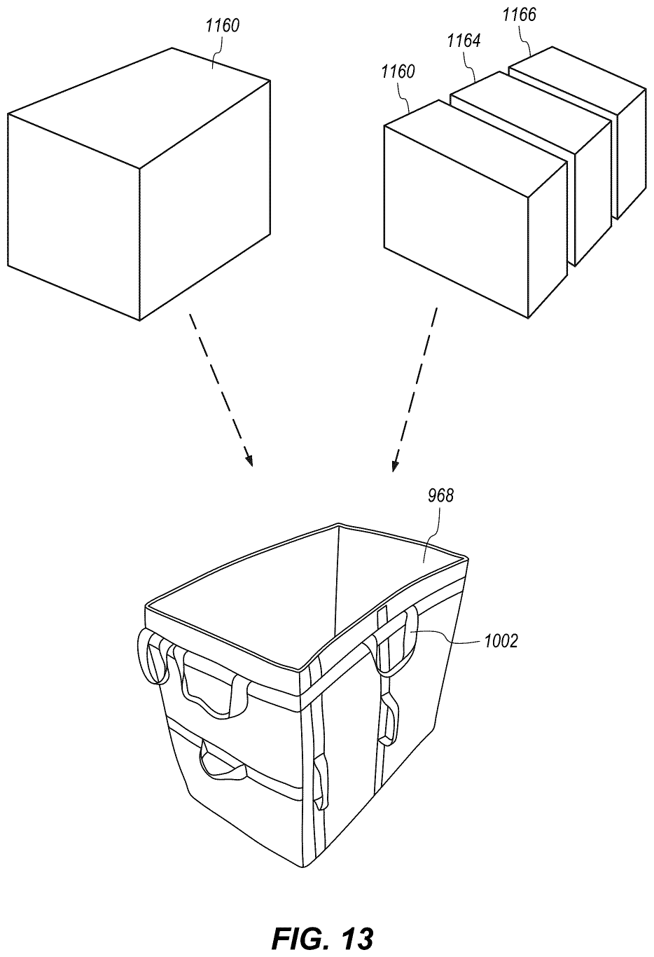

Referring to FIG. 3, in various embodiments it may be of interest to fill, handle, empty, or otherwise process containers such as the semi-rigid rectangular output container (968) shown in FIG. 13, various of which have been widely used in package and parcel processing and delivery logistics. Referring to FIG. 4A, from a high-level perspective, an input transfer from loading dock or other system may be processed (970); primary sorting may be conducted to at least partially singulate and move items toward sortation (972); a transfer may be conducted from primary sorting (such as via electromechanical diverter, conveyance, etc; preferably includes item identification, such as via scan and/or image analysis) to sorting input (974); processing may be conducted from the input structure into individual item sortation, preferably retaining item identification (may also include item analysis, such as geometric analysis, moment of inertia analysis, weighing, preferred orientation) (976). Precision item sortation may be conducted into output container (such as bin, tote, or intermediate structure, such as that illustrated in FIG. 3) preferably retaining item identification; may include release and/or landing orientation relative to output container (978). This may result in the sorted items being in output containers (such as bins, totes, or such as a container such as that illustrated in FIG. 3) (980).

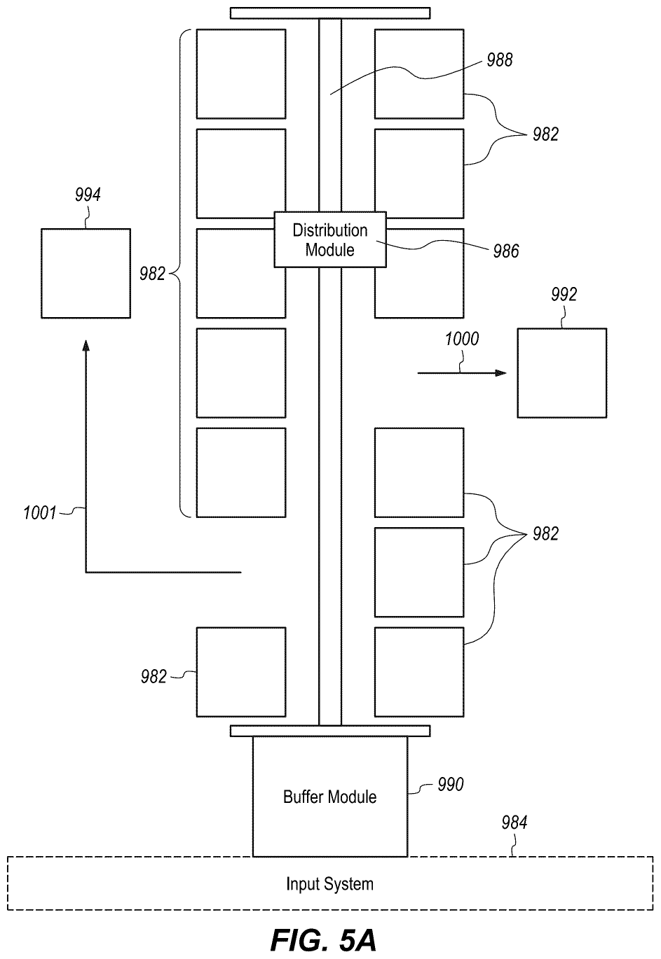

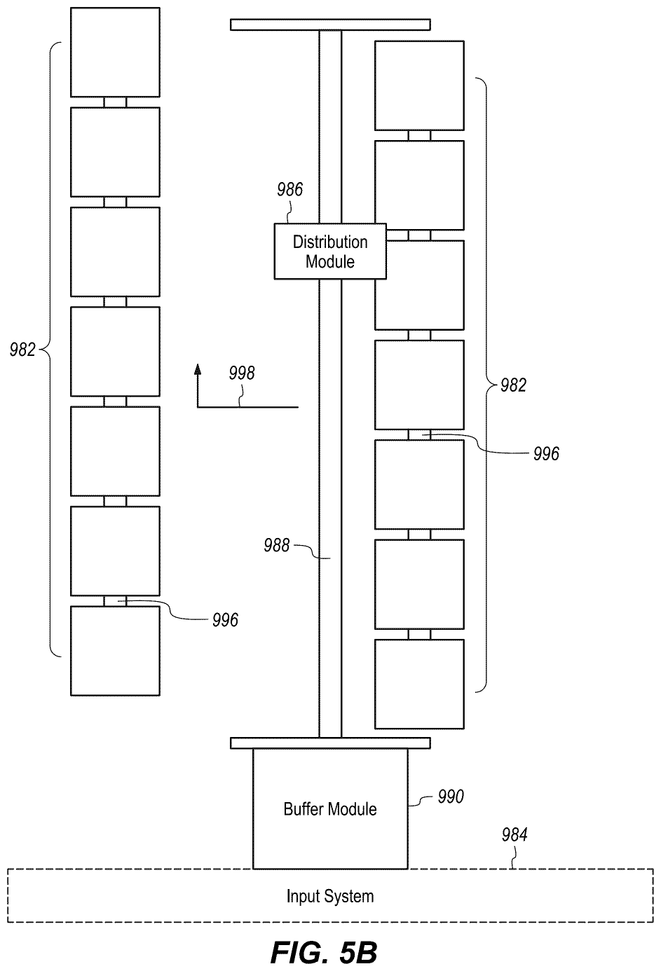

Referring to FIGS. 4B, 5A, and 5B, after incoming packages arrive through primary processing with the input system (984) to a sortation system, they may be automatically advanced onto a buffer module (990, such as a small conveyor, pan/tilt tray, package escalator, ramp and/or chute, or the like; all operatively coupled for computerized/automatic control), which may assist in refining or producing singulation, and which may also be configured to assist in exposing package labeling and preferably orienting packages for further processing as described in further detail below. Referring to FIG. 4B and as described in various configurations in the incorporated reference, the buffer module (990) may be configured to automatically pass packages to a distribution module (986, such as an automatically-controlled pan-tilt bin coupled to a linear rail (988), and/or gantry configuration) so that it may distribute to each of a plurality of local output containers (982).

Referring to FIG. 5A, in various configurations, it may be desirable to be able to transfer out (1001, 1000) individual output containers (994, 992) individually, or to transfer out groupings of output containers (as shown in FIG. 5B, wherein a structural rack (996) may be coupled to a plurality of output containers (982) so that an entire rack with coupled containers may be transferred out (998) together as shown in FIG. 5B, followed by an empty or partially loaded different rack (not shown) being similarly transferred in to continue output sortation as uninterrupted as possible.

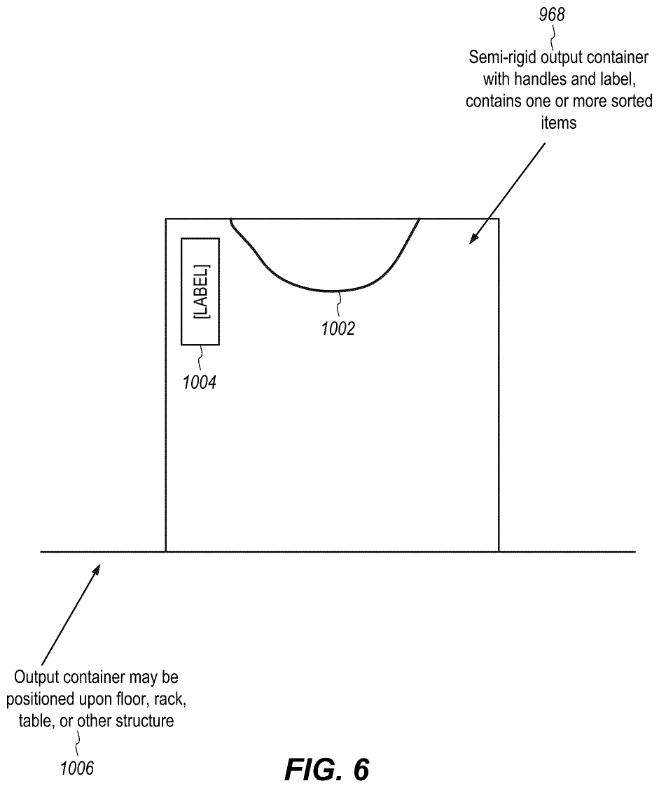

Referring to FIGS. 6-11G, various embodiments are illustrated which may be utilized to electromechanically grasp one or more individual output containers such as that (968) illustrated in FIG. 3. Referring to FIG. 6, an output container (968) may be semi-rigid and comprise a generally rectangular-prismic geometry with one or more external labels (1004) and two or more external handles (1002, 1003).

Referring to FIG. 7A, a labelled tote containing item, ready to be transferred to pack out; positioned upon structure (such as table, rack, floor) (1008); a vision system may be utilized to establish geometric bounds and orientation of tote as currently positioned (1010). Various tote grasp approaches may be analyzed and an execution grasp selected (1012). A removable coupling module maybe coupled to transport subsystem is electromechanically advanced toward tote structure (1014) and a removable coupling may be executed; a tote or output container may be removably coupled to a transport subsystem using a removable coupling module such as a robotic manipulator (1016). The tote may be moved to an intermediate or pack-out position and oriented using a transport subsystem (1018).

Referring to FIG. 7B, a labelled individual tote containing item may be ready to be transferred to pack out; positioned upon structure (such as table, rack, floor) (1020). A vision system may be utilized to establish geometric bounds and orientation of tote as currently positioned (1022). Tote or output container grasp approaches may be analyzed and an execution grasp selected (1024). A removable coupling module coupled to transport subsystem may be electromechanically advanced toward tote structure (1026). A removable coupling may be executed; tote may be removably coupled to transport subsystem using removable coupling module (1028). The labelled individual tote may be moved to intermediate or pack out position and orientation using transport subsystem (1030).

Referring to FIG. 7C, an assembly of individual totes containing items (such as a rack removably coupling a plurality of totes together), may be ready to be transferred to pack out; positioned upon structure (such as table, rack, floor) (1032). A vision system may be utilized to establish geometric bounds and orientation of tote assembly as currently positioned (1034). Tote or output container grasp approaches may be analyzed and an execution grasp selected (1036). A removable coupling module coupled to the transport subsystem may be electromechanically advanced toward the tote assembly structure (1038). A removable coupling may be executed with the tote assembly removably coupled to the transport subsystem using the removable coupling module (1040). The tote assembly may be moved to an intermediate or pack out position and orientation using the transport system (1042).

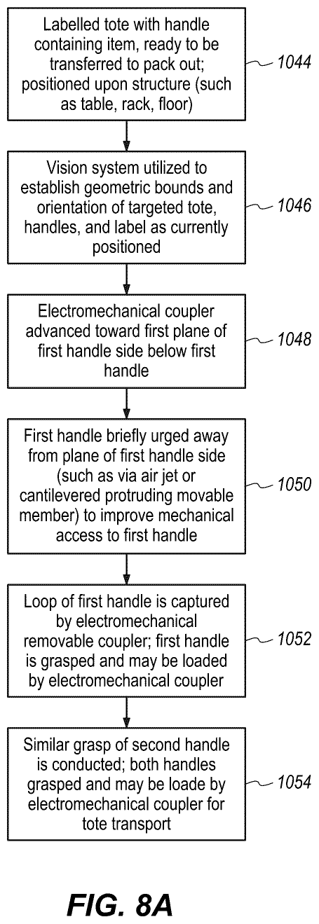

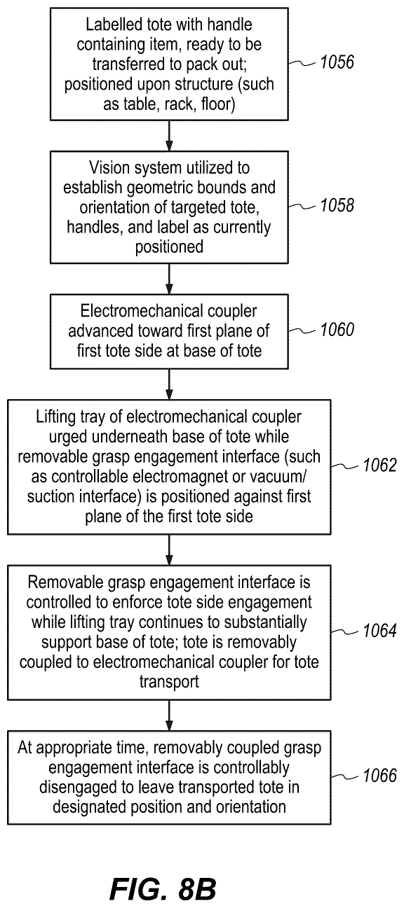

Referring to FIG. 8A, a labelled tote with handle containing item, may be ready to be transferred to pack out; positioned upon structure (such as table, rack, floor) (1044). A vision system may be utilized to establish geometric bounds and orientation of targeted tote, handles, and label as currently positioned (1046). An electromechanical coupler may be advanced toward a first plane of first handle side below first handle (1048). A first handle may be briefly urged away from plane of first handle side (such as via air jet or cantilevered protruding movable member) to improve mechanical access to first handle (1050). A loop of the first handle may be captured by electromechanical removable coupler; first handle is grasped and may be loaded by electromechanical coupler (1052). A similar grasp of a second handle may be conducted; both handles grasped and may be loade by electromechanical coupler for tote transport (1054).

Referring to FIG. 8B, a labelled tote with a handle containing an item, may be ready to be transferred to pack out; positioned upon structure (such as table, rack, floor) (1056). A vision system may be utilized to establish geometric bounds and orientation of targeted tote, handles, and label as currently positioned (1058). An electromechanical coupler may be advanced toward a first plane of a first tote or output container side at the base of the container (1060). A lifting tray of the electromechanical coupler may be urged underneath base of tote while removable grasp engagement interface (such as controllable electromagnet or vacuum/suction interface) is positioned against first plane of the first tote side (1062). A removable grasp engagement interface may be controlled to enforce tote side engagement while lifting tray continues to substantially support base of tote; tote is removably coupled to electromechanical coupler for tote transport (1064). At an appropriate time, the removably coupled grasp engagement interface may be controllably disengaged to leave transported tote in designated position and orientation (1066).

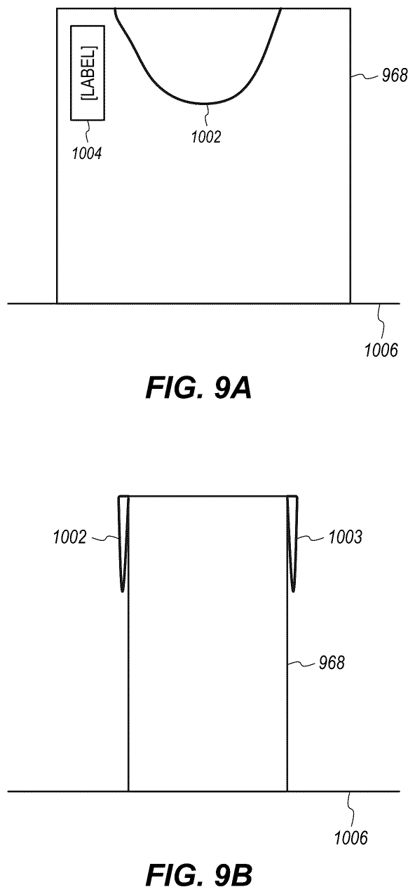

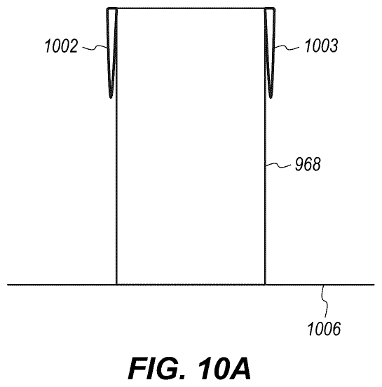

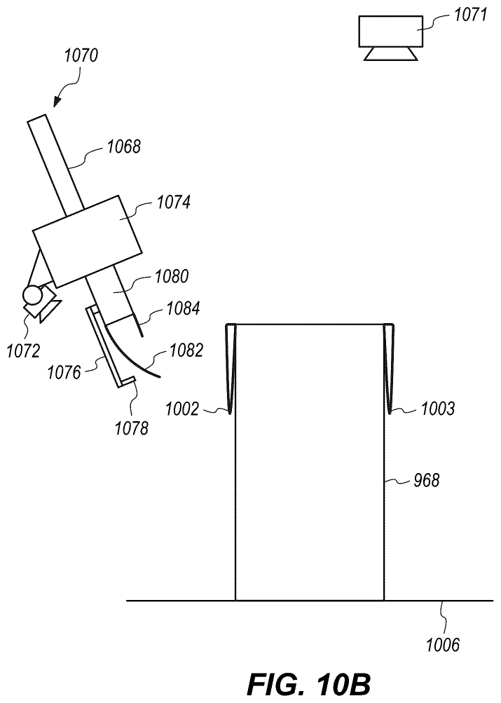

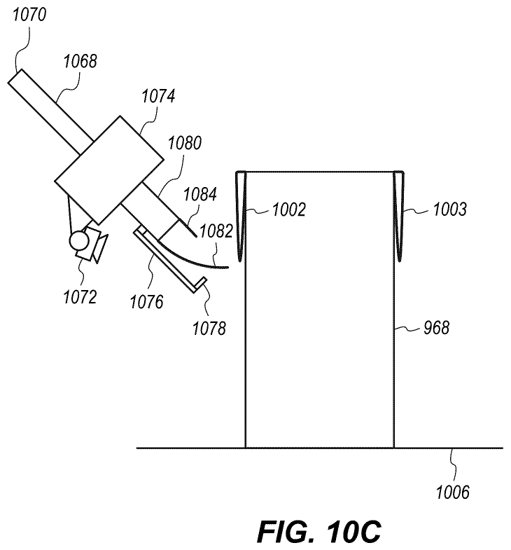

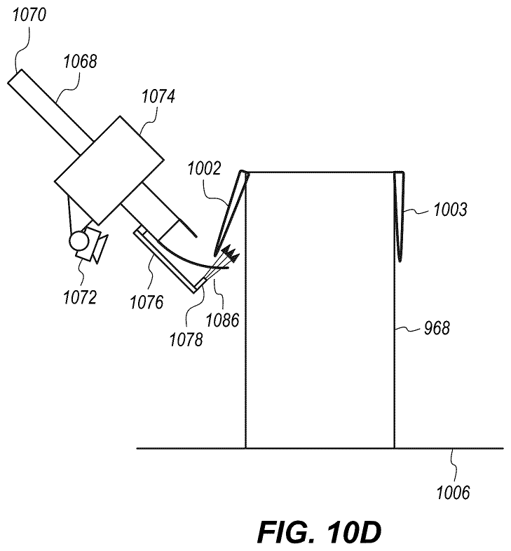

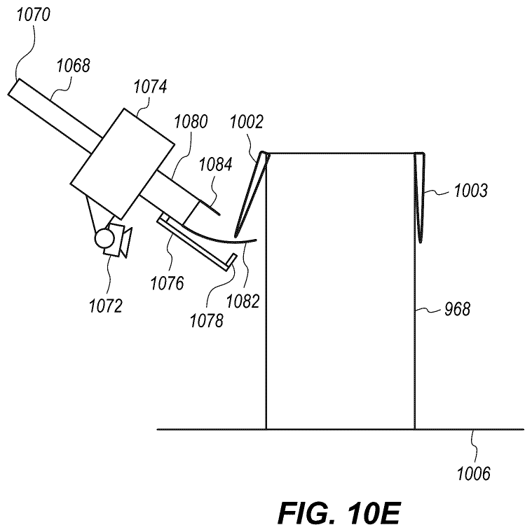

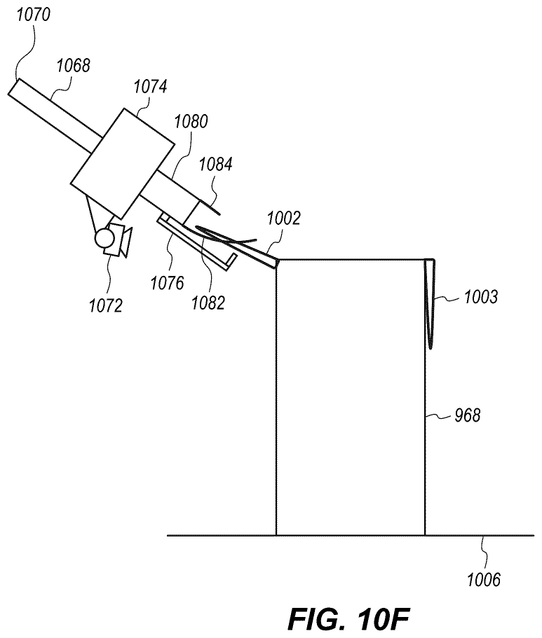

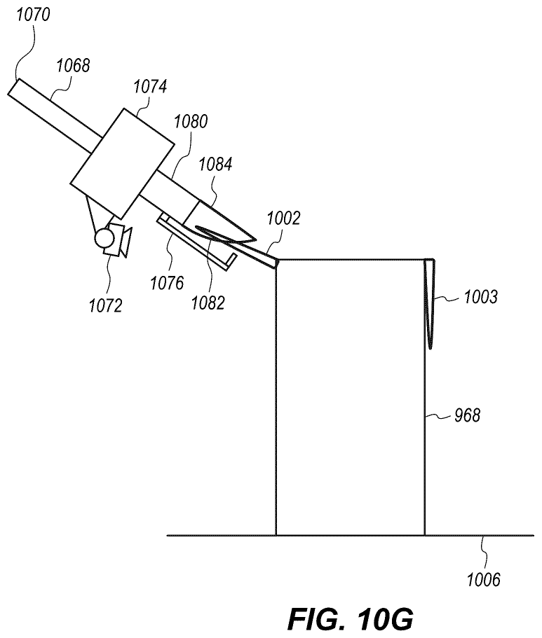

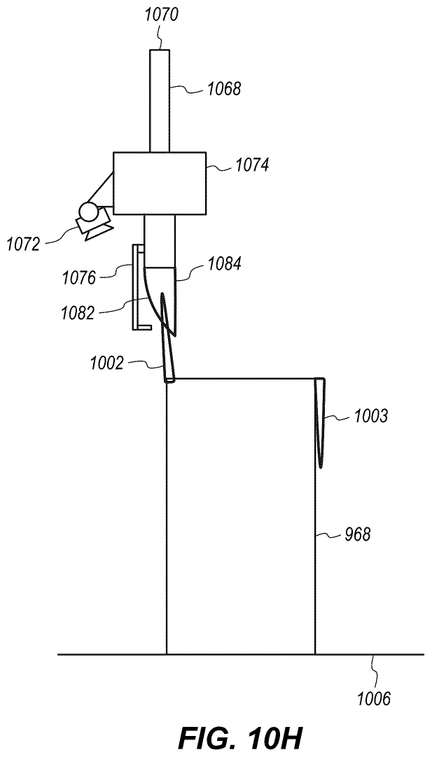

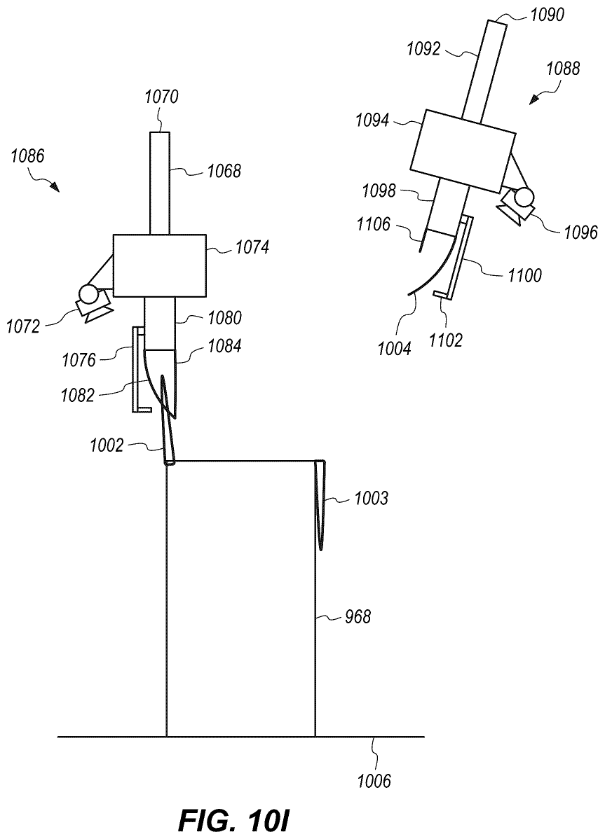

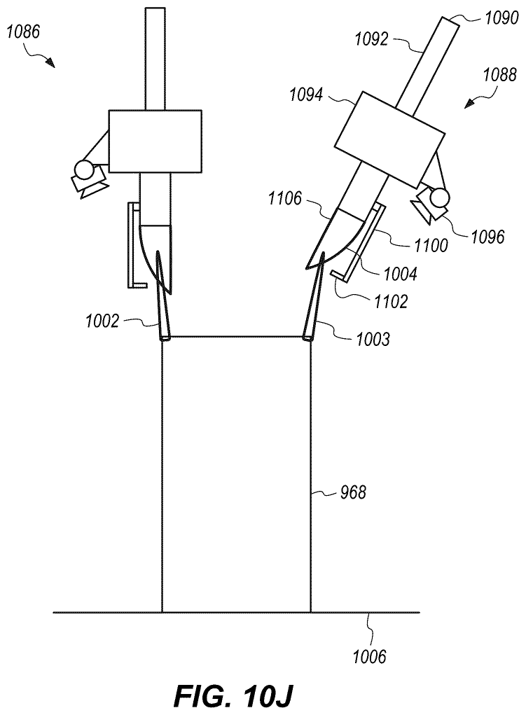

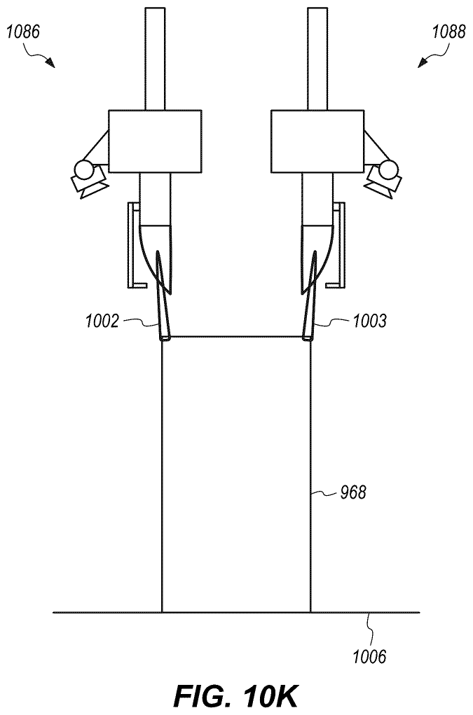

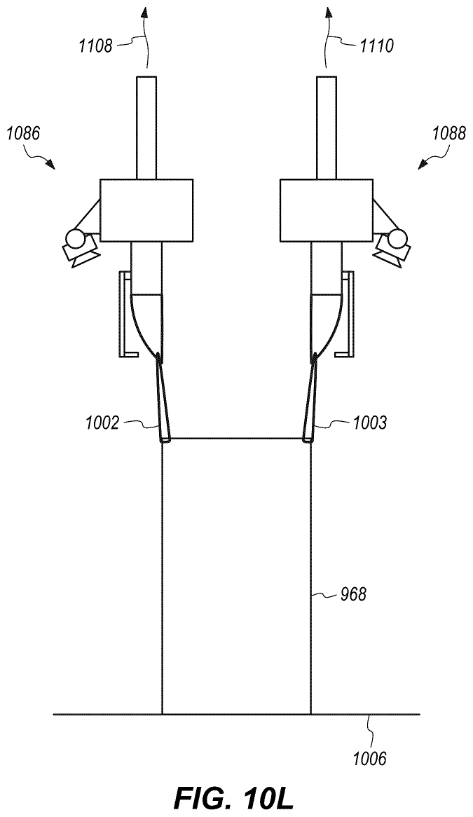

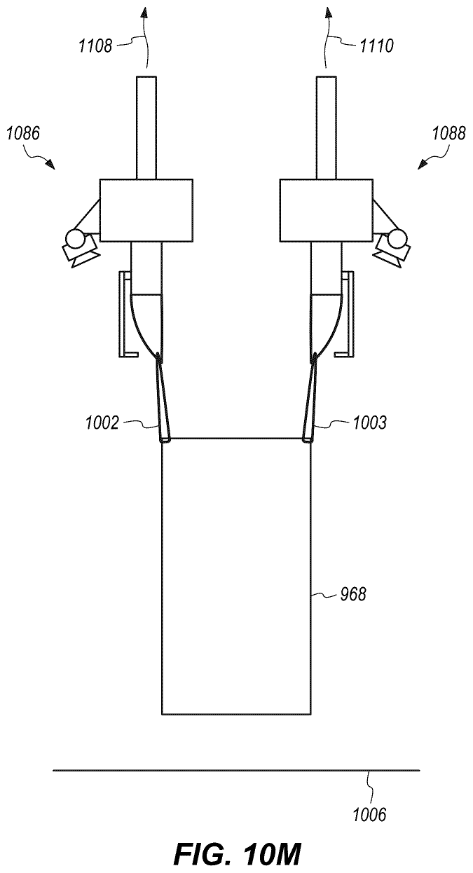

Referring to FIGS. 9A, 9B, and 10A, orthogonal views of a tote or output container (986) with handles (1002, 1003) are illustrated placed on a floor or other structure (1006) such as a rack or buffer structure. Referring to FIG. 10B, a computerized electromechanical or robotic manipulator (1068) system, the proximal end (1070) of which may be operatively coupled to another electromechanical system such as a robot arm (not shown; also operatively coupled to computing resource), may comprise an actuator module (1074) comprising one or more motors or actuators configured to controllably move or actuate one or more distal grasping members (1084, 1082), such as via lead screw, servo motor, stepper motor, and the like relative to the actuator module (1074) to controllably capture a structure such as a container handle (1002) as shown. One or more image capture devices (1072) may be positioned and oriented to assist with observing and automatically controlling such activity. Referring to FIGS. 10C and 10D, the manipulator (1068) may be automatically positioned and oriented to place a distal tip (1078) of a controllable air conduit (1076) adjacent to a targeted handle (1002) so that the air may rotate the handle upwards so that it is easily exposed to allow it to be captured by the intended distal grasping member (1082) as shown in FIGS. 10E and 10F, after which the other distal grasping member (1084) may be extended to capture the handle (1002), as shown in FIG. 10G, and pull the handle (1002) into tension and/or different orientation, as shown in FIG. 10H. The manipulator assembly (1086) may be matched with another similar manipulator assembly (1088; robotic manipulator 1092 with proximal end 1090 coupled to another controllable subsystem, not shown; actuator module 1094; image capture device 1096; air conduit 1100 with distal portion 1102; grasping members 1106, 1104) so that the other handle (1003) may be similarly grasped and the entire container or tote (968) controllably lifted away and/or reoriented, as shown in FIGS. 101-10M.

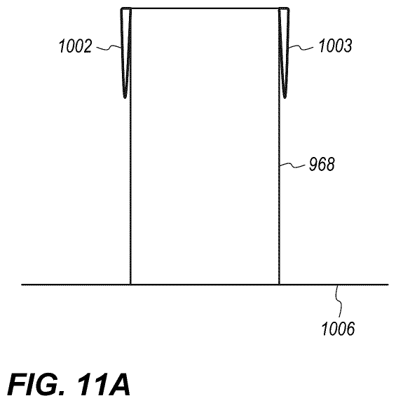

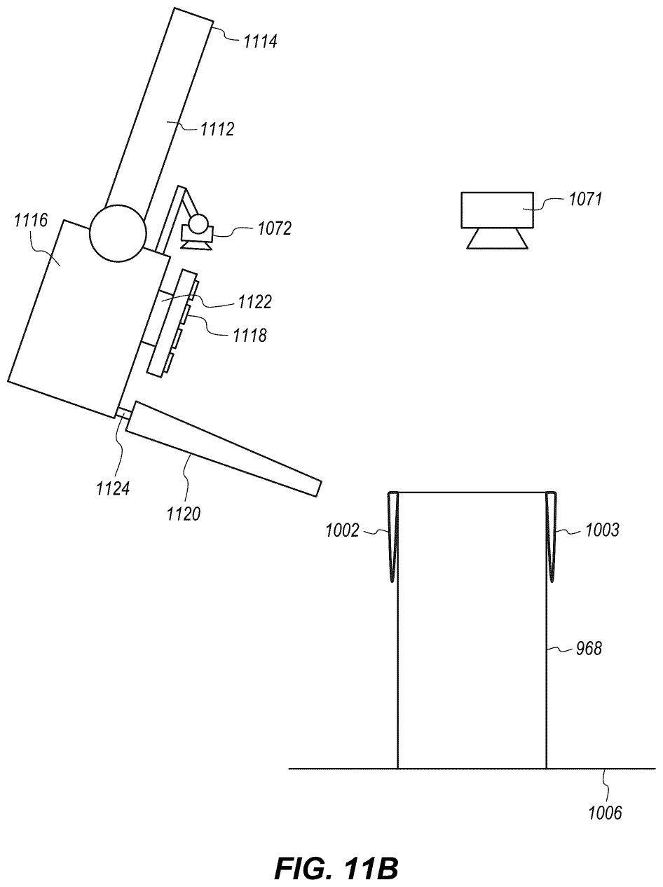

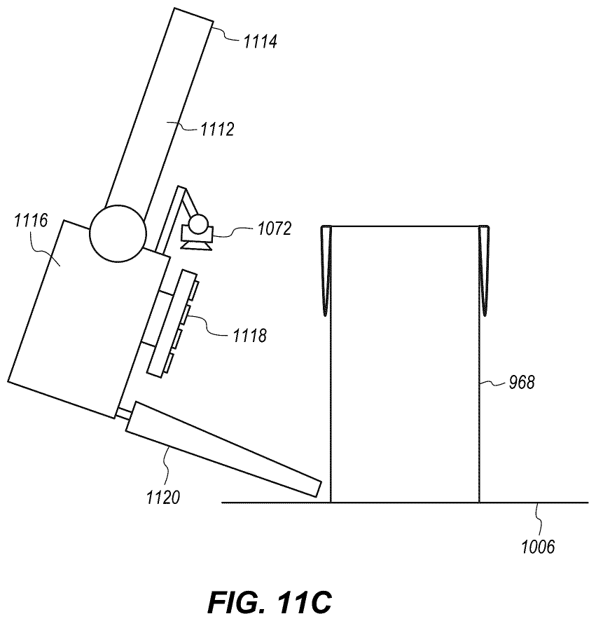

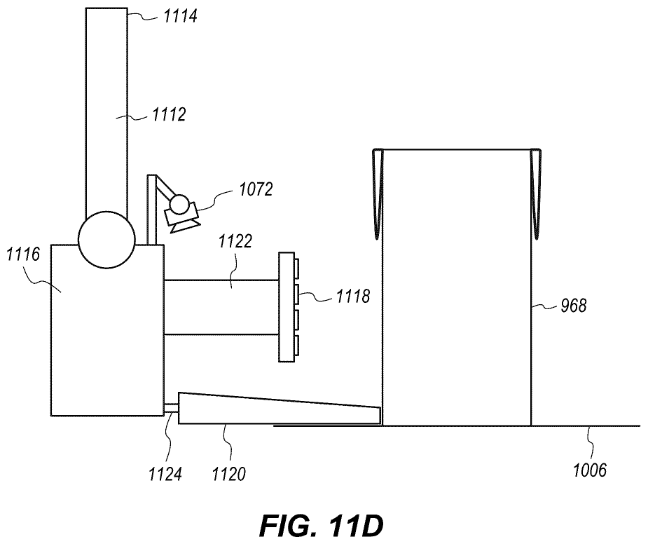

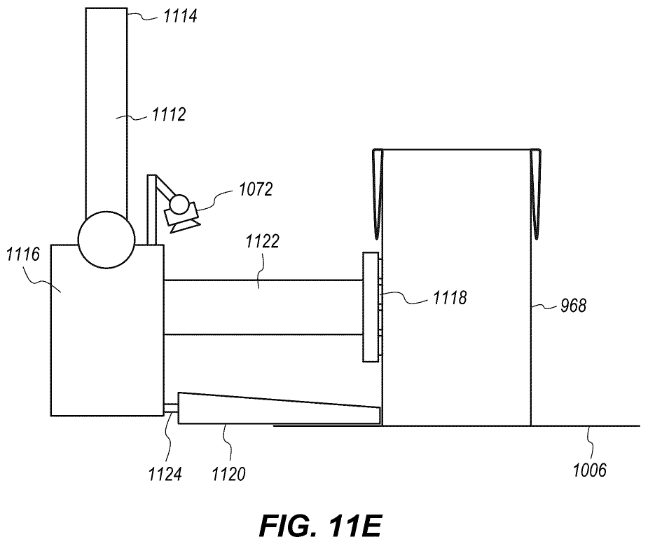

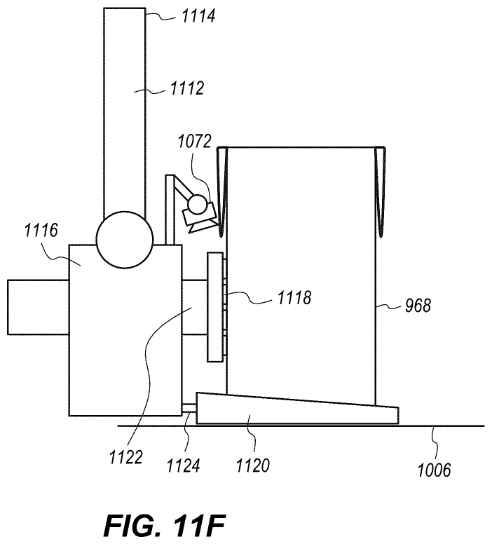

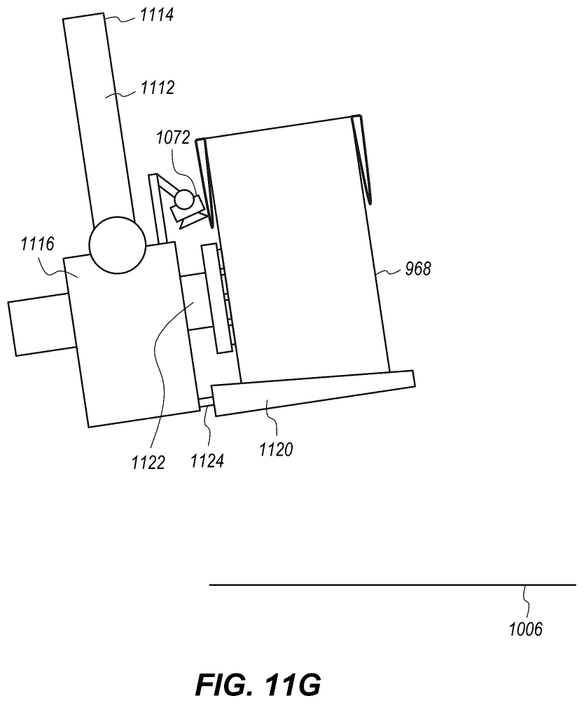

Referring to FIGS. 11A-11G, another embodiment of a robotic manipulator configuration is illustrated for removably coupling to and lifting away/repositioning/relocating an individual output container or tote such as that illustrated in FIG. 3. Referring to FIG. 11A, an individual output container or tote (968) is shown resting on a surface or structure such as a rack or floor (1006). Referring to FIG. 11B, a robotic manipulator (1112) is shown approaching (via coupling at its proximal end 1114 to another electromechanical subsystem such as a robotic arm; the manipulator 1112, image capture devices 1071, 1072, vacuum end effector 1118, and other components being operatively coupled to a computing resource) the container (968) and being operatively coupled to one or more image capture devices (1072), an actuator module (1116) which may comprise one or more electromechanical actuators, such as motors, lead screws, belts, gearsets, and the like, configured to controllably move an operatively coupled vacuum suction cup array end effector (1118) and operatively coupled lifting tray (1120). An image capture device (1071) may be operatively coupled and configured to capture operations such as by the robotic manipulator (1112) pertaining to the output container or tote (968). In one embodiment, each of the vacuum end effector array (1118) and lifting tray (1120) may be controllably inserted and retracted using a lead screw member (1122, 1124) powered by motors within the actuator module 1116). Referring to FIGS. 11C and 11D, the manipulator assembly may be positioned and oriented under vision-based (1072) control to be immediately adjacent to the targeted container (968), after which a combination of controlled insertion of the vacuum end effector array (1118) and lifting tray (1120), followed by vacuum coupling of the vacuum end effector array (1118) to the targeted container (968), as shown in FIG. 11E, and retraction of the vacuum end effector array (1118) relative to the lifting tray (1120), to pull the targeted container (968) securely onto the lifting tray (1120) for transport, as shown in FIGS. 11F and 11G.

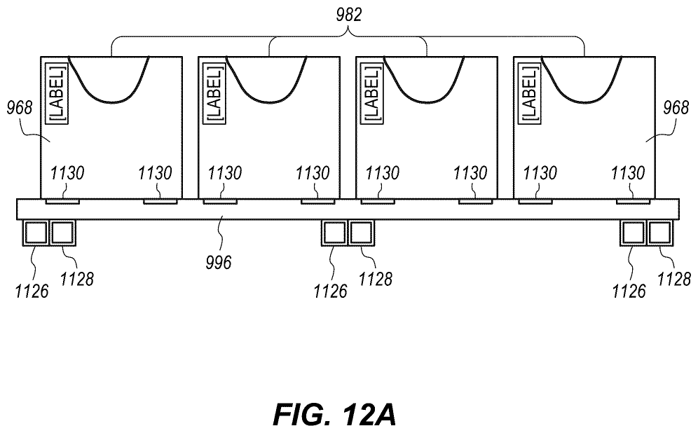

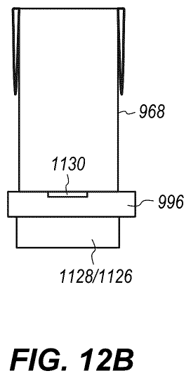

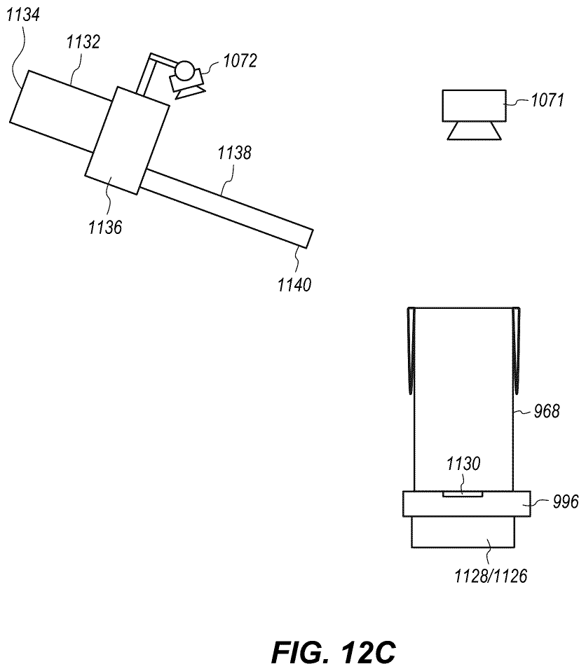

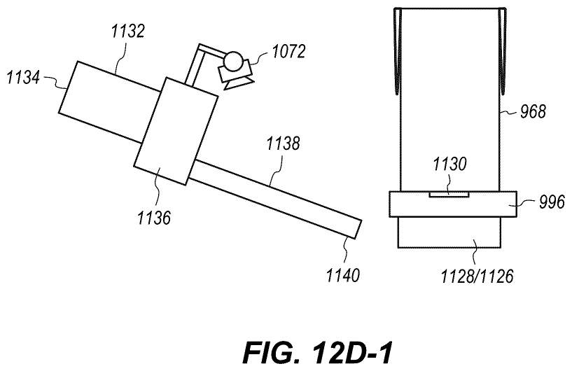

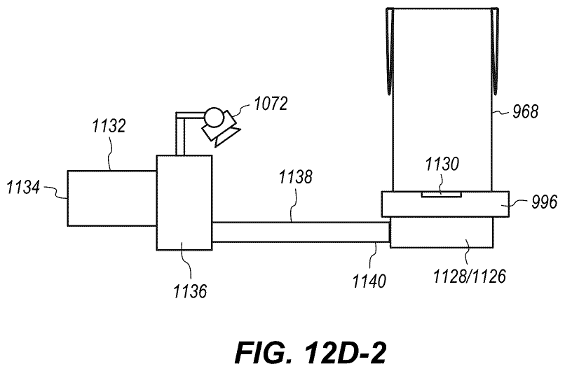

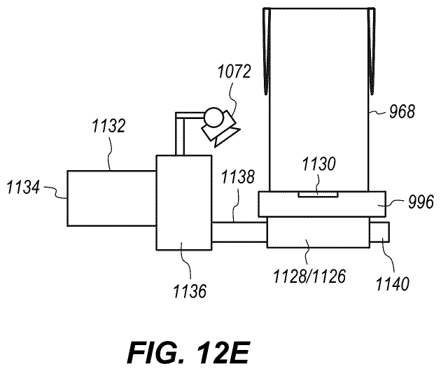

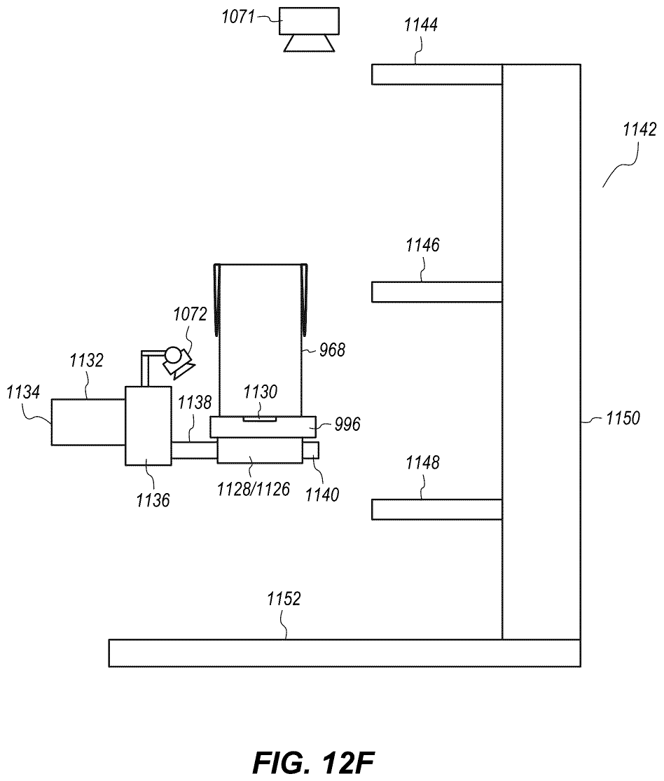

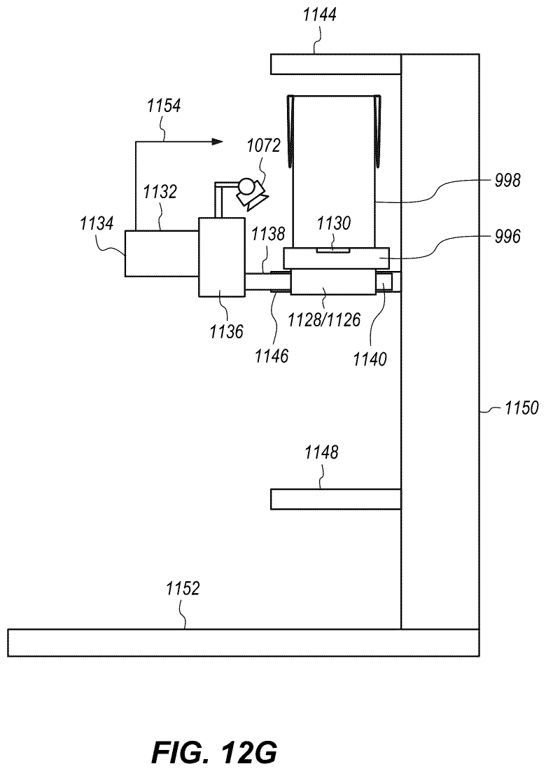

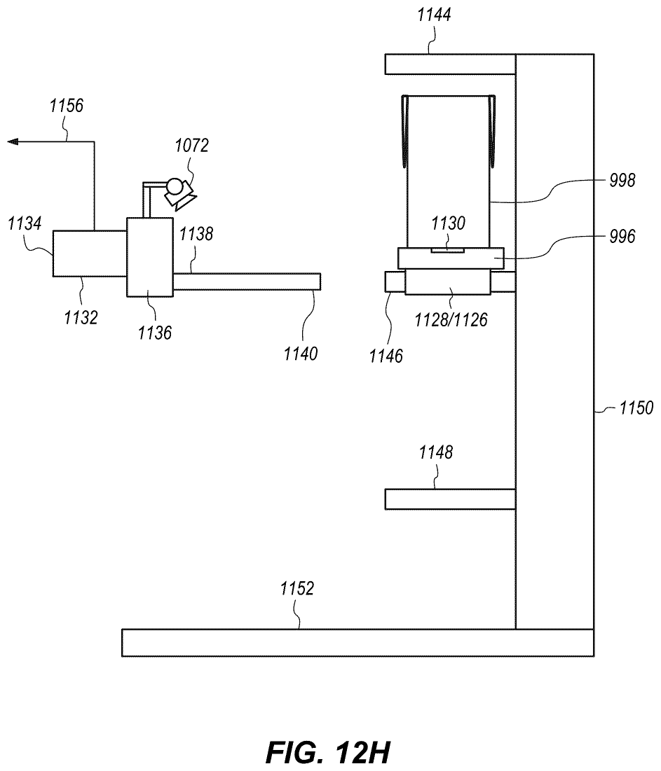

Referring to FIGS. 12A-12H, a structural rack (996) may be utilized to couple a plurality of output containers (982) together so that they may be transported to and from a sortation or other subsystem in a unified and efficient manner. Referring to FIG. 12A, each (968) of the plurality (982) may be removably coupled to the rack (996) using a plurality of permanent magnets or electromagnets or releasable latches (1130) configured to interface with various ferrous or mechanical features of the bottoms of the containers (986); these couplings may be configured to allow for easy and fast coupling, but also to prevent decoupling when a rack (996) is being moved or accelerated about during operation. The embodiment of FIG. 12A comprises pairs of mechanical coupling features, such as rectangular conduits (1126, 1128), which may be removably coupled to other rack structures, such as storage rack shelve structures, or protruding lifting members of a lifting manipulator, or both, as discussed below. FIG. 12B illustrates a side orthogonal view of a configuration such as that in FIG. 12A. Referring to FIG. 12C, a robotic manipulator (1132) may comprise a proximal end (1134) operatively coupled to another system such as a robotic arm, and may feature one or more operatively coupled image capture devices (1072, 1071), actuator module (1136; may contain motors, actuators, lead screws, and the like for operating nearby hardware such as a controllable protruding member 1138 having a distal portion 1140 mechanically configured for operative coupling with one or more aspects 1128/1126 of an associated rack structure 996). As shown in FIGS. 12C, 12D-1, and 12D-2, under preferably automatic vision-based control, the manipulator may be advanced toward the targeted rack (996); as shown in FIG. 12E, the distal portion (1140) may be inserted into a selected feature (1128/1126) of the rack for coupling, after which the selected rack (996) may lifted away, moved, reoriented, and advanced, for example, toward a storage or intermediate processing rack (1142) comprising a plurality of shelf structures (1144, 1146, 1148), a vertical support (1150), and a base support (1152), the shelves being configured also to be releasably coupled to one or more of the coupling features (1128, 1126) of the movable rack (996). As shown in FIGS. 12F and 12G, the movable rack (996) may be coupled to the storage rack shelf (1146), preferably via vision based automatic control (such as via one or more operatively coupled image capture devices 1072, 1071), and the manipulator may be retracted or withdrawn (1156) to do other work while the movable rack (996) remains temporarily coupled to the shelf (1146).

Referring to FIG. 13, in various scenarios, it may be challenging to fit a particular package (1160) into a given output or transportation container (968) without specific relative orientation of these structures. In other words, the single relatively large package or item (1160) shown in FIG. 13 may, indeed, fit within the targeted container (968), but only in a specific orientation relative to that container (968). Similarly, a group of three packages (1162, 1164, 1166) may only fit within the bounds of a targeted output container (968) when they are in specific positions and/or orientations relative to each other. The subject system may be configured to utilize vision and other tracking technologies to not only characterize the geometry of the selected packages and targeted output container, but also to optimize grasps, positioning, orientation (within the destination container, and also at intermediate locations during processing, such as in front of a barcode scanner or upon an intermediate buffer or table structure before further handling into the targeted output container), sequencing, acceleration, loading, and other factors to accomplish a desired result with a high rate of throughput speed. In one embodiment, operatively coupled image capturing/vision technologies may be utilized, along with a neural network trained in accordance with a supervised learning model, unsupervised learning model, and/or reward-based reinforcement learning model (each of which may be trained using actual image data, synthetic image date, or combinations of both) to understand the geometric bounds of various packages, fit prism geometries around them, identify labeling upon various sides of aspects of various packages, and analyze candidate grasp locations based at least in part upon factors such as: end effector type (such as single or plurality vacuum-suction-cup based end effector; or two-fingered grasper; or lifting tray+vacuum-suction-cup-array), determined free substantially-planar surface areas of a particular package, determined location of labeling information, determined mass of particular package, range of motion of associated robotic manipulator and/or related singularities, allowable global positioning envelope, allowable accelerations, allowable loading (for example, given meta data associated with a particular label upon a package; and/or based at least in part upon determined or estimated package mass, modulus, detection of loose objects within the package, and/or detection of sounds pertaining to the package, such as potentially fragile contents that make detectable noises when accelerated), and other factors.

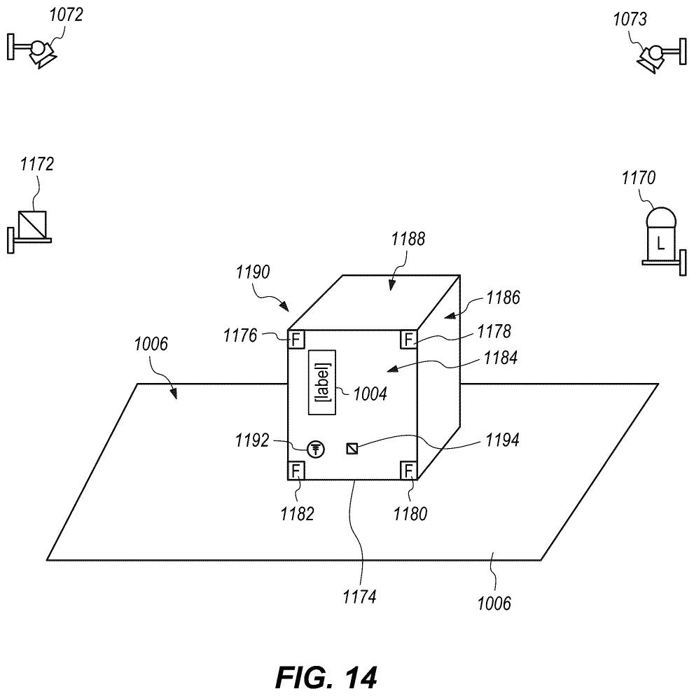

Referring to FIG. 14, a targeted package (1174) may comprise various features to expedite and enhance system tracking and processing, and these configurations and principles may be applied similarly to various containers as well, such as particular output containers (968). As shown in FIG. 14, a particular package (1174) may feature an external label (1004), which may feature textual and/or graphic material, and may be captured in image format and/or as a successful barcode, QR code, or other symbolic read. The package may also feature one or more fiducials (1176, 1178, 1180, 1182), such as marks, codes, patterns, or the like, which may be operatively coupled to meta data or information such as designated package side information (for example, they may identify the forward-presented side 1184 as one that is substantially planar, contains the label, and comprises a relatively stiff cardboard backing optimized for vacuum end-effector coupling, relative to other sides such as 1188, 1190, 1186 which may be sub-optimal for vacuum end-effector coupling and/or not contain label information). Such features may be configured to rapidly provide the electromechanical processing system with this type of information to assist with expedient processing and generally less de-novo analysis at one or more stages of processing. The package (1174) or container also may contain one or more geometric features configured to be easily and rapidly detected by not only an image capture device (1072, 1073, for example, which may be coupled to a portion of the electromechanical system, frame structure, aspect of the room structure such as ceiling or wall, or the like; suitable image capture devices may comprise simple cameras, IR or other spectrum sensors, depth or time-of-flight cameras such as those available from Intel under the tradename RealSense™, and the like) or scanner (such as a barcode scanner or image capture device configured to determine barcode information based upon captured image information), but also an operatively coupled LIDAR sensor (1170; also maybe coupled to system, frame, wall, ceiling, etc; such as those available under the tradename Hokuyo™), and or electromagnetic tracking detector (1172; also maybe coupled to system, frame, wall, ceiling, etc) which may be configured to determine position and orientation of a small coil box (1192; such as those manufactured by Northern Digital, Inc or Polhemus, Inc) which may be coupled to one predetermined aspect of the targeted package (1174) or container. Similarly, one or more small, relatively low-power wireless transmitters (1192) may be embedded or coupled to a given package (1174) or container to assist with identification and/or localization (such as via transceiver triangulation and/or nearfield identification or signal analysis/strength techniques) of particular packages and/or containers involved in a logistics process configuration. Each of these sensors and/or image capture devices may be operatively coupled to a computing resource to facilitate automatic identification and characterization, such as bounding box estimation, geometry estimation, mass estimation, stiffness estimation, reference to stored information (such as meta data previously associated with a given item identifier such as a barcode), and other operations.

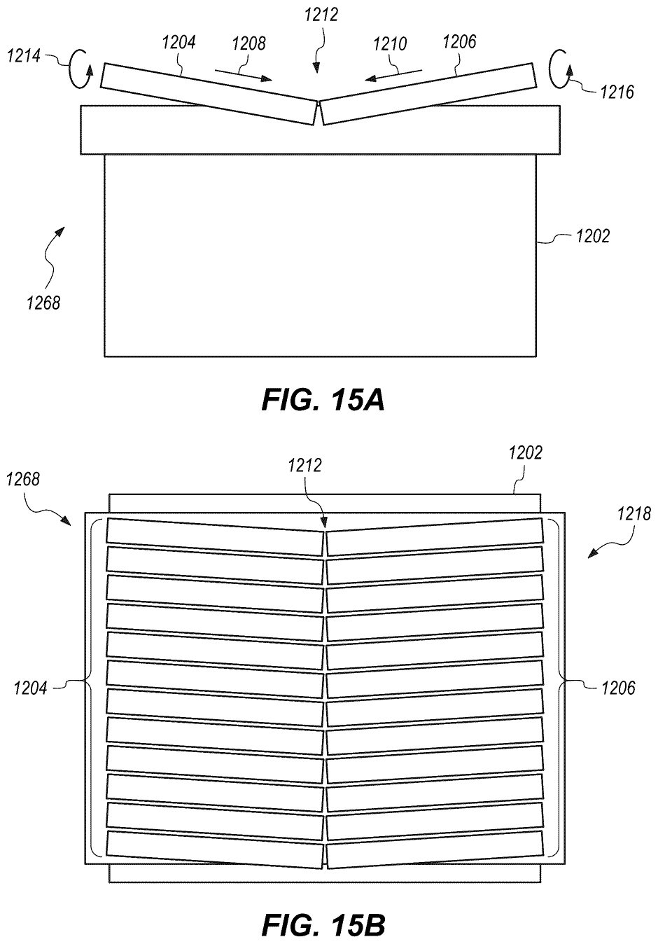

Referring to FIGS. 15A-15B, a central-gathering herringbone type of conveyance (1268) configuration is illustrated which may be utilized to electromechanically move and/or re-orient a given package that encounters such conveyance—to, for example, orient such package for optimal scanning and/or orient/vector such package toward a next step of processing en route to pack-out. Such operations may be conducted automatically utilizing operatively coupled computing resources and information from modules such as image capture devices. Referring to FIG. 15A and orthogonal/top view FIG. 15B, two assemblies (1204, 1206) of generally cylindrical and controllably rotatable members are angled up, for example at about 15 degrees of rotation, relative to a table or base structure (1202) so that a package will generally move (1208, 1210) toward a central position (1212) with vibration and movement of the members (1204, 1206). In one embodiment, each assembly (1204, 1206) may be rotated independently together, so that a package may be advanced off of the conveyance (1268), or in opposing rotational (1214, 1216) directions, in which case a package at the center (1212) will be rotated relative to the table (1202). Such a subsystem may be configured to have various modes, such as one wherein after a package may be automatically moved toward the center (1212) and then rotated until it resides label-up for a label scan by a nearby intercoupled scanning or image capture device. Such system may also be configured to orient a package in a manner that is optimized for further processing. For example, a known heavier side of the package may be left facing downward as the package is transferred off of the conveyance to another subsystem; or a labelled side may be intentionally exposed to a scanner or image capture device at a known vector; or a substantially planar aspect suitable for vacuum end effector grasp may be exposed directly for quick interfacing with a nearby vacuum end effector grasper for subsequent processing. In various embodiments, it is desirable to maintain system level identification of a particular package once it has been identified. In other words, once a barcode, label, UPC, or other identifying information has been linked with a particular package, time may be saved and efficiency gained by not having to re-identify such package at subsequent steps—and thus the associated subsystems generally may be configured to retain package singulation where possible, as well as access to key labelling or identification information or continuous tracking such that further identification or de-novo analysis by subsequent subsystems is not required.

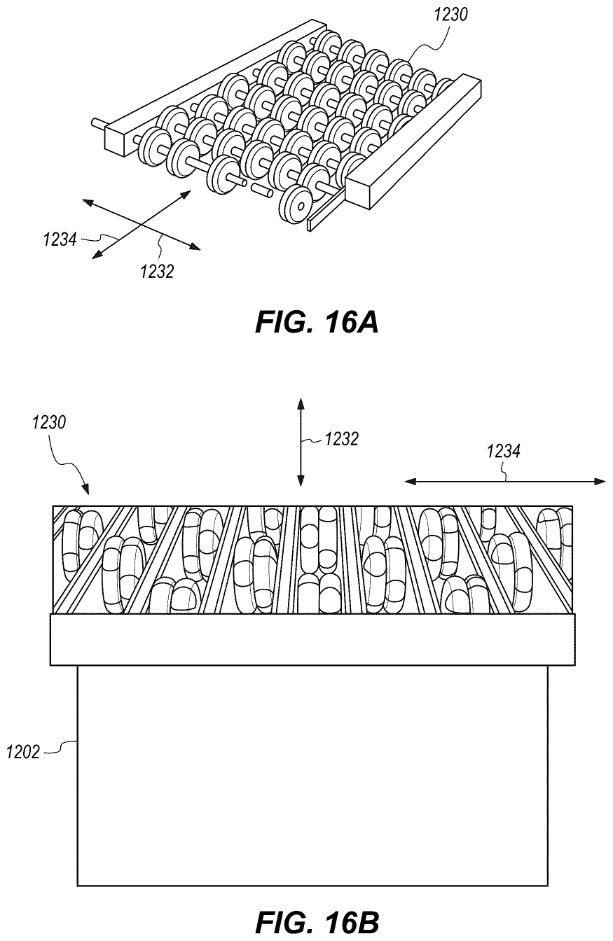

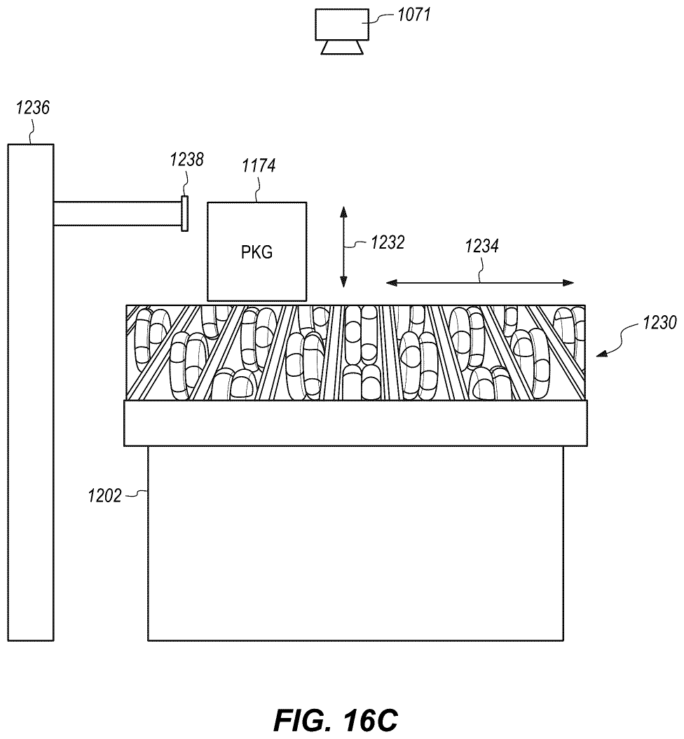

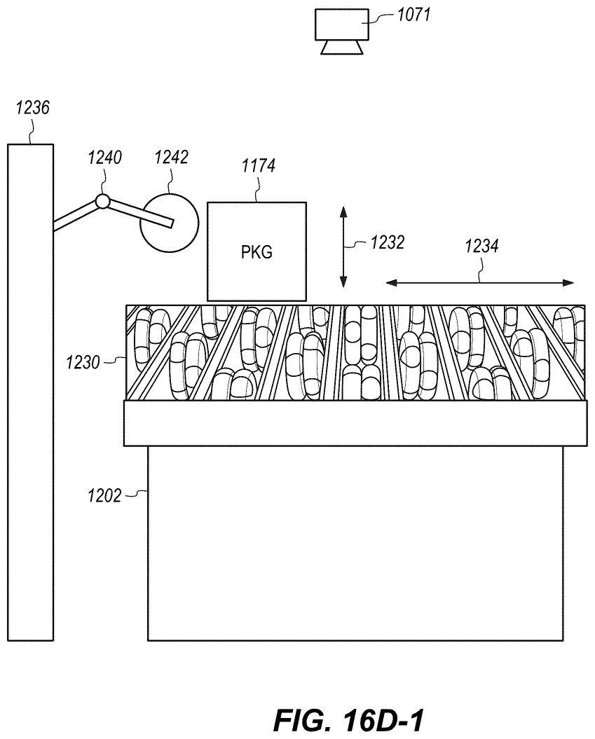

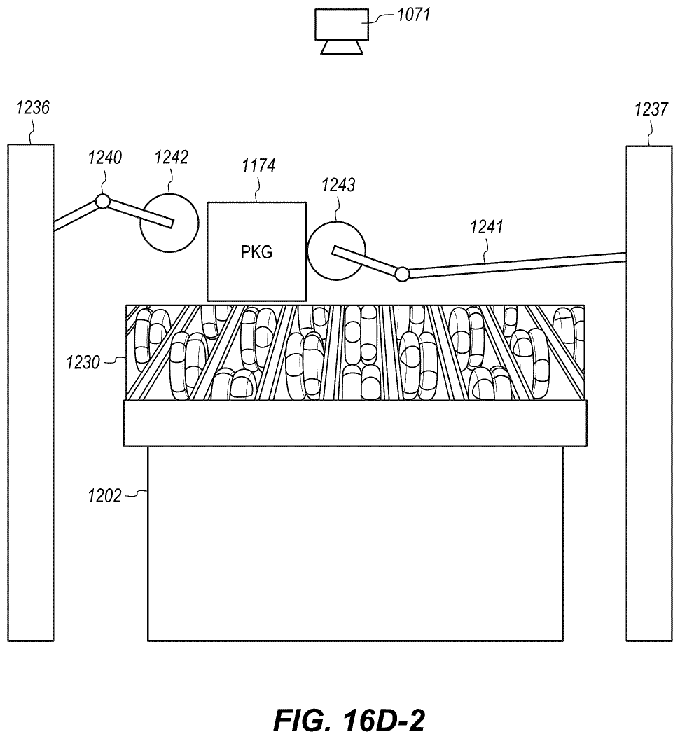

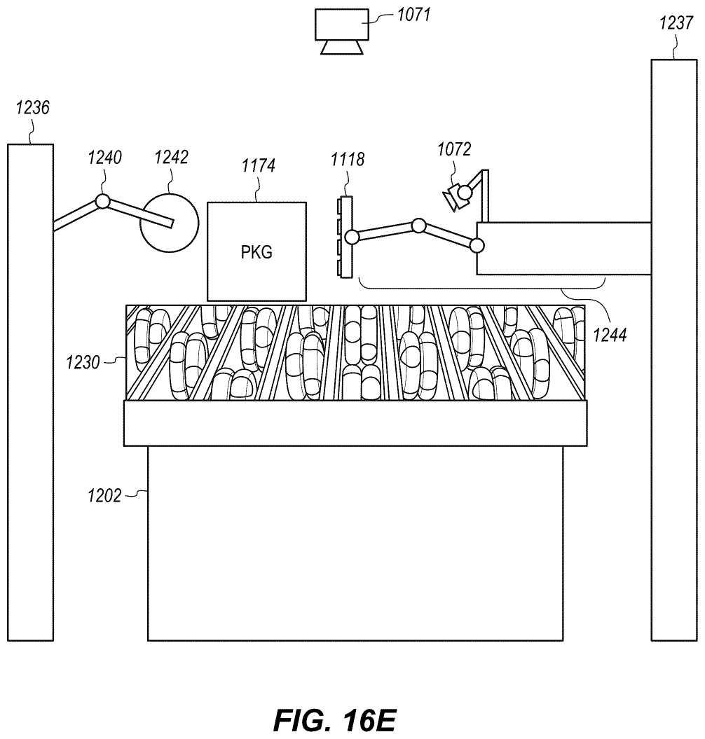

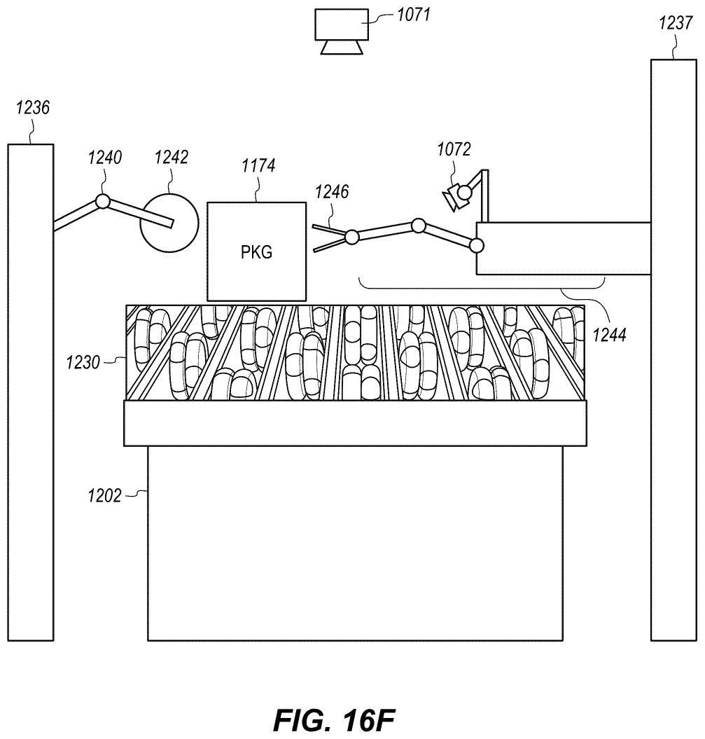

Referring to FIGS. 16A-16F, as noted above, multi-directional (1232, 1234) conveyance systems (1230) may be incorporated to divert, rotate, vector, and manipulate targeted packages with relatively high speed. Referring to FIG. 16B, a multi-directional (1232, 1234) conveyance system (1230) is mounted upon a table (1202) and may be used in various input, intermediate, and output configurations to rotate, orient, divert, eject, etc packages. As noted in the incorporated reference, extrinsic features or structures may be utilized to assist with conveyor-based manipulation of a particular package (1174). For example, referring to FIG. 16C, a structural member (1236) may be coupled to a protruding structure (1238) configured and positioned to provide a vectored, positioned push resistance against a package (1174) which may be vectored toward it by a conveyor (1230); this may facilitate an intentional tipping or other mechanical manipulation of the targeted package (1174), which may be observed and/or controlled with assistance of one or more operatively coupled image capture devices (1071). Referring to FIG. 16D-1, an electromechanical or robotic arm (1240) may extend from the structural member (1236) and may have an intentionally atraumatic and/or high-adhesion or grip distal portion (1242) configured to mechanically interface with a package (1174) urged toward it by the conveyance (1230), which facilitates a significant panoply of mechanical manipulation and/or interaction (for example, the distal portion 1242 may be utilized along with the conveyance 1230 to quickly intercept, stop, tip, reorient, etc the targeted package 1174). The distal portion may comprise a variety of geometries and/or surfaces, such as fingers, low-friction materials, and the like. The configuration may be observed and/or controlled with assistance of one or more operatively coupled image capture devices (1071). Referring to FIG. 16D-2, a second structural member (1237) may comprise a second robotic arm (1241) and engagement distal tip (1243) to facilitate significant mechanical manipulation of the targeted package along with the conveyor (1230) from positions across a conveyor table, for example. The configuration may be observed and/or controlled with assistance of one or more operatively coupled image capture devices (1071). In other embodiments, similar assemblies (1237, 1241, 1243) may be configured to encounter one or more packages in sequence down the length of a conveyor (1230), such that as a package (1174) is moving down the length of a conveyor, it can encounter one or more pairs, or generally a sequential plurality of such assemblies (1237, 1241, 1243) to sequentially adjust, re-vector, reorient, eject, hold, etc the package as it moves sequentially along through processing. Indeed, referring to FIGS. 16E and 16F, one or more manipulation assemblies may comprise robotic manipulators (1244) with end effectors which may, for example, comprise vacuum-suction-cup arrays (1118) or grasper end effectors (1246), to provide different manipulation alternatives relative to the conveyor surface (1230).

To provide further manipulation precision, handling, and efficiency, referring to FIGS. 16G and 16H, a targeted package (1174) resides upon an electromechanically controllable conveyor (1248) which also may be operatively coupled with one or more wall structures (1250) configured to provide a known extrinsic loading surface—and also which may be live conveyors themselves (for example, single direction or multi-directional). Thus as shown in FIG. 16H, when the base conveyor (1248) urges the package (1174) against the wall structure (1250), the wall structure may assist in simply providing a known planar extrinsic loading surface to, for example, assist in orienting the package relative to the wall structure (1250), or may also be configured to advance/vector loading against the aspects of the package (1174) that engage the wall structure (1250). Additional use of extrinsic loading (or so-called “extrinisic dexterity” processing whereby elements extrinsic to an operable member such as a grasper) may be utilized throughout various aspects of the system configurations described herein, and are not limited to the use of a ramp or wall in the particular configuration of FIG. 16H. For example, in each use of a conveyance, grasper, coupler, or other active member wherein a particular package or item is targeted for repositioning, reorientation, and/or grasp/coupling, extrinsic loading from known members such as ramps, walls, cuboids, concave elements, convex elements, or other shapes may be utilized to assist in such operation, and these extrinsic loading members may be stationary relative to the package or grasper/coupler—or may be controllably active (i.e., controllably movable or controllably reorientable, such as in the case of a controlled pusher wall or ramp).

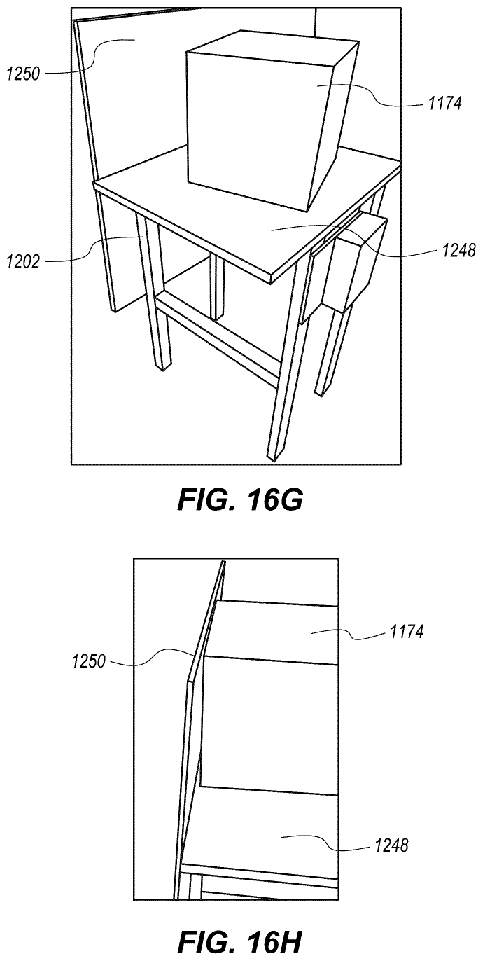

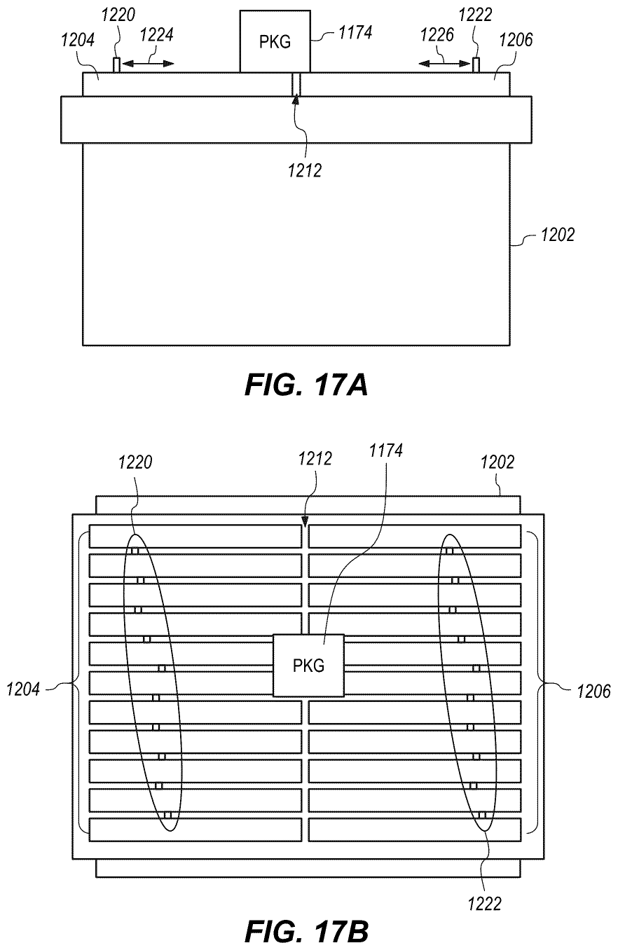

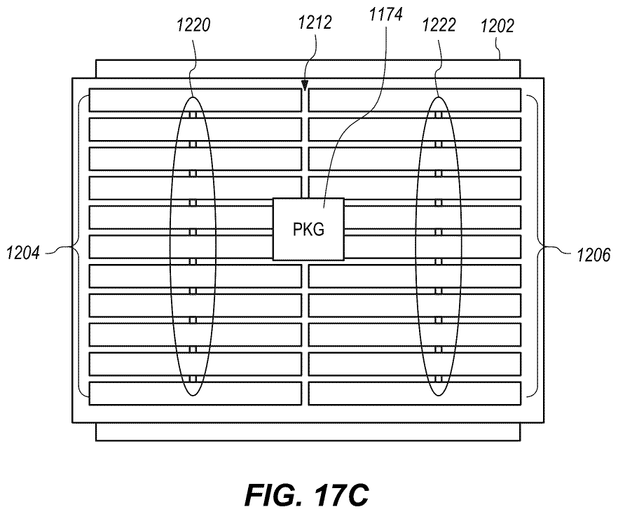

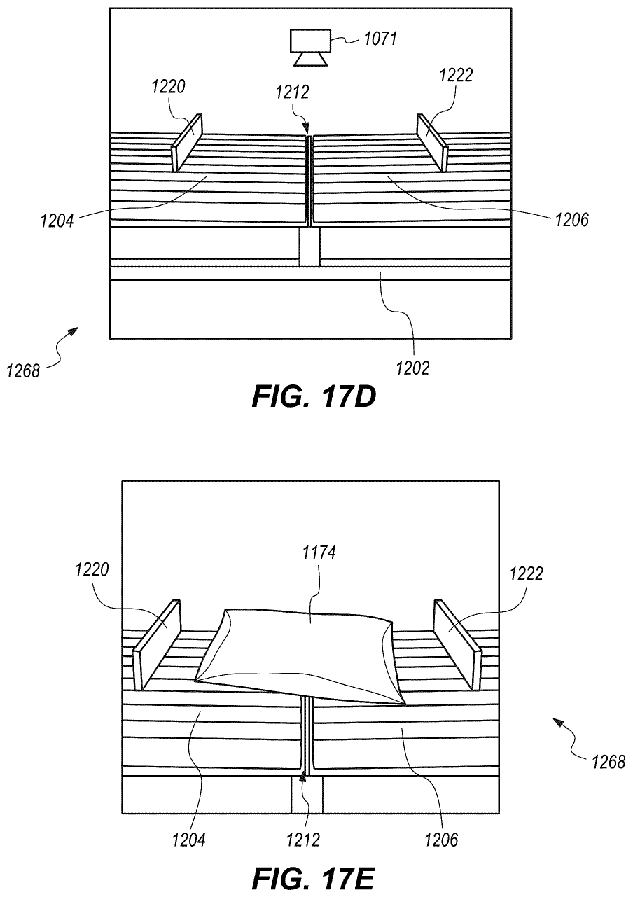

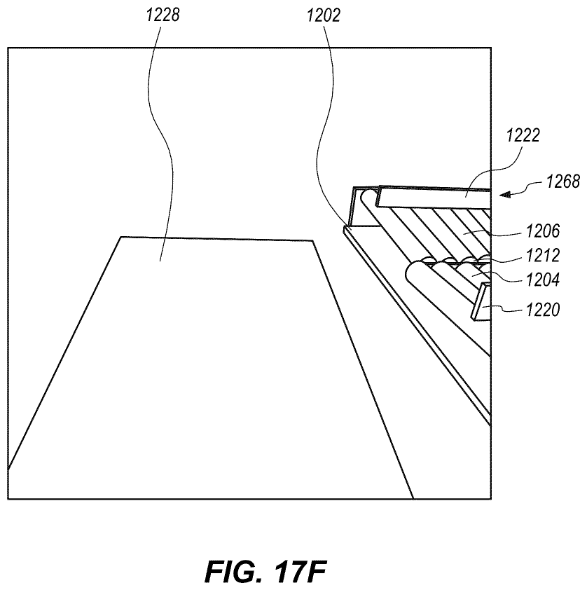

Referring to FIGS. 17A-17F, variations of herringbone style conveyance configurations, related to those described above, are shown wherein in addition to two intercoupled groups of controllably actuated/rotated cylindrical members (1204, 1206) are intercoupled to two sets of mechanical push features (1120, 1222) which may be configured to assist in gathering packages toward a given position on the conveyor, such as toward the center (1212), by being controllably movable (1224, 1226) in between the cylindrical members (1204, 1206) relative to the center (1212). These features may be configured to act independently, as in the configuration of FIG. 17B, or together, as in the configurations of FIGS. 17C and 17D-17F. The configuration of FIGS. 17D-17F shows that the push features (1120, 1222) may be coupled above the conveyor surface to function as small movable walls to push/move a given package (1174), such as toward the center (1212) as shown in FIG. 17E, wherein the package may be moved forward, backward, etc—and/or rotated/reoriented through opposing rotational motion of each opposing side of the herring-bone configuration (1204, 1206 rotating oppositely; in what may be called a “tank rotation” mode due to some similarities with the manner that a tank with tracks is steered or rotated); such configurations may be observed and/or controlled with assistance of one or more operatively coupled image capture devices (1071). Referring to FIG. 17F, the conveyance (1268) may be configured to eject the targeted package out onto another conveyor (1128), into an output container, etc.

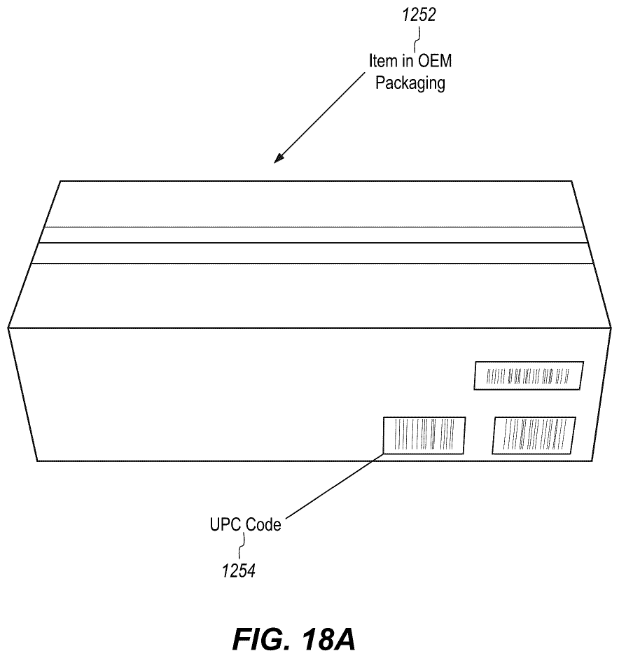

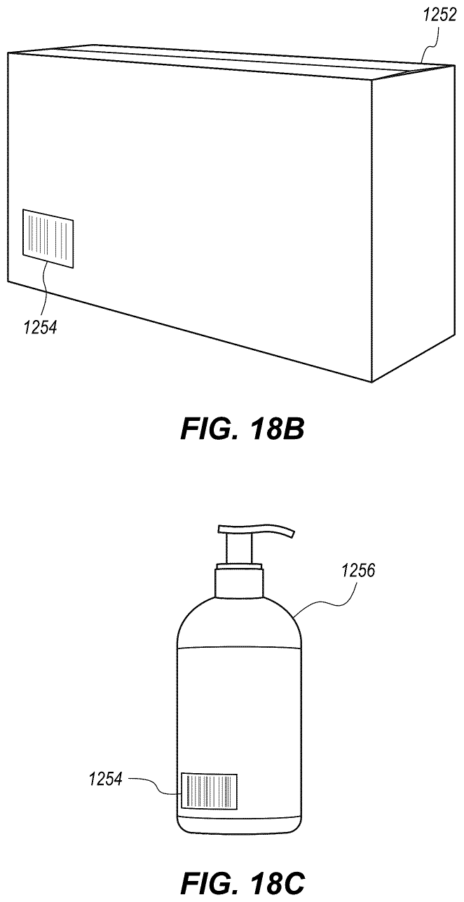

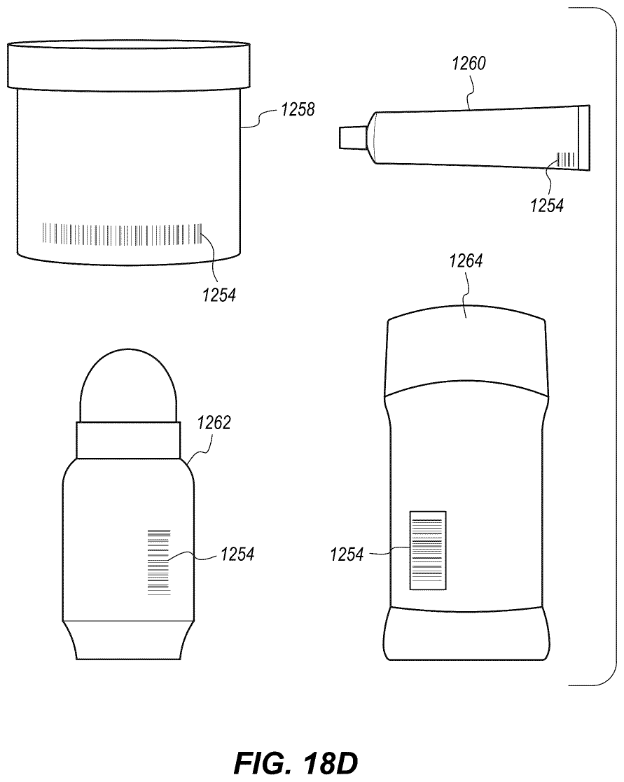

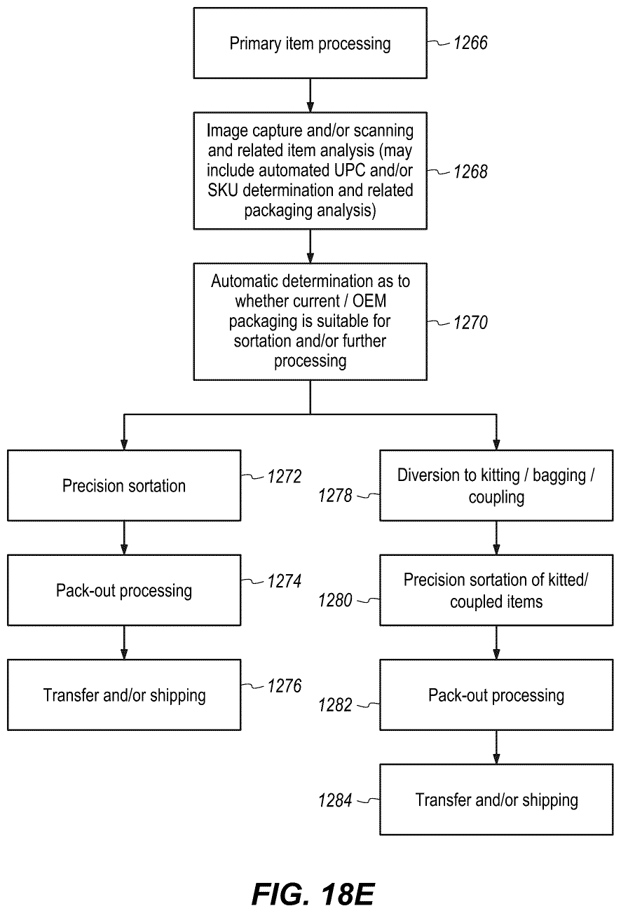

Referring to FIGS. 18A and 18B, where possible, it may be desirable to directly process, sort, and pack-out using OEM/SKU packaging (1252). In specific scenarios, this may be enhanced by the packaging itself containing identifying information (such as a stick-on label or other identifying information such as a UPC label 1254, SKU label, along with meta data which may allow the system to determine routing, shipping, and/or other variables based upon the UPC labeling; in other words, UPC code or SKU identification may not be enough to fully track and identify a given package or shipment because there may be many such packages with the same UPC or SKU labelling that day; in such situations the system may be configured to seek other meta data information to determine particular identification and routing, and may be configured to place an enhanced label upon the OEM packaging for additional use in processing). Further, certain OEM packaging may be unsuitable for logistics processing notwithstanding UPC code or other identification, and the system may be configured to automatically recognize, for example, that a lotion container (1256), or containers of other small cosmetic types of products (1258, 1260, 1262, 1264) should be kitted and bagged or boxed notwithstanding visible UPC identifiers (1254). Further, the system may be configured to automatically conduct basic analysis (such as image based, acceleration based, loading based) pertaining to the structure of such packages to determine that they should not be further processed in OEM packaging.

Thus referring to FIG. 18E, after primary item processing (1266), image capture and/or scanning and related item analysis (may include automated UPC and/or SKU determination and related packaging analysis) (1268). Automatic determination may be conducted as to whether current/OEM packaging is suitable for sortation and/or further processing (1270); if yes, precision sortation (1272), pack-out processing (1274), and transfer and/or shipping (1276) may follow; if not, diversion may be conducted for kitting/bagging/coupling (1278), followed by precision sortation (1280), pack-out processing (1282), and transfer and/or shipping (1284).

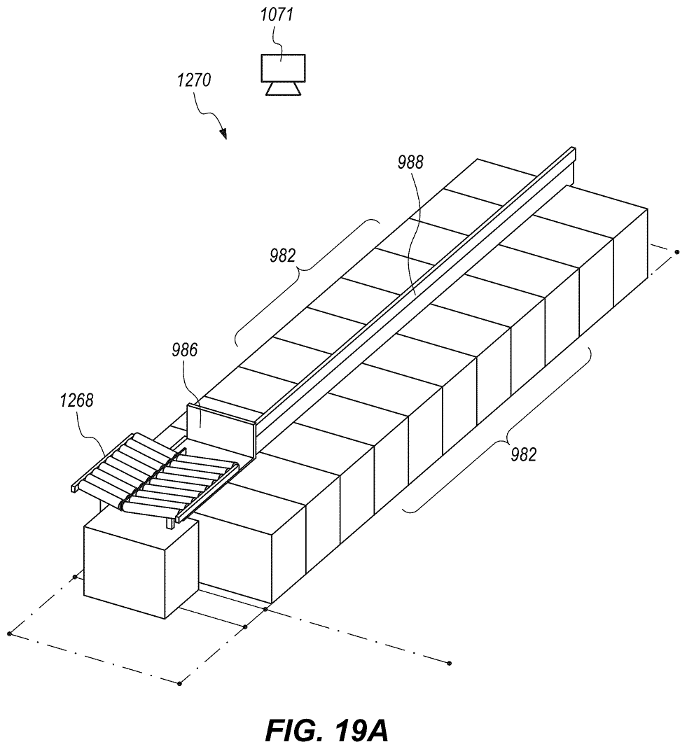

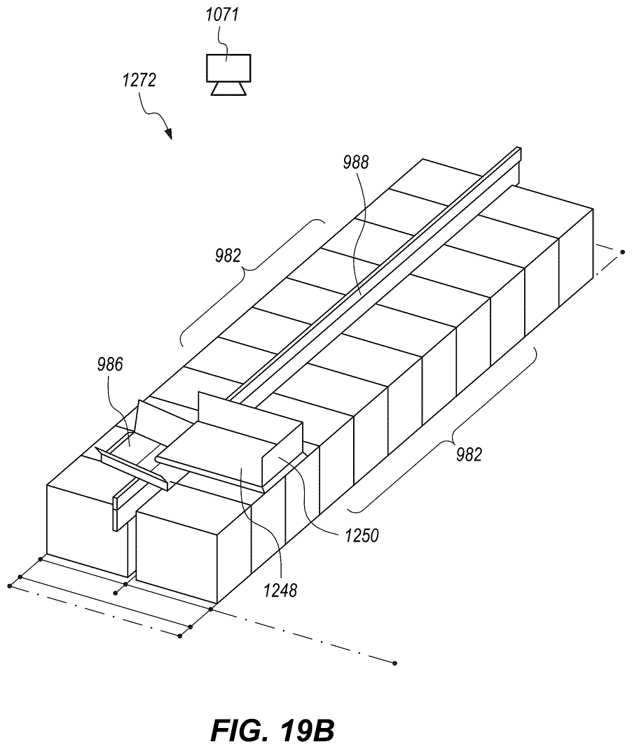

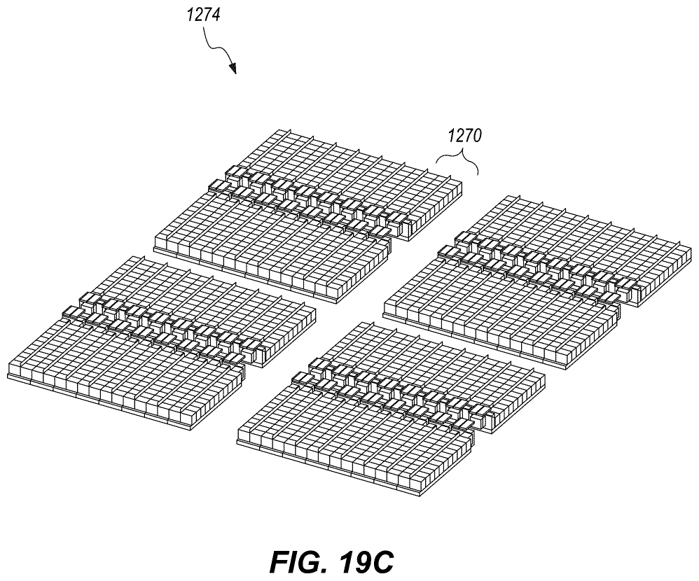

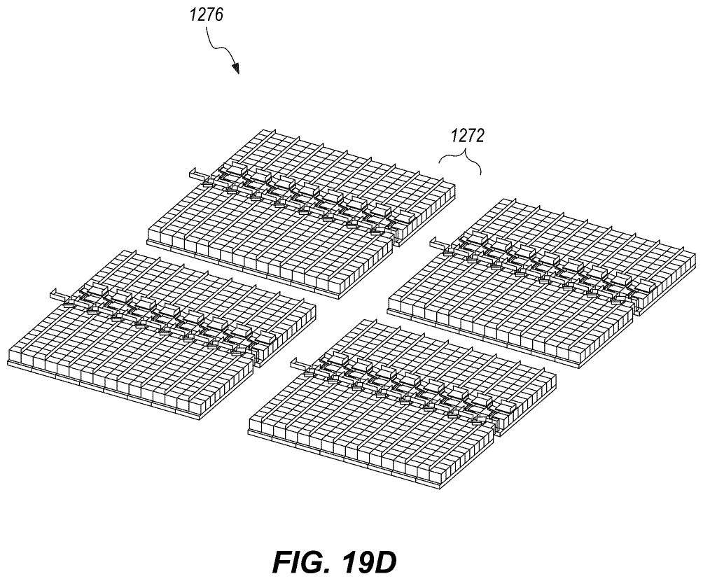

Referring to FIG. 19A, from an architectural and scaling perspective, a sorting unit (1270) comprising a herring-bone style conveyance (1268) may be configured to act as an input subsystem after primary item processing, and may be configured to controllably eject, such as with a preferred position and/or orientation, sequential packages onto a distribution module (986) such as a pan/tilt tray or small mobile conveyance, each of which may be coupled to a linear rail to provide access to each of an assembly of output containers (982). Referring ahead to FIG. 19C, many such units (1270) may be organized into a functional sortation assembly (1274) having many viable outputs. The configuration may be observed and/or controlled with assistance of one or more operatively coupled image capture devices (1071). Referring to FIG. 19B, a sorting unit (1272) is shown comprising a conveyor (1248; may be multi-directional) with wall structure (1250; may comprise a conveyor as noted above) which may be configured to act as an input subsystem after primary item processing, and may be configured to controllably eject, such as with a preferred position and/or orientation, sequential packages onto a distribution module (986) such as a pan/tilt tray or small mobile conveyance, each of which may be coupled to a linear rail to provide access to each of an assembly of output containers (982). The configuration may be observed and/or controlled with assistance of one or more operatively coupled image capture devices (1071). Referring ahead to FIG. 19D, many such units (1272) may be organized into a functional sortation assembly (1276) having many viable outputs.

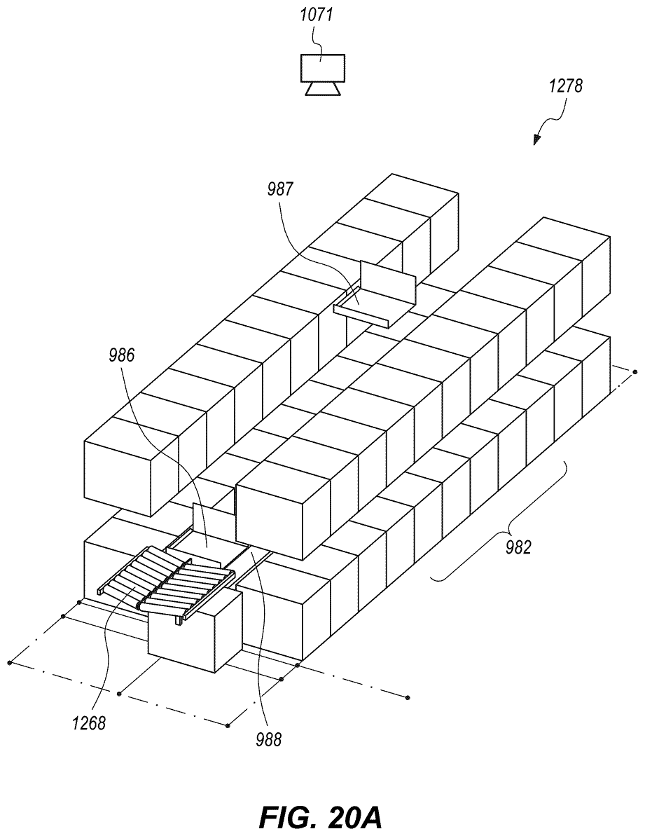

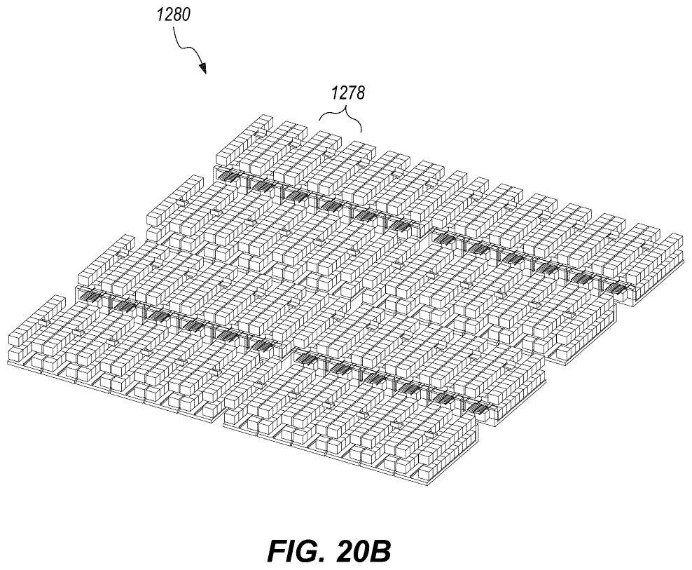

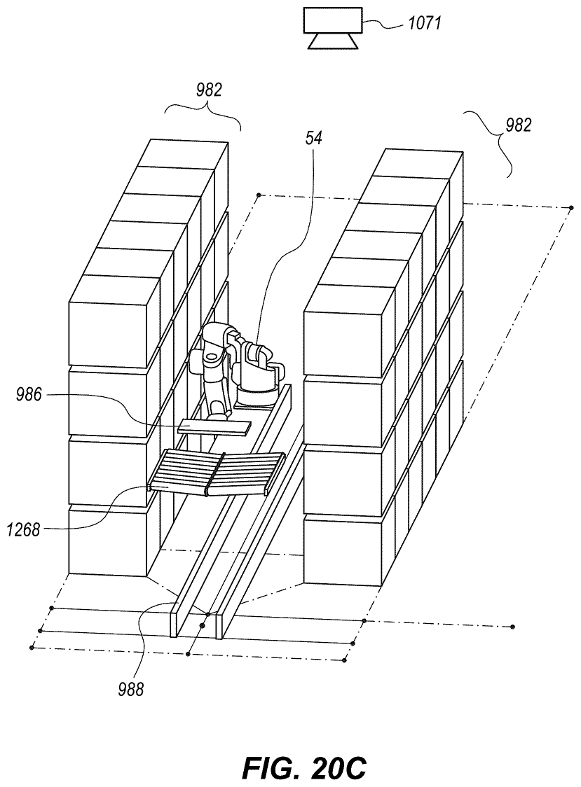

Referring to FIG. 20A, a sorting unit (1278) comprising a herring-bone style conveyance (1268) may be configured to act as an input subsystem after primary item processing, and may be configured to controllably eject, such as with a preferred position and/or orientation, sequential packages onto a plurality distribution modules (986, 987) such as a pan/tilt tray or small mobile conveyances, each of which may be coupled to a linear rail to provide access to each of a vertically stacked assembly of output containers (982). The configuration may be observed and/or controlled with assistance of one or more operatively coupled image capture devices (1071). Referring ahead to FIG. 20B, many such units (1278) may be organized into a functional sortation assembly (1280) having many viable outputs. Referring to FIG. 20C, a herring-bone type of conveyance (1268) may be configured to act as an input subsystem after primary item processing, and may be configured to controllably eject, such as with a preferred position and/or orientation, sequential packages onto a distribution modules (986) coupled to a robotic arm (54) mounted to a linear rail system (988) and configured to be able to controllably deposit packages into a stacked array of output containers (982). The configuration may be observed and/or controlled with assistance of one or more operatively coupled image capture devices (1071).

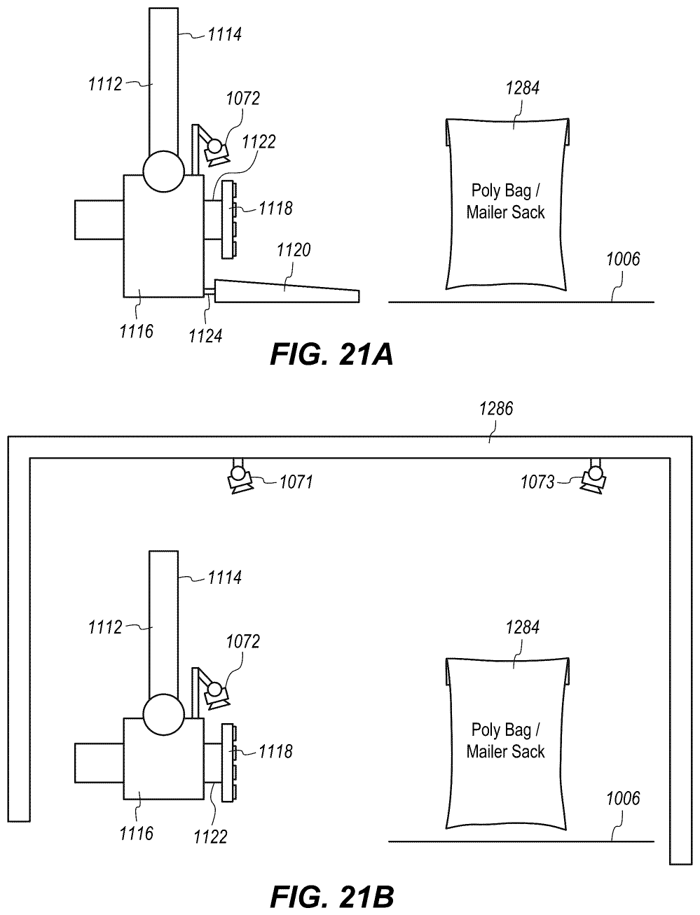

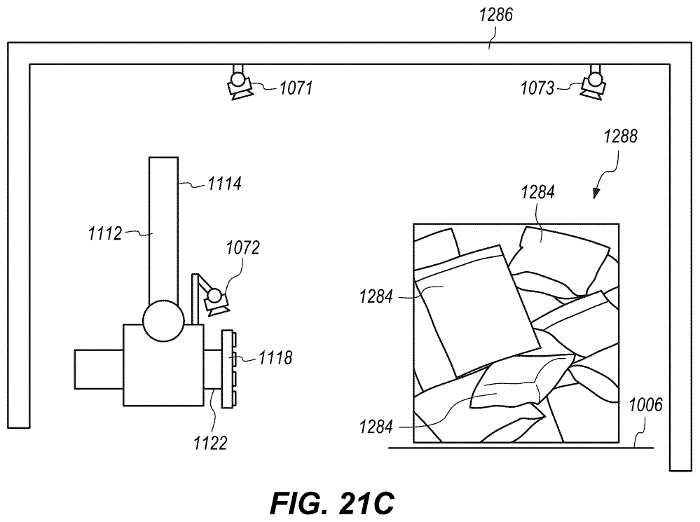

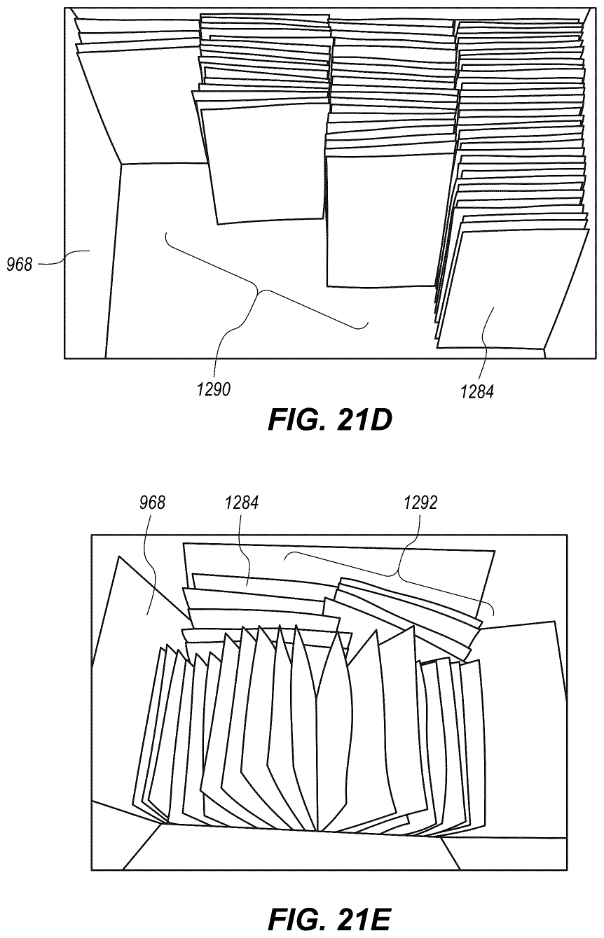

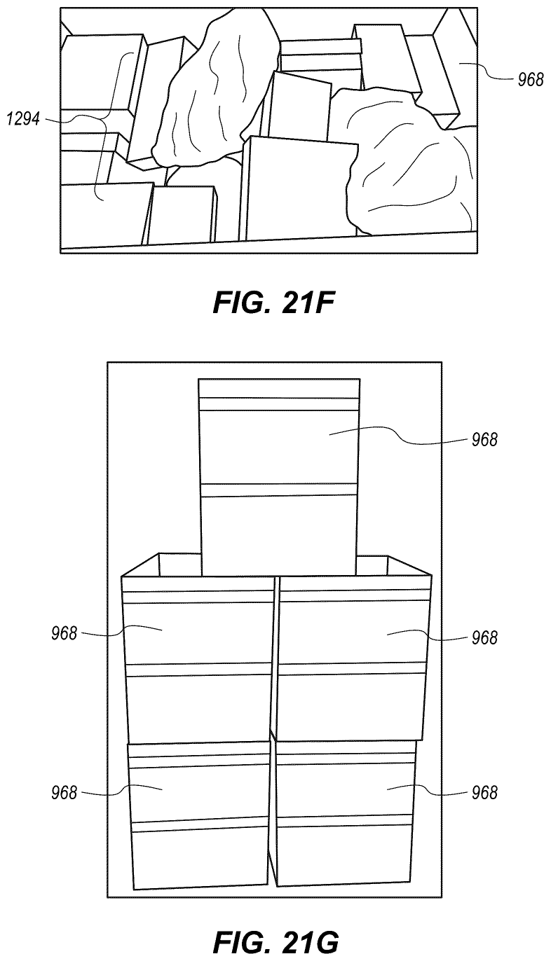

Referring to FIG. 21A, a robotic manipulator (1112) similar to that described above may be utilized to address a variety of package types.

Packages known as “poly bags” or “mailers” (1284, 1290, 1292) present a unique challenge because they are somewhat rigid, somewhat flexible, relatively thin, and generally need to be somewhat geometrically organized relative to each other to efficiently fit within a desired output container (968), as shown, for example, in FIGS. 21D and 21E. Using a vacuum-based end effector (1118), such as in a configuration as shown in FIGS. 21B and 21C without a lifting tray, poly bags, mailers, sacks, and bags of various types may be controllably grasped, reoriented, repositioned, and placed efficiently in output containers as shown. Other scenarios wherein speed is of utmost importance, a similar system may be utilized to deliver such poly bags or mailers in an at least semi organized manner with the largest flattest side down toward the base of the output container (in other words, a disorganized pile of flats which at least has most planar flat surface in parallel fashion relative to each other within they output container).

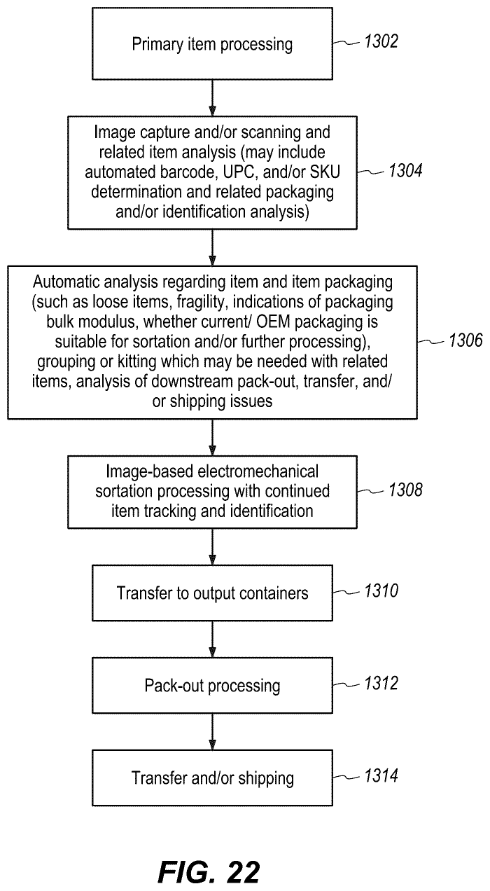

Referring to FIG. 21F, as noted above, the system may be configured to orient packages (1294) relative to each other within an output container (968), and also to provide a relative packaging schema optimized for input requirements, such as desired order of removal from the output container, predetermined, input, or determined fragility of packages, density or mass of packages, flexibility of packages, and the like. For example, depending upon the post-processing (such as during shipping or delivery), it may be desirable to optimize to be able to stack semi-rigid output containers up to three high within a truck without collapse, and this input may be modelled into the packing of the output containers (986). Thus referring to FIG. 22, after primary item processing (1302), image capture and/or scanning and related item analysis may be conducted (may include automated barcode, UPC, and/or SKU determination and related packaging and/or identification analysis) (1304). Automatic analysis may be conducted regarding item and item packaging (such as loose items, fragility, indications of packaging bulk modulus, whether current/OEM packaging is suitable for sortation and/or further processing), grouping or kitting which may be needed with related items, analysis of downstream pack-out, transfer, and/or shipping issues (1306). Image-based electromechanical sortation processing may be conducted with continued item tracking and identification (1308), followed by transfer to output containers (1310), pack-out processing (1312), and transfer and/or shipping (1314).

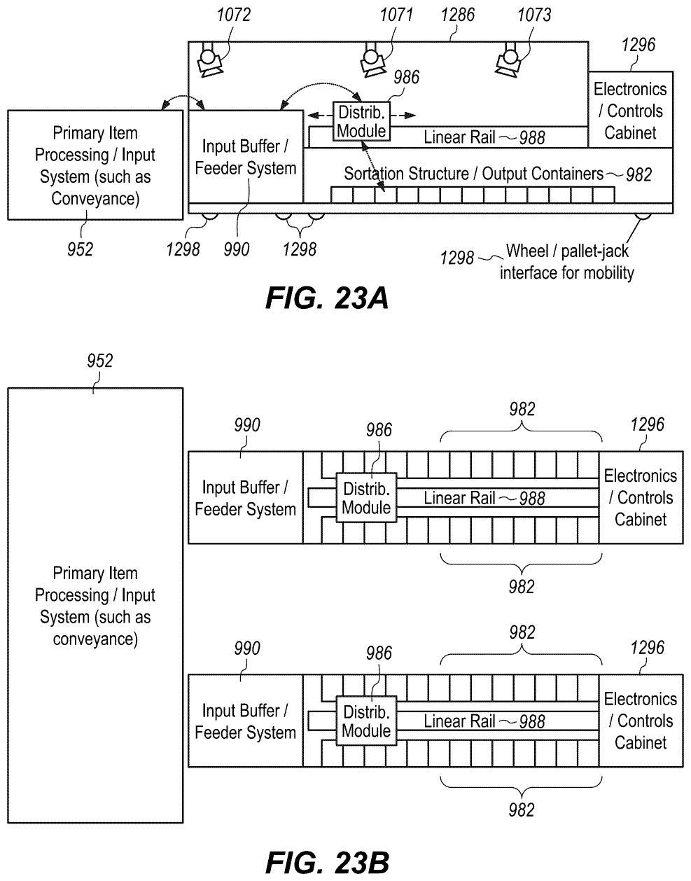

Referring to FIGS. 23A and 23B, a modular system configuration is shown comprising a frame assembly (1286) that couples one or more image capture devices (1071, 1072, 1073), a linear rail (986) configured to controllably move a distribution module (986) to access various coupled output containers (982) after receiving packages from an input buffer/feeder system (990), which is supplied by primary item processing (952; such as via conveyance). The frame (1286) assembly may comprise a plurality of wheels and/or pallet jack interfaces (1298) such that it may be moved throughout a warehouse floor, placed into storage, transported, easily scaled into a larger system, and the like. An electronics and controls cabinet (1296) may be located for convenient proximal access when in a larger assembly such as is shown in FIG. 23B, with wired and/or wireless coupling to all associated sensors, motors, and actuators. With a configuration such as that illustrated in FIG. 23A or 23B, and utilizing the various aspects of systems described above and in the incorporated reference, various types of packages may be brought into primary item processing in preparation for sortation, and they may be analyzed by computing resources operatively coupled to one or more image capture devices, which may be configured to not only identify, but also characterize packages as soon as possible in the processing, such that neural networks may be utilized to plot and execute singulation, precision sortation, positioning, transporting, and orientation within output containers, as well as the processing of completed output containers to pack out, as well as post-pack out processing, may be conducted quickly and efficiently using vision systems and operatively coupled computing resources configured to automatically process packages quickly and keep track of them during the process, preferably without undue de-novo or repeated analysis or processing along the way.

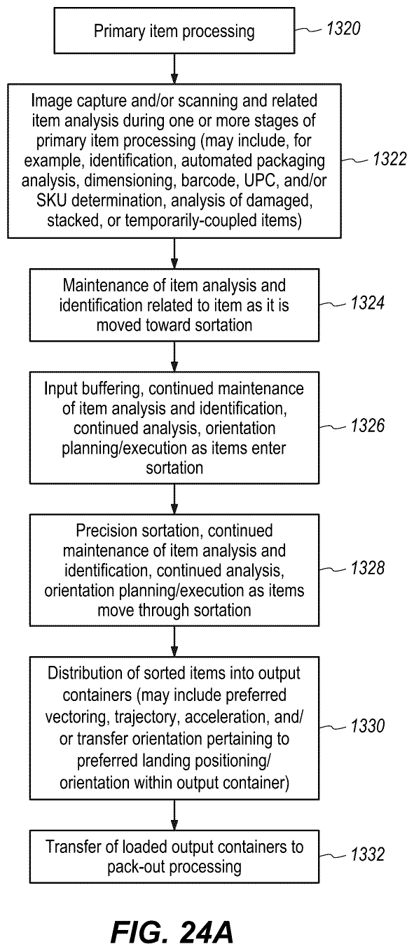

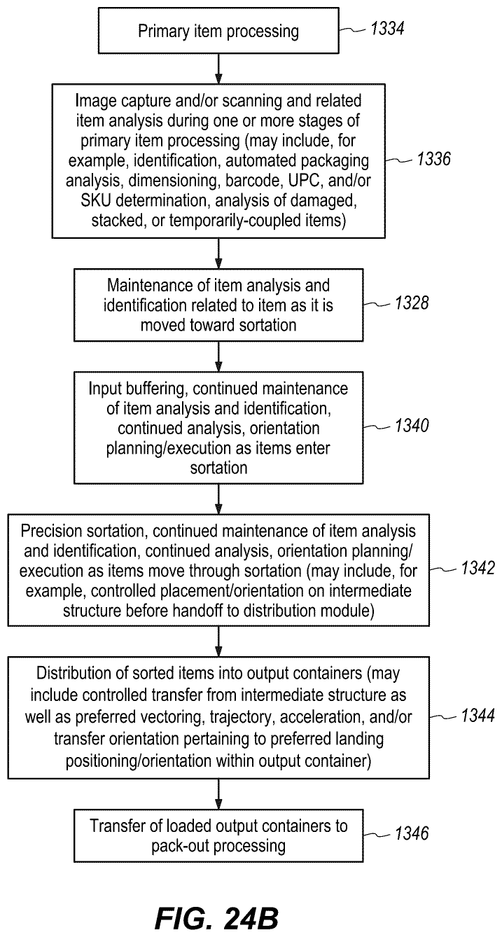

Referring to FIG. 24A, as noted above, in various embodiments it is desirable to continue to utilize identification and/or meta data information pertaining to particular packages or items as they are further processed. In other words, if a package is identified and characterized fairly early, or “upstream”, in the process, it is desirable to continue to be able to identify such package and utilize related meta data and characterization information downstream without the requirement of subsequent de-novo analysis; it may, indeed, be advantageous to continue to analyze a package as it moves “downstream” through a handling process, thereby gaining further information pertaining to the package itself and what has been done to it in terms of processing. Thus referring to FIG. 24A, a package may enter primary item processing (1320) and various events, processes, and subprocesses may be conducted. For example, image capture and/or scanning and related item analysis during one or more stages of primary item processing may be conducted, which may include, for example, identification, automated packaging analysis, dimensioning, barcode, UPC, and/or SKU determination, analysis of damaged, stacked, or temporarily-coupled items (1322). This information may be reported to connected computing systems, and following processing may be configured to retain or maintain the item analysis and identification capabilities pertaining to the particular package (1324). In other words, if a barcode label is successfully read pertaining to a particular package early in the primary item processing, the system may be configured to continue to orient the identified barcode label of such package in a manner such that it is exposed and vectored or directed toward a known position and/or orientation of an image capture device or scanner (i.e., not in a face down orientation wherein it may be difficult to re-identify such package). As items enter precision sortation, input buffering may be conducted (i.e., rate of throughput may be adjusted dynamic to downstream rate of processing in precision sortation to prevent over-feed, so-called “traffic jamming” of packages, and the like), and a continued priority may be maintained related to maintaining and improving item analysis and identification, as well as orientation planning and execution (1326). For example, orientation planning during early stages of primary item processing may be as simple as maintaining label visibility in something other than a face-down orientation; it may be as complex as maintaining a specific orientation of an item or package as it enters a specific chute, turn, conveyance, platform, or the like as the result of a known downstream manipulation singularity, pinch point, or scan or imaging tunnel. In other words, the system may be configured to not only maintain and improve identification and analysis of packages as they move through the process, but also to controllably and dynamically reposition and reorient them in accordance with known issues ahead for each package as it moves ahead through the processing (again, for example, the system may be configured to continue to observe identified packages as they move downstream with image capture and other devices, and if a particular undesirably does fall face-down onto a conveyance or other surface, the system may be configured to dynamically intervene, such as by grasping, pushing, flipping, diverting, or otherwise repositioning or reorienting such package until it can be readily identified again and/or is back in a preferred position and/or orientation given the known downstream processes and issues ahead. As items move through precision sortation, the system may be configured to continue to provide tracking, analysis, and identification information, as well as position and/or orientation optimization that is dynamic to the scenario for each package or item, in real-time or near real-time so as to keep the process moving expediently ahead (1328). With additional intervention and information, data from sensors such as one or more image capture devices (which may include color, monochrome, infrared, time-of-flight depth camera, and/or other types of image capture devices) and one or more compact LIDAR sensors may be utilized to continue to characterize packages. For example, in addition to so-called “sensor fusion” techniques as described above wherein data from two or more sensors with uncorrelated error configurations (such as two or more similar image capture device perspectives, or one image capture device rotated through two or more perspectives, or different types of sensors, etc) may be utilized to produce a synergistic characterization of a targeted item, such data may be utilized to continue to characterize the mechanical or material properties of a given item or package. For example, a given image capture device and/or compact LIDAR sensor may capture information pertaining to a sequence of time during which a package has been loaded, such as by an intentional physical intervention (such as by an intentional contact by a configuration such as that described above in reference to FIG. 16C, 16D-1, 16-D2, 16E, or 16F). In other words, by intentionally physically addressing a given package with a known load at a known vector and observing behavior in detail with sensors such as image capture devices and/or LIDAR, the system may be configured to calculate and/or determine material or mechanical properties of such package. For example, the system may be configured to seek a substantially planar surface and apply a known perpendicular/principal style load, followed by a known load paradigm involving shear loading with a contact load and known contact coefficients of friction (static, kinetic) at the interventional device (such as element 1242 of FIG. 16F, for example); the results from such intervention may be utilized to determine and/or estimate valuable information such as bulk modulus of package surface or package generally, friction coefficients (i.e., is this a “slippery” vs “grippy” exterior surface on this package), mass, moment of inertia, package compliance (i.e., is the package firm or compliant to loading), whether loose items are detected inside of the package, etc. For example, a grasper type of tool, such as that shown (1246) in FIG. 16F, may be utilized to grasp, lift, and reposition in free space for brief period of time, a package such as that (1174) illustrated. Load sensing capabilities of the associated robotic arm holding the grasper (1241), such as those which may be based upon inverse kinematics, motor currents, piezoelectric sensors, strain gauges, and the like, may be utilized to estimate mass (i.e., in response to accelerations of the grasper 1241 holding the item), moment of inertia (i.e., measured as the grasped item is rotated/reoriented in space), overall package compliance (for example, in response to grasp or movement during grasp), as well as sounds, vibrations, or other responses indicative of loose items (for example, the grasper or intercoupled robot arm may be operatively coupled to one or more microphones or one or more inertial measurement units capable of detecting small sounds and/or accelerations which may be correlated with loose items or collisions within the package or item). Further, image capture devices of various types may be configured to use various irradiation wavelengths and technique to detect sheen, flatness, and other characteristics pertaining to materials, such as sheens of known plastics versus cardboards). Packages may also be loaded in mild bending or jetted with air or inert gas to confirm bending modulus or surface rigidity, for example, to confirm that a given package is a thin mailer or poly-bag. Similar analysis may be conducted throughout the various interlinked processes. Distribution of sorted items into output containers may, for example, include preferred vectoring, trajectory, acceleration, velocity, and/or transfer orientation pertaining to preferred landing positioning and/or orientation within a targeted output container (1330). For example, referring back to FIG. 13, it may be important to specifically position and orient one or more packages within a given structure, such as an output container or tote, or they may not fit as planned. The output containers may be subsequently transferred away for pack-out processing (1332).

Referring to FIG. 24B, a somewhat similar configuration to that of FIG. 24A is illustrated, with primary item processing (1334) which may include image capture and/or scanning and related item analysis during one or more stages of primary item processing (may include, for example, identification, automated packaging analysis, dimensioning, barcode, UPC, and/or SKU determination, analysis of damaged, stacked, or temporarily-coupled items) (1336). Again, maintenance of item analysis and identification related to item as it is moved toward sortation may be prioritized (1338), along with input buffering, continued maintenance of item analysis and identification, continued analysis, orientation planning/execution as items enter sortation (1340). Sortation may comprise a series and/or sequence of different subsystems, as described above. Precision sortation may be conducted with continued maintenance of item analysis and identification, continued analysis, orientation planning/execution as items move through sortation (may include, for example, controlled placement/orientation on intermediate structure before handoff to distribution module) (1342). Sorted items may be distributed into output containers (may include controlled transfer from intermediate structure as well as preferred vectoring, trajectory, acceleration, and/or transfer orientation pertaining to preferred landing positioning/orientation within output container) (1344), and loaded output containers may be transferred to pack-out processing (1346).

Referring to FIGS. 25A and 25B, as noted above, connected computing resources, such as local computing resources (such as local data center or network operating center resources 1352), remote computing resources (such as cloud computing resources available under tradenames such as Amazon Web Services®, Microsoft Azure®, or Google Cloud®; 1350), individual computing resources (such as connected laptop computers, desktop computers, smartphones, tablet computers; 1354), and other connected systems (such as delivery or shipping trucks, mobile scanners, other computing or resource locations, weather information, disaster information, GPS information, mobile telecom information, traffic information, and air traffic control information pertaining to air-based logistics vehicles; 1348), each of which may be connected (1360, 1361) to the integrated sortation systems (1361, 1363) by wired (such as by terrestrial copper and/or optical fiber) and or wireless connectivity, such as via IEEE 802.11 wireless connectivity, proprietary wireless network, mobile telephony/smartphone wireless network, extra-terrestrial wireless connectivity (such as via systems available from StarLink® or proprietary satellite networks). FIG. 25A emphasizes that integrated computer vision, scanning, and tracking preferably may be ubiquitous throughout the various stages of processing (1364, 1366, 1368, 1370, 1372, 1374, 1376), and may be utilized not only for monitoring or quality control purposes (such as identifying a jam, damaged package, or the like), but also to responsive, dynamic control of the system to keep things moving rapidly and efficiently. FIG. 25B illustrates that various subsystems may be chained from or operatively coupled to other parent systems. For example, in the depicted embodiment, two (or more; second line depicted as elements 1367, 1369, 1371, 1373, 1375, 1377, 1363; with the integrated controls 1363, 1362 and computing 1348, 1350, 1352, 1354 all interconnected 1361 as shown) interconnected lines of sortation and processing may be dynamically linked to a given larger or preexisting primary item processing system to allow for flexibility and modularity, while all such subsystems may be centrally controlled and operated.

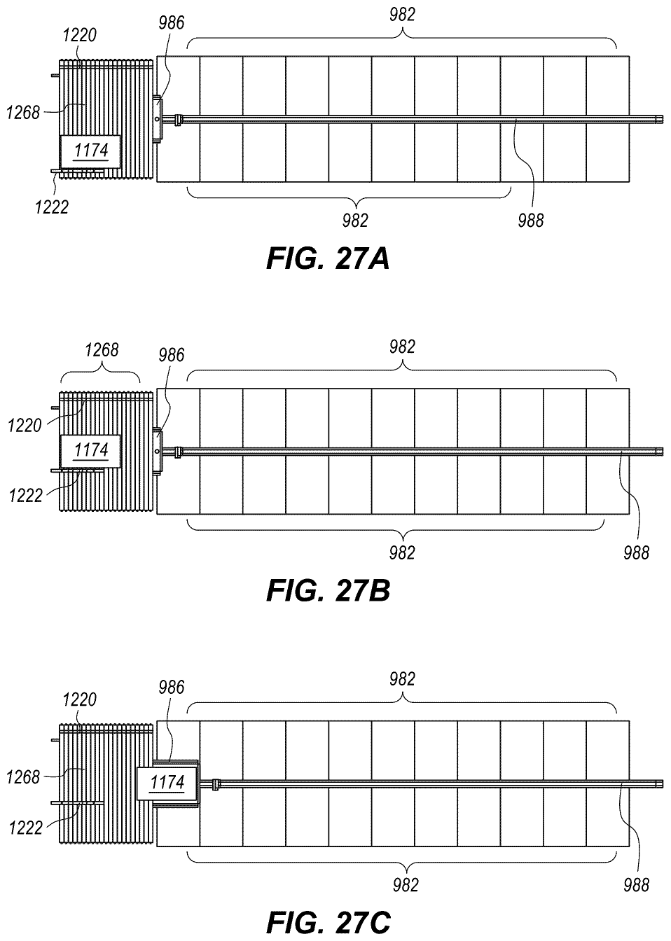

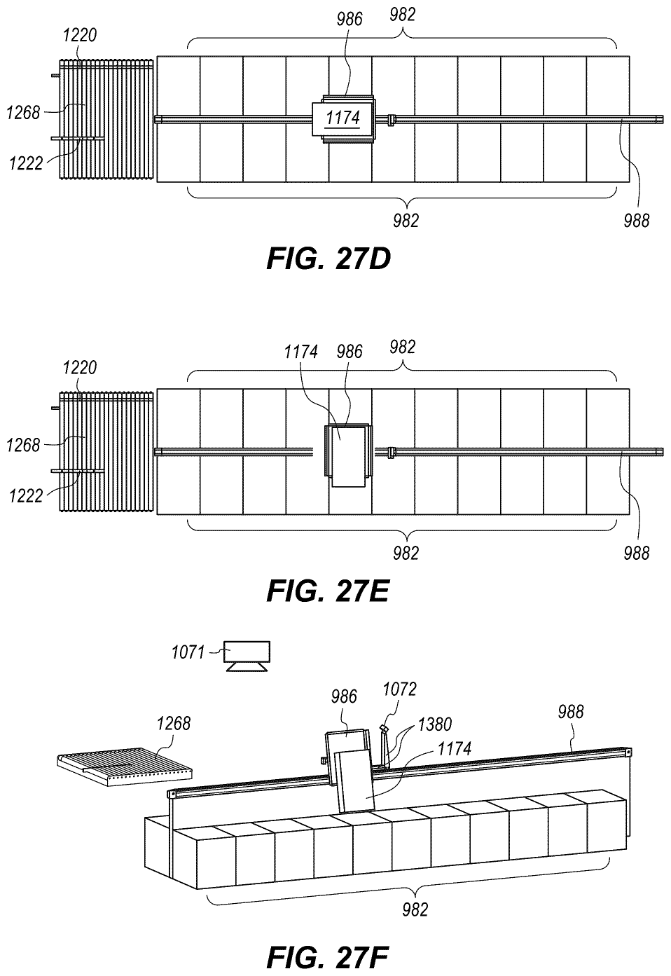

Referring to FIGS. 26A-26D, various aspects of a dual-motor pan-tilt distribution module (986), suitable for use in various above-described embodiments are illustrated. Referring to FIG. 26A, a frame assembly (1380) may be configured to constrain two motors (1384, 1386) relative to each other and to support a image capture device (1072) having a field of view or capture (1378) that is configured to at least capture the motion and activity of the distribution module (986). An input conveyance (1248) may be configured to deliver a package or item (1174) toward the distribution module (986) as shown in FIG. 24A, and to push it forward into the distribution module (986) as shown in FIGS. 26B and 26C. FIG. 26D illustrates an orthogonal view without the package for illustration of the distribution module (986); the frame assembly (1380) may be fixedly coupled to a movable portion of a linear rail (988) using a rail coupling member (1382). The pan motor (1386) may be configured to controllably rotate (1404) the distribution module (986) about the axis (1408) shown, while the tilt motor (1384) may be configured to controllably rotate (1402) the distribution module (986) about the axis (1406) as shown. These combined controlled rotations may be utilized to place a given package into an output container with specific vectoring, velocity, and orientation, as shown in FIG. 27F, for example.

Referring to FIGS. 27A-27F, an incoming package or item (1174) may enter a conveyance (1268) as shown, here a herring-bone style conveyance with controllably movable members (1220, 1222) for centering, as described above, for example, in reference to FIGS. 15A-15B and 17A-17F. FIG. 27B illustrates that the package (1174) has been centered using the movable members (1220, 1222), and in FIG. 27B, the conveyance 1268 then may be utilized to advance the package (1174) onto the distribution module (986) as shown. Referring to FIG. 27D, the package (1174) may be taken down toward an targeted output container (982) by the rail subsystem (988). When in a desired position along the rail (988), the distribution module (986) may be rotated as shown in FIG. 27E (using the pan motor 1386) to provide a preferred orientation for the package (1174), before the package is tilted (using the tilt motor 1384) into the targeted output container (982) with the preferred vectoring/orientation as planned, so that it will fit as desired. The configuration may be observed and/or controlled with assistance of one or more operatively coupled image capture devices (1071).

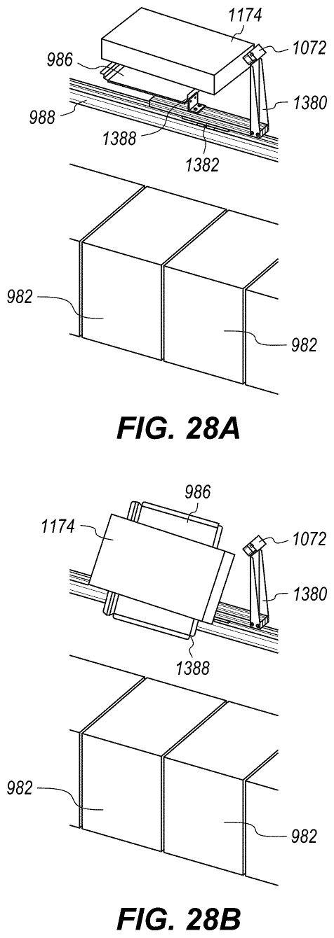

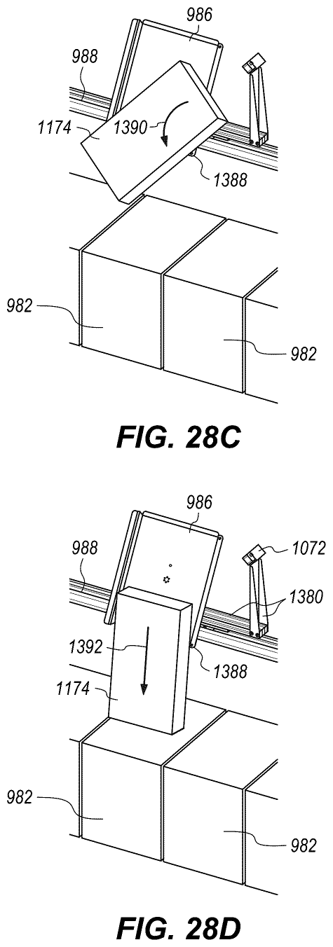

Referring to FIGS. 28A-28D, in another embodiment, it may be desirable to have one less motor, and to utilize the relative dynamics of the distribution module (986) and package (1174), as well as a protruding pivoting feature (1388) of the distribution module (986) which is specifically positioned and oriented to cause a rotation (1390) of the package (1174) as the package is falling down (1392) toward the targeted output container (982) after the tilt motor has been actuated, as shown in FIGS. 28C and 28D. In other words, with use of the protruding pivoting feature (1388) of the distribution module (986), the system may be able to avoid usage and/or integration of a separate motor for actuated pan, as in the embodiment of FIGS. 27A-27F.

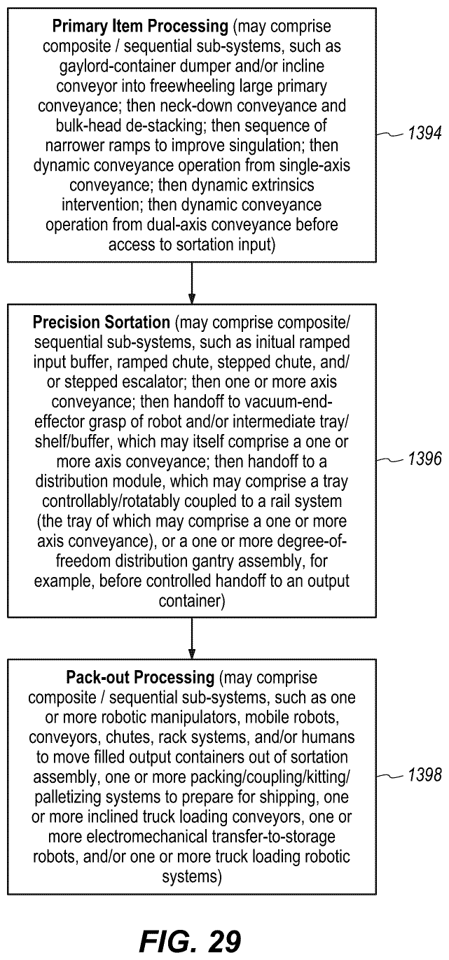

Referring back to FIGS. 25A and 25B and others, FIG. 29 again emphasizes sensor fusion, system integration, and efficiency in all stages of a package handling paradigm. Referring to FIG. 29, Primary item processing (1394) may comprise composite/sequential sub-systems, such as gaylord-container dumper and/or incline conveyor into freewheeling large primary conveyance; then neck-down conveyance and bulk-head de-stacking; then sequence of narrower ramps to improve singulation; then dynamic conveyance operation from single-axis conveyance; then dynamic extrinsics intervention; then dynamic conveyance operation from dual-axis conveyance before access to sortation input; all preferably including advanced levels of integration and cooperation. Precision sortation (1396) may comprise composite/sequential sub-systems, such as an initial ramped input buffer, ramped chute, stepped chute, and/or stepped escalator; then one or more axis conveyance; then handoff to vacuum-end-effector grasp of robot and/or intermediate tray/shelf/buffer, which may itself comprise a one or more axis conveyance; then handoff to a distribution module, which may comprise a tray controllably/rotatably coupled to a rail system (the tray of which may comprise a one or more axis conveyance), or a one or more degree-of-freedom distribution gantry assembly, for example, before controlled handoff to an output container; all preferably including advanced levels of integration and cooperation. Pack-out processing (1398) may comprise composite/sequential sub-systems, such as one or more robotic manipulators, mobile robots, conveyors, chutes, rack systems, and/or humans to move filled output containers out of sortation assembly, one or more packing/coupling/kitting/palletizing systems to prepare for shipping, one or more inclined truck loading conveyors, one or more electromechanical transfer-to-storage robots, and/or one or more truck loading robotic systems; all preferably including advanced levels of integration and cooperation.

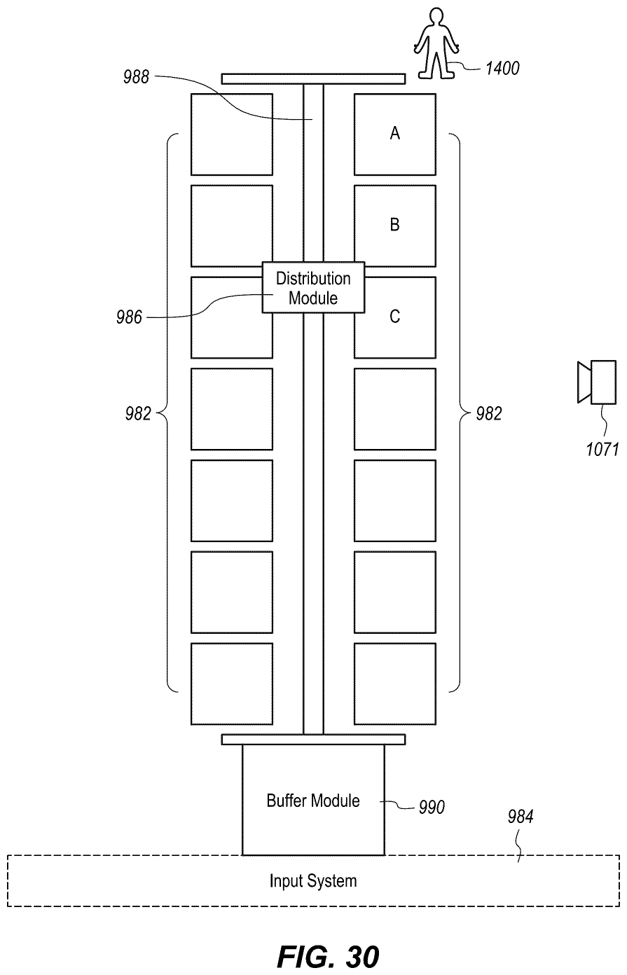

Referring to FIG. 30, of course human resources may be integrated into various aspects of the subject process and system configurations at many stages, and the systems preferably are configured to dynamically respond. For example, as shown in FIG. 30, a person (1400) located as shown may have limited feasible safe access to access output container “C”, or output containers “C”, “B”, and “A”, and as a result, may start by relocating container A; then container B, then container C (for example, in a simplistic scenario, all of the output containers 982 may be positioned together on a warehouse floor). The configuration may be observed and/or controlled with assistance of one or more operatively coupled image capture devices (1071). Indeed, the system preferably is configured using vision-based analysis, for example, to detect the person (1400) and the motion, repositioning, and reorientation of containers A, B, and C, and to continue processing otherwise as pertains the remainder of the output containers (982) shown, and/or to interrupt asking for a management response to confirm that activity should be continued during the activity of the person (1400) as pertains containers A, B, and C.

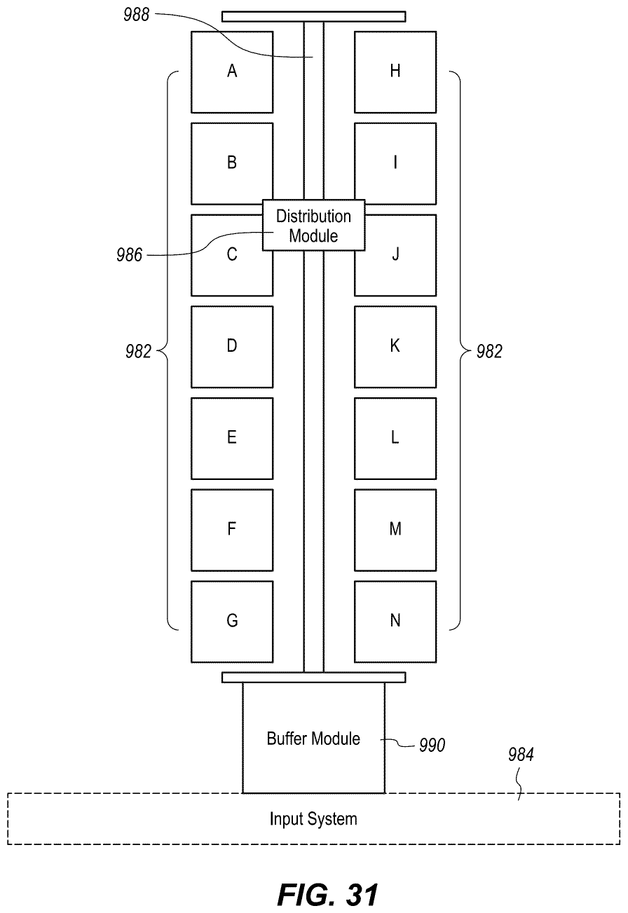

Referring to FIG. 31, and also back to the descriptions above related to FIGS. 4A-5B, and also FIGS. 6-12H, the system may be configured to cycle in and out various individual output containers, as well as groups thereof. In relatively straightforward scenarios, one or a group of output containers may receive one or more packages each, and then be exited toward pack-out in sequence (i.e., either individually, or as groups, as described above). In other scenarios, it may be desirable to coordinate the filling of various output bins in accordance with a variety of factors, such as breakability, ultimate endpoint destination, loading scenario within the truck (i.e., how many bins, totes, or other output containers high will the stacks in the trucks be at during truck transport), and/or unloading technique within the delivery truck at the ultimate endpoint destination (for example, in one scenario, the driver may be instructed to go sequentially through each bin on board the truck; after one bin is empty, then go to the adjacent bin; alternatively, the driver may be instructed to go sequentially layer by layer through the bins, so that he pulls the top item from the first bin; then the top item from the second bin; then the top item from the third bin, etcetera; then cycles back to get the second item from the first bin, second item from second bin, and so on; there are many such configurations wherein customization may be planned for at the sortation level). Thus referring to FIG. 31, the system preferably is configured to deposit items or packages into the various output containers (“A” through “N”) in accordance with the downstream plan. Such execution as the sortation/distribution module level may be best accomplished by moving various output containers in and out of immediate access to the distribution module during sortation using techniques such as those described above in reference to FIGS. 4A-5B, and also FIGS. 6-12H. In other words, it may be most efficient to sort in “batches” or “batch mode”, such that the distribution module (986) is commanded to distribute certain items to certain output containers (982), interrupted (preferably minimally or not at all with preferred coordinated motion planning) by switching in and out of certain output containers or groups thereof, for further sorting/batching, until certain output containers are ready for transfer out to pack-out as complete. System variations such as that depicted in FIG. 31 may be configured to sort packages or items within the targeted output containers (982) using a multi-pass sorting algorithm such as what is known as a “hash sort” configuration. In such configuration, output containers (982) may be assigned items by the order of the item in the sequence (e.g., all items that are to be first on the downstream delivery route go to bin A, all items that are to be second on the downstream delivery route go to bin B, etc). Then after this subprocess, each full output container (982) may be moved away from the distribution module (986) and the items/packages therein unloaded, or “re-inducted”, into the primary sorters on the input side (984) in reverse order (e.g., the tote, bin, or other output container 982 assigned to the last items may inducted first in order, and so on). The items from the re-inducted output containers may then be re-sorted into delivery bins that are prepared for routing to final destinations (such as via delivery van or truck). This way the first item along the delivery route is on top of the container and the last item to deliver is at the bottom of the container. Such configurations may have optimized efficiency through the use of various above described techniques and configurations, all integrated using the most updated information pertaining to the various items/packages coming through the various subsystems. For example, at stages, positions, or orientations where image capture devices, scanners, LIDAR devices, and the like are present, the system may be configured to continually refine, preserve, and improve determinations regarding each subject package, its status, condition, etc through the use of low-latency computerized neural networks trained (such as in supervised learning and/or unsupervised learning configurations) based upon real and/or simulated scenario data so that they are optimally responsive to a broad panoply of scenarios (i.e., we are able to greatly enhance the number of applied training cycles using simulated image and scenario information as compared with conventional labeled real data in a supervised learning configuration), and so that they are constantly improving, such as via reward-based reinforcement learning configurations, in view of the various packages, lighting, sensors, and system components present operationally. In various embodiments, with requisite knowledge of state information pertaining to key variables such as geometric ranges, distances, and sizes of certain known structures (such as general package sizes, parameters of the operational electromechanical systems and components such as conveyance features, robot arm dimensions and reach, etc), reinforcement learning may be conducted not only in runtime to improve results in accordance to a designated reward paradigm, but may also be conducted in simulation, to utilize computing resources to generally enhance cycling of the reinforcement/reward paradigm for continually improved operational utility. As described above, the systems and subsystems may be configured to constantly observe, prune away problem packages or quality control issues, dynamically address problems and optimize processing, improve and optimize grasping, such as via the use of vacuum-based end effectors which may be configured to not only plan and execute grasps on substantially planar surfaces such as a box side, but also against irregular surfaces such as bags, mailers, and the like, such as via pulling one or more portions of a flexible surface such as that of a bag into an inner chamber of a vacuum end effector while also preventing over-protrusion with a permeable distal wall member configuration between the targeted package and inner chamber. We have also described and integrated various aspects of extrinsic dexterity configurations, wherein the system may be configured to utilize loading and contact pertaining to objects available during package handling which may assist in high-speed repositioning, reorientation, and the like, dynamic to what is observed with the various sensors and sensor fusion results, which may be utilized to not only observe positioning and orientation of packages, but also to fit volumes and 3-D prisms around targeted packages to dimension them, determine or estimate whether breakage or deformation has occurred, and estimate material properties, as described above. At a higher level, groups and/or networks of systems may be centrally controlled and operated with inputs from important sources such as weather analysis systems, trucking logistics systems, road quality systems, air traffic control systems, hurricane or other emergency warning systems, and the like-all of which can have dramatic impacts upon shipping and package handling demands and operation.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A robotic package handling system, comprising:
an end effector assembly configured to transfer one or more packages from an input assembly to an output assembly;
a first imaging device positioned and oriented to capture image information pertaining to the one or more packages;
a first computing system operatively coupled to the end effector assembly and the first imaging device, and configured to receive the image information from the first imaging device and command movements of the end effector assembly based at least in part upon the image information;
wherein the input assembly is operatively coupled to the first computing system and configured to be operated by the first computing system based at least in part upon the image information to mechanically process a plurality of incoming packages from a substantially disordered mechanical organization to provide a supply of packages to be transferred to the input assembly that is substantially singulated, and to prune away certain packages which do not become substantially singulated as a result of the mechanical process; and
wherein the first computing system is configured to operate the end effector assembly to move a targeted package of the one or more packages from the input assembly based at least in part upon the image information, and release the targeted package to be at least transiently coupled with the output assembly with a position and orientation based at least in part upon the image information.

2. The system of claim 1, wherein the end effector assembly comprises a first suction cup assembly coupled to a controllably activated vacuum load operatively coupled to the first computing system, the first suction cup assembly configured such that operating the end effector assembly to move a targeted package comprises engaging the targeted package and controllably activating the vacuum load.

3. The system of claim 1, wherein the end effector assembly further comprises a tray member configured to be at least partially positioned below the targeted package when operating the end effector assembly to move a targeted package.

4. The system of claim 1, wherein the first imaging device comprises a camera.

5. The system of claim 1, wherein the first imaging device comprises a stereoscopic camera assembly.

6. The system of claim 1, wherein the first imaging device comprises a depth camera.

7. The system of claim 1, wherein the input assembly is configured to be operated by the first computing system to control the supply of packages based at least in part upon a number of the one or more packages transiently coupled to output assembly.

8. The system of claim 1, wherein the input assembly is configured to be operated by the first computing system to control the supply of packages based at least in part upon the image information pertaining to the one or more packages at the input assembly.

9. The system of claim 1, wherein the input assembly comprises one or more mechanical singulation elements configured to mechanically process and direct the substantially singulated supply of packages toward the output assembly.

10. The system of claim 9, wherein the one or more mechanical singulation elements are selected from the group consisting of: a ramp sequence; a vibratory actuator; a belt; a coordinated plurality of belts; a ball sorter conveyor; a step sequence; a chute with one or more 90-degree turns; a mechanical diverter; a vertical mechanical filter; and a horizontal mechanical filter.

11. The system of claim 1, wherein the input assembly is configured to be operated by the first computing system to prune away certain packages which do not become substantially singulated as a result of the mechanical process using a diversion element configured to selectably divert one or more targeted packages.

12. The system of claim 1, further comprising a second image capture device operatively coupled to the first computing system and configured to capture information pertaining to the one or more packages on the input assembly.

13. The system of claim 1, further comprising a second image capture device operatively coupled to the first computing system and configured to capture information pertaining to the one or more packages on the output assembly.

14. The system of claim 1, wherein the first image capture device is positioned and oriented to capture information pertaining to packages being moved from the input assembly to the output assembly.

15. The system of claim 1, wherein the input assembly comprises an electromechanical conveyance.

16. The system of claim 15, wherein at least a portion of the conveyance comprises multi-axis electromechanical conveyance.

17. The system of claim 1, wherein the output assembly is configured to controllably release the targeted package to an output container.

18. The system of claim 17, wherein the output container is selected from the group consisting of: a bin, a sack, a tote, a gaylord container, a chute, a conveyance.

19. The system of claim 1, wherein the first computing system is operatively coupled to the output assembly.

20. The system of claim 19, wherein the output assembly is configured to controllably release the targeted package to a distribution module, the distribution module being operatively coupled to the first computing system and configured to controllably release the targeted package to an output container.

21. The system of claim 17, wherein the output container is selected from the group consisting of: a bin, a sack, a tote, a gaylord container, a chute, a conveyance.

22. The system of claim 20, wherein the distribution module comprises a tray or bin movably coupled to a transport assembly coupled between the distribution module and the output assembly.

23. The system of claim 22, wherein the distribution module is movably coupled to the transport assembly using a pan-tilt actuation assembly operatively coupled to the first computing system.

24. The system of claim 22, wherein the transport assembly comprises an elevated gantry assembly configured to have physical access to an array of available output containers.

25. The system of claim 22, wherein the transport assembly comprises a rail assembly configured to have physical access to an array of available output containers.

26. The system of claim 24, wherein a plurality of output containers comprising the array of available output containers may be coupled together as an assembly to be transferred away from the output assembly together.

27. The system of claim 24, wherein a plurality of output containers comprising the array of available output containers may be removably coupled together as an assembly to be transferred away from the output assembly together.

28. The system of claim 20, wherein the distribution module is configured to be able to controllably release the targeted package to a targeted output container selected from an array of available output containers.

29. The system of claim 28, wherein the first computing system is configured to operate the distribution module to sequence packages into one a plurality of targeted output containers selected from the array of available output containers based upon a multi-pass sorting algorithm.

30. The system of claim 29, wherein the multi-pass sorting algorithm comprises a hash-sort configuration selected to facilitate efficient sequenced unloading of the plurality of targeted output containers.

31. The system of claim 28, wherein the first computing system is configured to automatically controllably release the targeted package to a targeted output container selected from an array of available output containers based at least in part upon image information from the first image capture device.

32. The system of claim 31, wherein the first computing system is configured to automatically controllably release the targeted package to a targeted output container selected from an array of available output containers based at least in part upon image information from the first image capture device which may be utilized by the first computing system to estimate a factor selected from the group consisting of: package geometry; package compliance; estimated package bounding box geometry; package relative mass; relative rigidity of package material; package mechanical stability; and package moment of inertia.

33. The system of claim 28, further comprising a second image capture device fixedly coupled to the distribution module and configured to provide image information pertaining to movement of packages between the distribution module and the array of available output containers.

34. The system of claim 33, wherein the second image capture device is further configured to provide image information pertaining to interior portions defined within output containers comprising the array of available output containers.

35. The system of claim 34, wherein the second image capture device is configured to provide image information pertaining to interior portion factors selected from the group consisting of: shape of interiors of output containers, geometry of items within output containers, and fill level within output containers.

36. The system of claim 35, wherein the first computing system is configured to operate the distribution module to place the targeted package into the targeted output container with a position and orientation automatically selected to optimize geometric fit of the targeted package within the targeted output container.

37. The system of claim 28, wherein the first computing system is configured to operate the distribution module to sequence packages into one a plurality of targeted output containers selected from the array of available output containers based upon a known pattern regarding a planned unloading of the plurality of targeted output containers.

38. The system of claim 28, wherein the first computing system is configured to operate the distribution module to sequence packages into one a plurality of targeted output containers selected from the array of available output containers based upon a known pattern regarding a planned relative positioning of the plurality of targeted output containers within a delivery vehicle.

39. The system of claim 28, wherein the first computing system is configured to operate the distribution module to sequence packages into one a plurality of targeted output containers selected from the array of available output containers based upon a known delivery route pertaining to a planned unloading of the plurality of targeted output containers.

40. The system of claim 1, wherein the input assembly comprises a herringbone conveyance operatively coupled to the first computing system and configured to automatically position the one or more packages in a central position within reach of the end effector assembly.

41. The system of claim 40, wherein the first computing system is configured to operate the herringbone conveyance based at least in part upon the image information from the first image capture device.

42. The system of claim 1, wherein the input assembly comprises an input conveyance and a plurality of movable members configured to extend above the input conveyance, the plurality of movable members and input conveyance being operatively coupled to the first computing system and configured to automatically reposition the one or more packages when on the input conveyance.

43. The system of claim 42, wherein the first computing system is configured to operate the plurality of movable members and input conveyance based at least in part upon the image information from the first image capture device.

44. The system of claim 1, wherein the first image capture device is configured to capture image information pertaining to the one or more packages as they are positioned upon the input assembly.

45. The system of claim 44, wherein the first computing system is configured to establish an identity for each of the one or more packages based at least in part upon the image information captured from the input assembly.

46. The system of claim 45, wherein the first computing system is configured to utilize the established identity in releasing the targeted package to the output assembly.

47. The system of claim 46, wherein the first computing system is configured to utilize the established identity in releasing the targeted package to the output assembly based at least in part upon characteristics of the targeted package which may be associated with the established identity.

48. The system of claim 45, wherein the first computing system may be configured to associated other predetermined information pertaining to the one or more packages from another operatively coupled computing system based at least in part upon the image information captured from the input assembly.

49. The system of claim 1, wherein the input assembly comprises a primary item processing/input system.

50.-98. (canceled)
